(19) United States
(12) Patent Application Publication
(10) Pub. No.: US 2021/0398157 A1
(43) Pub. Date: Dec. 23, 2021

(54) SYSTEMS AND METHODS FOR MAXIMIZING MINE PRODUCTION SCHEDULING

(71) Applicant: COLORADO SCHOOL OF MINES, Golden, CO (US)

(72) Inventors: Canberk Aras, Golden, CO (US); Thys Johnson, Golden, CO (US); Kadri Dagdelen, Golden, CO (US)

(21) Appl. No.: 17/350,729

(22) Filed: Jun. 17, 2021

Related U.S. Application Data
(60) Provisional application No. 63/040,591, filed on Jun. 18, 2020.

(51) Int. Cl. G06Q 30/02; G06Q 10/04; G06Q 50/02

(52) U.S. Cl. CPC G06Q 30/0206; G06Q 10/06312; G06Q 50/02; G06Q 10/04

(57) ABSTRACT

The methods of the present disclosure can solve mine production scheduling problems modeled with multi capacities, grade blending, grade uncertainty, stockpiles, variable pit slopes, multi destinations and truck hours. In some embodiments, the methods disclosed can provide an optimal integer solution to the open pit mine production scheduling problem with capacity constraints together with lower and upper bound blending constraints. The difference between the integer feasible solution and the optimal linear solution of the same problem is called an “optimality gap”. In one example, the strength of the integer solution algorithm developed is highlighted by the ability of solving problems that have more than 7 million variables as an integer problem with an optimality gap as small as 0.01% within 5 hours 30 minutes.

### CROSS-REFERENCE TO RELATED APPLICATIONS

This application claims the benefit of priority pursuant to 35 U.S.C. § 119(e) of U.S. provisional patent application No. 63/040,591, filed 18 Jun. 2020, entitled “Systems and Methods for Maximizing Mine Production Scheduling,” which is hereby incorporated by reference herein in its entirety.

### FIELD

The present disclosure relates generally to mining optimization methods and systems.

### BACKGROUND

An extensive literature review of the mathematical modeling methods together with the solution techniques to the open pit mine production scheduling problems that have been under investigation since the 1960s will be presented. The solution techniques proposed by the researchers are presented under categories characterized by the variable types such as linear programming, mixed integer linear programming and integer programming solution techniques. The proposed solution techniques will be critiqued within each category. The reason for collecting the assessment of the techniques under a separate section is to avoid repeating similar evaluations since most of the techniques share resembling pitfalls. It is also worth mentioning that none of the techniques proposed by the researchers were able to provide an optimal integer solution to the mine production scheduling problems. This is the leading motivation behind the work in this thesis.

2.1 Ultimate Pit Limit Problem

Traditionally, the ultimate pit limit problem only investigates the most profitable blocks to be mined as if all the resource capacities were unlimited and the mills were free from any kind of blending requirements. In other words, the value of the pit is maximized subject to the extraction sequence of the blocks governed by the pit slopes. Since all the resource capacities are assumed to be unlimited and the mills are assumed to have no blending requirements, the need for a scheduling vanishes as well as the impact of time value of money on block extraction. It is usually accepted as the maximum limits of mining or as the ultimate shape of the pit at the end of mine life. There are various heuristic and exact algorithms that can solve the “ultimate pit problem” in a reasonable amount of time.

The moving cone algorithm of Pana (1965) was a widely accepted and implemented heuristic algorithm due to its fast solution time. Dagdelen (1985) shows that the algorithm generates cones with a vertex positioned on a positive block and moving from one positive block to another. The side walls of the cone obey the pit slope and the profitable cones are selected for mining. Gauthier and Gray (1971), Barnes (1982) and Underwood (1996) mention that the moving cone method has shortcomings since the cones are only targeting a single positive block and ignoring the combination of the other cones. Hence, if a single cone is not profitable, it will not be mined although it would generate profit once combined with the other cones. Since the moving cone method cannot promise the optimal answer, it falls into the heuristic category.

In 1965, an algorithm based on graph theory concepts was introduced by Lerchs and Grossman which is currently known as the LG algorithm. The pit is initially represented with a graph by converting each block to a node with a node mass equal to the block value and connecting all the positive nodes (ore blocks) and the negative nodes (waste blocks) to the root node with the arcs. In other words, an initial spanning tree is formed. Spanning trees will be partitioned into strong and weak node groups. If the group of nodes represented with an arc coming from a root node have a cumulative node value or mass that is positive, the group of nodes is called strong otherwise they are called weak nodes. If the weak group of nodes overlies a strong group of nodes, they are combined and reclassified into strong and weak group of nodes based on their cumulative mass. The collection of strong nodes forms the maximum closure which indeed represents the set of blocks that maximizes the profit and defines the ultimate pit limit.

Johnson (1968) is the first to show that when the ultimate pit limit problem is formulated as a LP, the dual of the LP model can be transformed to a max flow network model. The author also shows that the LP representation of an ultimate pit limit problem has a totally unimodular structure where the entries of the coefficient matrix are integral, and the determinant of the coefficient matrix is either 1 or −1, hence the problem can be converted to a bipartite graph. The author became a pioneer in the field by showing that an ultimate pit limit problem is a maximum flow problem which can be solved by any algorithm that can solve max flow network models.

Zhao and Kim (1992) modified the LG algorithm and extended its application to the large block models. The pit is represented with a directed graph where the arcs are formed between the positive (ore) and negative (waste) nodes (blocks) to imply the sequencing relationships. The positive nodes are connected to negative nodes which is called as full support. Also, if an ore block cannot support the waste block, then an arc is directed from waste block to the ore block called as partial support. The value of the root node which is at the starting point of the last generated arc is checked to determine if the tree should be categorized as strong or weak. If a weak group of nodes overlies a strong group of nodes and only non-root nodes of the strong and weak trees have a precedence relation, the root node of strong tree is shifted to the non-root node of the strong tree and the root node of weak tree is shifted to the non-root node of the weak tree since the arcs can only be drawn between the root nodes. This approach solves the jointly support and reallocation problems. Also, Zhao (1992) explains in his thesis that the proposed approach avoids the normalization step of the LG algorithm which may reduce the computation time. However, a direct comparison with the original LG algorithm was not provided.

Yegulalp and Aries (1992) applied the excess-scaling algorithm of Ahuja and Orlin (1989) to solve the ultimate pit limit problem as a max flow problem. However, the authors showed that the LG algorithm implemented by Whittle Programming Pty. Ltd solves the ultimate pit limit problem faster than their implementation of the excess-scaling algorithm.

Underwood and Tolwinski (1996) interpreted the graph theoretic methodology of LG algorithm from a mathematic programming point of view by examining the similarity of the steps of LG algorithm with the steps of dual simplex algorithm. The authors show that the dual simplex algorithm maintains the same logic as the LG algorithm by removing the strong nodes and leaving the weak nodes at every stage and once the optimality is achieved, the strong nodes will represent the ultimate pit limit solution. The authors claim that the only difference between the two algorithms is that the dual simplex algorithm updates the value of the arc between strong and weak node by maximizing its value while maintaining the dual feasibility which improves the computing performance. The authors show that dual simplex algorithm solves the ultimate pit problem a few minutes faster than the LG algorithm for the cases they tested with up to 2.5 million blocks.

Hochbaum (2008) introduced the pseudoflow algorithm which is the fastest known algorithm that can solve the ultimate pit limit problem or multi period sequencing problem as a maximum flow or minimum s-t cut problem. The algorithm may start with a simple initialization by saturating the sink adjacent and the source adjacent arcs and keeping the rest of the arcs with zero flow (Chandran and Hochbaum, 2009). Hence, excesses are created at the source adjacent nodes and deficits are created at the sink adjacent nodes. The method tries to reroute flow through all the arcs going from a subset of nodes that has excess to a subset of nodes that has a deficit, so that in the end a provable minimum cut in the graph will be achieved (Hochbaum, 2008; The Pseudoflow Algorithm: A New Algorithm of the Maximum-Flow Problem; Operations Research, 56(4), 992-1009). According to the computational study of the pseudoflow and push-relabel algorithms for the maximum flow problem conducted by Chandran and Hochbaum in 2009, the pseudoflow algorithm is faster than the push-relabel algorithm which was widely accepted as the fastest algorithm to solve the maximum flow problem at that time. It has been also shown that the pseudoflow algorithm solving the max flow formulation of the ultimate pit limit problem is faster than the Lerchs and Grossman algorithm.

2.2 Pushback Design

The pushback design method determining a production schedule to an open pit mine should start with determining the ultimate pit limits. Once the ultimate pit limit is determined, mine planning continues with the goal of finding the optimal extraction sequence of the blocks, which in the end, results in incremental pits called as pushbacks. The need for dividing the pit into sub pits arises due to the scale of a block by block production scheduling problem hence, sub-pits or pushbacks are used to schedule the blocks quarterly or yearly. Many heuristic techniques were developed in order to sequence the pushbacks so that the schedules from the pushbacks will be in compliance with the resource capacity and mill blending requirements.

Dagdelen and Francois-Bongarcon (1982) determined a series of pushbacks by varying the price of the commodity, cutoff grade, mining or processing costs.

Gershon (1987) proposed an algorithm which generates cones with the shape of a pit expanding towards the bottom of the pit with the vertex positioned on each block. The total quality of the ore within the cone determines the positional weight of the block. The blocks are ranked based on their positional weight and the highest rank block is scheduled first. Then, the positional weights of the blocks are re-initialized with the remaining blocks. This allows scheduler to reach the high-grade ore at the bottom of the pit quicker than the traditional approaches.

Whittle's approach (1988) is a pit parametrization technique which varies the block values incrementally and generates nested pits by implementing the LG algorithm.

Seymour (1995) proposed a parameterization algorithm that abandons the traditional pit parametrization techniques which generate pits as a function of pit value. Instead, the method selects both the pit volume and pit value as the parameters of this function. The algorithm is a modified version of the LG algorithm by adding the parametrized variables and allowing to form sub trees that represent the small pits (Meagher et al., 2014). The branches are categorized as strong or weak based on the threshold value of their strength which is calculated by dividing the cumulative value of the nodes in the branch by the cumulative mass of the nodes in the branch. Strong branches form the sub tress (small pits) which are sequenced based on their strength value.

Ramazan and Dagdelen (1998) developed a minimum stripping ratio pushback design algorithm which is a modified version of the Seymour's algorithm in 1995. The authors apply break-even cutoff grade to differentiate ore and waste with an indicator value “1” assigned to ore and indicator value “0” assigned to waste. The authors replaced the cumulative value approach in Seymour's algorithm with the cumulative indicator value approach to calculate the strength of the branch. The goal of the algorithm is to find pits with the minimum stripping ratio which will lead to a schedule where the ore blocks are mined as soon as possible. Authors also demonstrated that Whittle's pit parametrization method may produce the same nested pits as the minimum stripping ratio pushback design algorithm if all the ore blocks are assigned the value of the highest-grade ore in the block model.

Somrit (2011) introduced a phase design algorithm which uses Lagrange parameters to determine the size of the pits in compliance with the annual resource capacity requirements. The usage of Lagrange parameters is similar to the Whittle's pit parametrization technique. Although the relationship between the Lagrange parameters and pit size is not linear, the author uses linear interpolation to determine the parameters since it is impossible to predict the relationship with an equation. This kind of approach may result in gap problems. The pits are determined in a reverse order compared to the commonly adopted approaches. The algorithm first tries to find a pit that meets the resource requirements of “t−1” periods. The unmined portion of the pit becomes a phase for the period “t”. Then, the algorithm looks for the next pit that obeys the resource requirements of “t−2” periods. The remaining blocks create the next phase for the period “t−1”. Hence, the algorithm proceeds backwards in time till it determines the phase corresponding to the first period.

2.2.1 Shortcomings of the Pushback Design Methods

Due to the large scale of block by block mine production scheduling problems, the pushback concept became attractive since it allows scheduling to be done from the sub-pits or nested pits which results in less variables in the optimization model. Dagdelen and Francois-Bongarcon (1982), Gershon (1986), Whittle (1988), Seymour (1995), Ramazan and Dagdelen (1998), Somrit (2011) proposed various techniques to obtain the pushbacks. The methods follow the incremental fashion of obtaining pushbacks that fail to incorporate the blending requirements as well as the uncertainty of the grade of ore. Moreover, the size of the pit has a non-linear relationship with the value of the pit which makes it extremely hard to determine. But the common approach attempts to find the pit size with an assumption of a linear relationship which in the end results with a gap problem. The resulting gap problem will prevent pushbacks to meet with the capacity requirements. So far, researchers have not found an approach to overcome the stated problems which will in the end produce poorly designed pushbacks. Since many production schedule plans depend on the design of pushbacks, poor designs can prevent the schedules from achieving a maximum NPV or even obtaining a feasible solution.

2.3 Mathematical Programming and Integer Solution Techniques for Production Scheduling

The mine production scheduling problem was originally formulated by Johnson (1968) with a goal of finding the optimal block schedule that will maximize the NPV throughout the life of a mine. This generic model incorporates the dynamic cutoff grade strategy by allowing the blocks to be sent to the most attractive destination determined by the pit slope, capacity limitations and average grade requirements at each destination and availability of the equipment. Johnson's model will generate a higher NPV since the destinations of the scheduled blocks will not be pre-determined by the mine planner, instead the optimal destinations will be selected by the scheduler to maximize the NPV. The best schedule would be obtained if the model could be solved with integer decision variables. The complexity of the problem increases as the number of the blocks, which are the decision variables in the model increases. A true integer optimal solution of the proposed model still cannot be determined with the current solution techniques. The past and most recent research in the area is geared towards developing solution techniques which can find such feasible solutions that are close to the optimal integer solutions within a reasonable time frame. Since the optimal integer solution to the proposed model is unknown, the solution techniques developed cannot identify how far one is from the integer optimal solution, however the quality of the solutions are measured from the optimal linear programming solution since it provides an upper bound (Dagdelen, 1985; Optimum Opin Pit Mine Production Scheduling, Thesis, U of C Berkeley).

2.3.1 Linear Programming Solution Techniques

Linear Programming (LP) models are often called linear relaxation models, if one decides to relax the integrality of the decision variables by presenting them as continuous variables in the model. As mentioned before, the theoretical upper bound provided by the optimal LP solution is a benchmark to measure the “optimality gap” of the integer solution to the same problem which allows the evaluation of the success of the integer solutions.

G. Dantzig proposed the simplex algorithm in 1947, which is an exact optimization technique to solve LP models. The simplex algorithm still remains one of the most popular algorithm, adapted by commonly used optimization engines such as CPLEX and Gurobi. Once the LP model is generated, the solution space bounded with the constraints creates a polytope where the optimal solution may exist on one of its vertices which can be also called extreme points. Given a mine production scheduling problem with an objective of maximizing NPV, the simplex algorithm will solve the linear relaxation of the model by starting the search of an optimal solution on an extreme point and moving to another extreme point until the objective function value cannot be improved. This kind of a search is not practical for mining problems since the number of variables and constraints may result with too many extreme points to be searched which results in inefficient solution times.

Johnson (1965) proposed the Dantzig Wolfe (DW) decomposition algorithm to solve the LP relaxation of the mine production scheduling model by decomposing the original model into subproblems. The subproblem can be called a Lagrange relaxation of a model where the resource capacity and blending constraints are moved to the objective function and penalized with the associated dual values. The Lagrange relaxation problem is similar to the ultimate pit problem except the blocks are sequenced in multi time period. Since the subproblem or Lagrange relaxation problem has the totally unimodular structure, Dagdelen (1985) showed that the multi period subproblem is a maximum flow network problem which is faster than solving the problem as a LP. The DW algorithm uses a convex combination of the extreme points of the Lagrange relaxation problem to find the optimal solution to the original problem. The variables associated with the extreme point solution vectors of the subproblem are used to solve the master problem subject to the constraints of the original problem and a constraint that assures the convex combination of extreme points. The optimal solution which may be in a fractional form can be used as a guidance for scheduling the blocks since the optimal LP solution is an upper bound for the optimal integer programming (IP) solution.

Bienstock and Zuckerberg (2009; A New LP Algorithm for Precedence Constrained Production Scheduling. Industrial Engineering, 1-33) improved the DW decomposition algorithm and the BZ is presently recognized for being the fastest LP solving decomposition algorithm for the precedence constrained production scheduling problems such as mine production scheduling problems. The BZ algorithm can solve the LP relaxation of the mine production scheduling problems constrained with upper and lower bound resource and blending constraints to a proven optimality. The algorithm decomposes the original problem into a subproblem and master problem. Each subproblem is solved likewise in the DW algorithm except the extreme point solution vectors of the subproblem are orthogonalized in the BZ algorithm which will increase the dimension of the solution space by adding more axes to the system which eventually reduces the number of vectors linearly combined to represent the optimal solution in the master (original) problem. In other words, since there is a variable associated with each one of the vectors generated from the subproblem solution, a decrease in the number of vectors will result with less variables to solve in the master problem. Detailed investigation of the BZ algorithm is presented in section 4.

Van Dunem (2016) integrated the uncertainty concept in the form of risk constraints to the mine production scheduling problem. The author developed a model which allows the user to reflect his/her risk tolerance within the production scheduling problem. The model includes mill capacity, mill blending and risk constraints where the mill blending, and risk constraints have both minimum and maximum requirements. The resource modeling is done in order to estimate the grade of a block with an associated level of uncertainty. Mineral resources are classified into the categories as inferred, indicated and measured and defined as follows (CIM, 2006):

(i) An Inferred mineral resource is that part of a Mineral Resource for which quantity and grade or quality are estimated on the basis of limited geological evidence and sampling. Geological evidence is sufficient to imply but not verify geological and grade or quality continuity.

(ii) An Indicated mineral resource is that part of a mineral resource for which quantity, grade or quality, densities, shape and physical characteristics are estimated with sufficient confidence to allow the application of modifying factors in sufficient detail to support mine planning and evaluation of the economic viability of the deposit.

(iii) A Measured mineral resource is that part of a mineral resource for which quantity, grade or quality, densities, shape, and physical characteristics are estimated with confidence sufficient to allow the application of modifying factors to support detailed mine planning and final evaluation of the economic viability of the deposit.

The risk constraints are developed in order to control the uncertainty by applying an upper bound on the number of the inferred blocks sent to the mill and lower bounds on the amount of indicated and measured blocks. With the incorporation of the risk constraints the author aims to minimize the impact of uncertainty on meeting the operational or production targets. Traditional stochastic production scheduling problems incorporate the grade uncertainty by varying the grade of the ore blocks from one scenario to another which eventually increases the number variables with the magnitude of the number of scenarios and results in a NP-hard problem with a huge variable space. In contrary, the author proposed a novel approach by integrating the grade simulations once the production scheduling is completed. In other words, the initial schedule is generated in order to meet with the risk tolerance of the manager. Then, the simulated grades are integrated to check whether the given schedule will meet the blending requirements. For example, if 9 out of 10 integrated simulations are within −15% of the lower bound and +15% of the upper bound blending requirements, then the optimal production schedule is obtained under the grade uncertainty. If the integrated simulations fail to meet with the blending requirements, the manager can lower the number of the inferred blocks requested by the mill or increase the number of measured blocks which will potentially lower the grade variability at the mill. Also, the management can drill more drill holes to increase the level of confidence within the inferred group of blocks. The NPV difference between the riskiest scenario and the considerably less risky scenario can give a hint to the management about the expected NPV that can be generated if more drilling is conducted on the inferred group of blocks. Although modeling the production scheduling problem as a deterministic model reduces the number of variables, the problem size is still considerably large to solve as an integer programming model. Moreover, a solution for the LP relaxation of the model might not be obtained by using CPLEX. Thus, the author proposed a decomposition method developed by Bienstock and Zuckerberg in 2009 to solve the LP relaxation of the model. The integration of the Pseudoflow algorithm to the BZ decomposition algorithm made the LP relaxation of the large-scale open pit production scheduling problem under the metal uncertainty solvable with fast solution times.

2.3.2 Mixed Integer Linear Programming Solution Techniques

Mixed integer linear programming techniques gained importance due to the size of the mine production scheduling problems. Since the optimal integer solution of the problem has not been achieved, a lot of research has moved towards solving the mining problems with the mix of continuous and integer variables.

Gershon (1983) modified the mine production scheduling model proposed by Johnson (1968) by adding continuous variables that will mine the blocks partially if all the preceding blocks have been removed. The author claims that forcing the integrality of the decision variables will not reflect the practical approach, hence by allowing partial mining, the schedules can meet with the blending constraints. Osanloo et al. (2008) mentioned that Gershon's approach will not be able to handle large problems due to the large number of the binary variables and also since the size of the problem is a concern, dynamic cutoff grade strategy cannot be implemented.

Ramazan and Dimitrakopoulus (2004) improved Gershon's (1983) model by setting the ore blocks as binary variables and leaving the waste blocks as continuous variables. The decision to partially mine the waste blocks still exist in the model. The authors claim that since the ore blocks must be mined fully, the waste blocks will also be mined fully in order to satisfy the sequencing requirements. Partially mined blocks may exist in the last period. The case study lead to a conclusion that the number of binary variables may be decreased as well as the solution time by setting only the ore blocks as binary and also the partially mined blocks can be minimized if the reserve constraints are equalities.

Kawahata (2006) took an approach to solve the MILP problems. The author divided the pit into series of pushbacks and divided the pushbacks into increments (benches). The blocks within the increments aggregated based on the similarities of the grades of the blocks and rock properties. The original MILP formulation consists of binary variables that preserve the sequencing between the pushbacks and increments and continuous variables which allow the scheduler to pick the destination for the portion of the increment mined under dynamic cutoff grade policy. The author reduces the solution space that the MILP model works within by splitting the original problem into two Lagrange relaxation problems where the aggressive case relaxes the process capacity constraints while keeping the mining capacity constraints and the conservative case relaxes the mining capacity constraints while maintaining the process capacity constraints in the model. Since the Lagrange relaxation model consists of only small number of pushback variables achieved by aggregating the benches, the binary nature of the variables does not pose any computational disadvantage. Since the solution of the subproblems will provide an upper and lower bound to the original MILP problem, the variables which are not considered in the solution set of the subproblems can be eliminated from the variable set of the MILP problem. This approach will decrease the solution time of the MILP problem.

Boland et al. (2008) formulated the MILP problem with the same aggregation technique presented by Kawahata (2006). The author used binary variables to sequence the aggregated blocks, however the model has two continuous variables, one for the fraction of the aggregate excavated and the other variable represents the fraction of the aggregate processed. The author claims that the blocks in any aggregate can have multiple attributes based on the different metal content. The model does not have any blending constraints and the blocks in the aggregates are already classified as ore and waste with a predetermined cutoff grade.

Goycoolea et al. (2015) proposed a MILP model which works with pre-defined pushbacks. As in Kawahata's approach (2006), the author aggregated the blocks within each pushback into benches (increments). The model considers upper bound capacity on both production and processing constraints. Also, a dynamic cutoff grade strategy was incorporated by allowing the scheduler to choose a destination for the mined blocks. Continuous variables were used to mine the increments and the blocks from each increment partially. The author added additional volume-flow constraints to limit the variance on the production from one period to another. Also, instead of using binary variables to sequence the increments, the author achieved the same outcome with a constraint that all predecessor increments of any increment which is partially mined to be mined completely.

King (2016) formulated the open pit to underground transition model with pre-determined block destinations by varying crown and sill pillar locations. The author took a phase design approach with the benches binned into blocks characterized by grades. The author combined the surface mine production scheduling model with the underground mine production scheduling model and called it an enhanced transition model. Binary variables were used to schedule the underground activities such as extraction, backfilling and development as well as the sequencing relationship between the benches for the surface mining. Also, continuous variables were used to partially mine the benches and partially send the blocks to the mill. However, the partially bench mining constraints were written in such a fashion that once the bench is mined it should be mined completely so that the sequencing can take place. The author also allowed the stockpiles in the model, however the stockpile rehandling costs are not considered. In order to solve the model, the author used the BZ algorithm to solve the LP relaxation of the model and then a rounding heuristic method is applied in order to get an integer solution. The author solved the model many times by changing the locations of the sill and crown pillars in order to find the best location that will maximize the NPV.

2.3.2.1 Shortcomings of the Mixed Integer Linear Programming Solution Techniques

Mixed integer linear programming (MILP) techniques gained importance since the optimal integer solution of the mine production scheduling problem has not been achieved due to the size of the problems. Gershon (1983), Ramazan and Dimitrikapolus (2004), Kawahata (2006), Boland (2008), Goycoolea et al. (2015), King (2016) solved the mine production scheduling problems with the various forms of MILP techniques. Kawahata (2006) and Boland et al. (2008) further aggregated the blocks into the benches in their MILP models in order to reduce the number of variables. MILP models are solved for binary variables and continuous variables. Most of the authors use binary variables for the sequencing relations between the benches or blocks, and continuous variables to partially mine the benches or the waste blocks. A disadvantage of aggregation techniques is the loss of resolution. In other words, once the blocks are aggregated into benches, individual block grades are replaced with the average grade of the blocks like if the block grades on a bench are distributed homogeneously. This assumption might generate schedules which can easily mislead the operations in terms of meeting blending requirements. However, the MILP model proposed by Goycoolea et al. (2015) may overcome this issue since the model allows blocks to be scheduled individually from the benches but the sequencing relations are still preserved between the benches which will create a dependency between the block and the bench above. The plans generated with this approach might lead the scheduler to mine blocks which do not have any spatial correlation with blocks on the next level. This might lead to extra stripping for a particular period in certain situations. For the MILP models where the scheduling is done block by block and no bench aggregation is considered, the number of binary variables may be too large which will prevent the solver to find an optimal solution in a reasonable amount of time (Less than 8 hours). Also, there is no real mining case study presented in the literature which can be solved by modeling as MILP that takes into account mining and processing capacity and blending requirements with scheduling on a block by block basis.

2.3.3 Integer Solution Techniques

True open pit mine planning schedules can be achieved if one can solve Johnson's (1968) production scheduling model with integer variables.

Dagdelen (1985) was the first to show that the Lagrange relaxation technique can be applied to solve Johnson's model to generate integer solutions feasible to the original problem. The Lagrange relaxation model has the same objective function as the original model with an addition of side constraints penalized with the Lagrange multipliers and the model is subject to the sequencing constraints. Hence, the Lagrange relaxation problem solution always provides an upper bound to the optimal solution of the original problem. The goal is to find the best multipliers that will generate solutions as close as possible to the original problem. Dagdelen proposed the subgradient optimization method to generate Lagrange multipliers. If one cannot find such Lagrange multipliers that will produce feasible solution, to the original problem, it can be concluded that the condition of gap exists (Everett, 1963). Dagdelen identified the totally unimodular structure of the Lagrange relaxation problem and represented the multi-time period sequencing problem on a network structure. The author solved the multi-time period sequencing problem as a combination of a single time period maximum flow network problem.

Tachefine and Sumois (1996) also applied the Lagrange relaxation technique to solve the open pit mine production scheduling problem which does not have any blending constraints. The author uses the Bundle method to obtain the Lagrange multipliers. In order to make the solution of the Lagrange relaxation feasible to the original problem, the author proposed a greedy heuristic algorithm. The author solves the Lagrange relaxation problem as a maximum closure graph problem. The greedy algorithm tries to find a set of frontier nodes which are candidates for elimination. The nodes are selected for elimination in such a fashion that the violation of the capacity constraints is minimized while keeping the impact on the value of the closure minimum.

Akaike (1999) extended Dagdelen's Lagrange relaxation approach with the 4D network relaxation method. The proposed method solves a Lagrange relaxation problem as a multi time period maximum flow problem. Moreover, the method can handle the cutoff grade strategy and the stockpiles can be incorporated in the model. Since the method tries to find the best Lagrange multipliers with the subgradient method, the gap problem is inevitable if one exists.

Ramazan (2001) proposed the fundamental tree algorithm to solve the problem within the pushbacks. The author removes the side constraints of the original model and represents the problem as a network problem. The network model is formulated as a LP problem. At each iteration, the arcs that have 0 flow are eliminated and a new tree(s) is formed. The iterations terminate if the number of trees at the current iteration is equal to the previous iteration or if all the trees have only 1 positive node. Each fundamental tree can be treated as aggregated blocks that contain certain ore tonnage, waste tonnage and grade. Once the fundamental trees are obtained, the production scheduling model for the pushback can be solved as an IP problem with the resource capacity and blending constraints with a binary variable assigned for each fundamental tree. Although the number of the binary variables in the model can be reduced, large deposits can still have large number of fundamental trees that will make model inefficient.

Amaya et al. (2009) implemented a local search heuristic method to improve the initial integer feasible solution of a production scheduling model constrained with an upper bound on mining capacity constraint. Given an initial integer feasible solution, the method iteratively fixes parts of the schedule and the remaining unfixed parts are solved within a binary context to find out if a local improvement exists. If the solution provides an improvement, then the initial solution space is updated. The author presented three strategies to search for an improvement. The cone above strategy is used by first picking a block randomly from the set of blocks which are not considered in the initial integer feasible solution set. Then, the target block and its predecessors are solved as an integer while the rest of the initial feasible solution space is fixed. The periods strategy can be applied by randomly selecting two-time intervals from a given integer feasible solution space and solved for the best solution. The transversal strategy is applied by first defining a distance and height and then searching for the blocks that are not considered in the initial integer feasible solution.

Cullenbine (2011) proposed a sliding time window heuristic algorithm to approximately solve the production scheduling problems with the minimum and maximum resource capacity constraints. The algorithm initially fixes the initial integer feasible solutions for the T1 periods. Then, the exact window T2 is determined where the integer solution will be obtained. Then, for the remaining periods T3, Lagrange relaxation of the model is solved by penalizing the minimum and the maximum resource capacity constraints with the duals obtained from the optimal solution of the LP relaxation of the original IP model.

Chicoisne (2012) proposed a toposort heuristic algorithm which uses the optimal LP solution as a guide to round the fractional solutions to an integer result. Expected extraction time of a block is determined by multiplying the proportion of the block mined with its extraction period. Once the integer feasible solution is found, Amaya's local heuristic technique is applied in order to improve the initial integer feasible solution. The algorithm can only be applied for models with single or two capacity constraints in an upper bound form.

Lamghari and Dimitrakopoulos (2012) proposed the Tabu search meta-heuristic method integrated with two diversification strategies that are long term memory search and variable neighborhood search, to improve the feasible solution domain of the stochastic mine production scheduling problem. The authors modeled the two-stage stochastic problem by penalizing the upper and lower bound mining capacity constraints in the objective function while preserving the scenario dependent mill capacity and metal content constraints. In order to solve the modified model, the initial integer feasible solution (xᵢ) is obtained by randomly selecting the blocks from a mineable set of blocks meaning that the blocks should not have any predecessors, or the predecessors are already mined. The random selection continues until the amount of the chosen blocks for each period will be greater than or equal to the average of the upper and lower bounds for the mining capacity constraint. The solution honors the non-stochastic constraints such as mining capacity, reserve and sequencing constraints. The tabu search procedure begins once the initial solution is obtained. For each block in the solution set, schedule times of the closest successor and predecessor blocks are identified. Then, the latest schedule time of the predecessor e(x₁) and the earliest schedule time of the successor l(xᵢ) is selected. For any block i in (xᵢ), the blocks can be shifted from one period to another between the time intervals of e(xᵢ) and l(xᵢ) at each iteration. The block which is scheduled minimum amount of times is selected as a candidate in order to improve the searching activity in the less explored areas. If the solutions from the consecutive iterations stop improving for a certain amount of pre-determined time, then the Tabu search terminates. Then, the author applies diversification strategies to the Tabu search solution space in order to explore the areas which are rarely considered. The first strategy is named as a long-term memory diversification strategy. Since each block may be scheduled multiple times during the Tabu search, the time period that a block has been scheduled for less frequently is stored in a set. Then, a block randomly drawn from the set is scheduled to that time period. The second proposed diversification strategy is the variable neighborhood diversification strategy. Given the solution set obtained by Tabu search, a block which is scheduled the least number of times is selected from the set and rescheduled to a time period between e(xᵢ) and l(xᵢ) which gives the best NPV. The iterations terminate if the Tabu search solution cannot be improved or whenever the pre-defined number of iterations is reached.

Lambert (2012) proposed the Tailored Lagrange relaxation algorithm to solve the open pit mine production scheduling problems with minimum and maximum resource capacity constraints. The author proposed a maximum value feasible pit (MVFP) algorithm which will generate initial integer feasible solutions to the Tailored Lagrange relaxation model. The MVFP is processed in 3 phases. In Phase 1, a pit parametrization technique is used in order to find ore blocks that will satisfy processing needs over time. If the Phase 1 cannot find any pit that satisfies both the minimum and maximum ore production requirements over the time horizon, the well-known gap problem exists. In Phase 2, if the minimum production requirements are not satisfied, an integer program is solved to expand the pit. For the phase 3, an ultimate pit limit approach can be conducted or sliding time window algorithm can be applied to generate an initial integer feasible solution. Once the three phases are completed, the information collected during the MVFP stage will determine the dualization strategy of the Tailored Lagrange relaxation model.

Lamghari et al. (2014) proposed a method to generate an initial integer feasible solution under mining and mill capacity constraints with an upper bound and to improve the generated initial integer feasible solution. The author presented an exact approach and greedy heuristics to get an initial integer feasible solution. For the exact approach, the production scheduling model with mining and mill capacity constraints is solved within a binary context per period as a single time period problem. The author also benefits from the variable elimination techniques by pre-checking the mining capacity violations and generating a valid inequality to strengthen the formulation. For the sequential greedy heuristics, a cone is generated with a vertex on each block with a purpose of finding the set of blocks which will minimize the deviations from the mining and mill capacity requirements while maximizing the NPV. One can make a similar analogy by applying the floating cone algorithm to a multi time production scheduling problem to generate initial integer feasible solutions. Then, the author implemented the variable neighborhood descent (VND) search method of Hansen and Maladenovic (2001) to improve the initial integer feasible solutions. The algorithm works in three steps. Given the initial integer feasible solution, the algorithm first trades the ore and waste blocks between the consecutive time periods. Then, the blocks together with the predecessors are shifted forward and backward in time until no more NPV improvement is achieved.

Lamghari and Dimitrakopoulos (2015) proposed three heuristic algorithms, one for generating an initial integer feasible solution called look-ahead heuristic (LAH) and the others for improving the generated integer feasible solution to maximize the NPV of the two-stage stochastic mine production scheduling problem named a network-flow based heuristic (NF) and a diversified local search heuristic (DLS). In order to apply the LAH, the multi-time period stochastic model is re-written as a single time period stochastic model. LAH is an improved version of the greedy heuristics presented in Lamghari (2014). LAH generates cones only with the blocks if the objective function value can be improved while obeying the mining constraints. The iterations terminate when there is no such cone that can improve the latest objective function value. Once the initial integer feasible solution is obtained the author applied the NF heuristic to improve the generated solution. The idea of the NF heuristic is to search the initially generated solution space extensively by shifting the blocks from one period to another in order to delay and advance the extraction of the blocks with a purpose of improving the NPV. Also, the NF heuristic has an advantage over the variable neighborhood descent (VND) heuristic introduced by Lamghari (2014) by allowing a search in the solution space instead of just considering the feasible solution space. Since the neighborhoods generated with the forward and backward processes of the NF are large compared to the Tabu Search (TS) presented by Lamghari (2012) and VND neighborhoods, the author converted the problem to a network model and solved the longest path problem (LPP) to find the solution that gives the best improvement in NPV. The author proposed the pulling algorithm of Ahuja (1993) to solve the longest path problem as a network problem. If the solution obtained is not better than the previous one, then the algorithm terminates. Secondly, the author also proposed diversified the local search heuristic (DLS) to improve the initial integer feasible solution. The heuristic DLS is basically the combination of the VND and NF heuristics. Instead of applying the NF heuristic directly to the initial integer feasible solution obtained by LAH, the author first applies VND to the solution so that the NF heuristic will begin with an improved version of the initial integer feasible solution which will also avoid the local optima of the VND heuristic. If the consecutive application of the VND and NF heuristics do not improve the solution, the algorithm terminates, and the current solution is accepted as the final best solution to the problem.

2.3.3.1 Shortcomings of the Integer Solution Techniques

Mining operations can be truly optimized if an optimal integer solution can be found to the production scheduling model proposed by Johnson in 1968. The generic model encompasses block by block scheduling subject to mining and mill capacity and blending constraints while obeying the pit slope requirements. The existing solution algorithms to solve the integer programming models to a proven optimality such as branch and bound (A. H. Land and A. G. Doing, 1960) and branch and cut (M. Padberg and G. Rinaldi, 1983) are not efficient enough to solve large scale mine planning production scheduling problems within a binary context.

2.3.3.1.1 Lagrange Relaxation Technique

Researchers investigated new solution techniques to solve the mine production scheduling problems with the integer variables. Dagdelen (1985), Tachefine and Sumois (1996), Akaike (1999), Kawahata 2006, Cullenbine (2011), Lambert (2013) implemented various forms of Lagrange relaxation techniques with a goal of achieving an integer solution. If the optimal solution of a Lagrange relaxation problem is feasible to the original problem, it provides an upper bound solution to the original problem. On the other hand, there is no guarantee that a feasible solution to the original problem by adjusting the Lagrange multipliers can be obtained. As shown by Everett in 1963, Lagrange multipliers measure the change in the objective function value when the resource constraints (mining and mill capacity or blending constraints) are expended. Since the relationship between the resource expenditure and the objective function is non-linear, whenever the function has a non-concave region, the hyperplane defined by the Lagrange multiplier cannot be tangent to the accessible points on the region which constitutes the “gap” problem (Everett, 1963). The presence of a gap problem will prevent Lagrange relaxation solution from providing a feasible solution to the original problem. So far, researchers have not identified a method to overcome the gap problems. This will make mine production scheduling problems solved with Lagrange relaxation techniques less attractive since gap problems are not avoidable which appears to be due to the non-homogeneity of a mineral deposit.

2.3.3.1.2 Fundamental Tree

Ramazan (2001) aggregated the blocks into fundamental trees based on only considering the values of the blocks and the precedence relationships. Then, the author treated each tree as an integer variable and solved the mine production scheduling problem under mining and mill capacity and blending constraints. Since, the complexity of the integer programming models is directly related with the number of variables, the author first generated the pushbacks and then scheduled the trees (grouped blocks) from the pushbacks. Unfortunately, since the author uses the aggregation technique together with pushbacks, the weaknesses of those two approaches presented above will result in poor quality solutions. Moreover, for the large scale open pit mine production scheduling problems, the model will have large number of fundamental trees which will increase the complexity of the integer programming model which might prevent obtaining an integer solution.

2.3.3.1.3 Heuristic Techniques

2.3.3.1.3.1 Heuristic Techniques to Obtain Initial Integer Feasible Solution

Since the scale of mine production scheduling problems restrict the usage of exact solution algorithms, researchers implemented heuristic techniques to find the integer feasible solutions fast and as close as possible to the optimal LP solution. Chicoisne (2012), Lamghari and Dimitrakopoulos (2012, 2015), Lambert (2013), Lamghari et al. (2014) proposed methods to obtain initial integer feasible solutions. Among these methods, Lamghari criticized the random heuristic (RH) method proposed by Lamghari and Dimitrakopoulos in 2012 for its myopic approach. Also, the solution times of the improvement heuristics applied to the initial integer feasible solutions generated by the random heuristics are highest according to the cases presented. The author also criticized the greedy heuristic proposed by Lamghari et al. (2014) for considering all the unmined blocks as a candidate for the cones generated and selecting cones that will only minimize the deviations from the upper bound mining capacity requirements even if the selected cone does not improve the current solution. The author proposed a look ahead heuristic (LAH) approach which is an improved version of the greedy heuristic where the candidate blocks for the cone are selected if it leads to an improvement of the objective function value for the time period t, while the upper bound mining capacity constraints are not violated. Although the author didn't present the actual solution times that it takes to obtain an integer feasible solution by applying RH and LAH, it is mentioned that LAH is much faster. Also, since the quality of the solutions generated by the improvement heuristics after obtaining an initial integer feasible solution are dependent on the initial solution, the case studies show that regardless of which improvement heuristic method is used, the initial integer feasible solutions generated by LAH result in a better solution compared to the RH and the combined solution times are faster. Lambert proposed a maximum valued feasible pit (MVFP) method to generate an initial integer feasible solution to the model which considers lower and upper bounds on the mining and mill capacity constraints. According to the case study presented by the author, it takes 5000 seconds (˜1 hr 20 min) for the MVFP method to generate an initial integer feasible solution for the models with 10000 blocks and a time horizon of 15 years. The solution time is quite high for a fairly small size model. Chicoisne et al. (2012) proposed a TopoSort heuristic which uses LP relaxation solutions to assign weights to each block based on the expected mining time and then schedules the blocks by ranking the weights. The authors implemented the TopoSort heuristic to a case which has more than 4 million blocks with a time horizon of 15 years. According to the results presented, the initial feasible solution to the model which has an upper bound on mining and mill capacity constraints is achieved in less than a second. So far, none of the heuristic methods that generate initial integer feasible solutions are able to handle the models with blending constraints. Moreover, MVFP is the only one that can handle lower bound mining and mill capacity constraints but uses approximately 1 h 20 minutes to generate a solution to a model with 10000 blocks which is too long for such a small size model. Also, the comparison between MVFP, LAH and TopoSort heuristic methods in terms of the quality of the solutions they generate has not presented in the literature.

2.3.3.1.3.2 Solution Improvement Heuristic Techniques

An initial integer feasible solution serves as a guide to the improvement heuristic techniques developed by Amaya et al. (2009), Cullenbine (2011), Lamghari and Dimitrakopoulos (2012, 2015), Lambert (2013), Lamghari et al. (2014). The case study presented by Amaya et al. (2009) shows that near optimal solutions were achieved in 4 hours by implementing Local search heuristic (LS) to the Marvin (53668 blocks), AmaricaMine (19320 blocks), AsiaMine (772800 blocks) datasets where the models have only upper bound mining and mill capacity constraints. Similar solutions are also presented by Chicoisne et al. (2012), when the authors ran the LS heuristic in about 4 hours once they obtained an initial integer feasible solution with the TopoSort heuristic. Moreover, the authors show that once the number of the resource capacity constraints increase, the optimality gap achieved in 4 hours also increased. The applicability of LS to the real mine models that include upper and lower bounds on resource and blending constraints still remains elusive. The Sliding time window heuristic (STWH) proposed by Cullenbine (2011) can solve the models consisting of upper and lower bounds on the mining and mill capacity constraints. The results presented by the author shows that it may take up to 2 hr 40 min to solve a model with 25000 blocks and 15 time periods and produce a solution with an optimality gap of 4.3%. This is so far the best-known solution obtained in the models with lower bounds on the resource constraints. Moreover, since the approach utilizes Lagrange relaxation techniques, it will be vulnerable to potential gap problems. The Tailored Lagrange relaxation method (TLR) proposed by Lambert (2013) can be also applied to the models with upper and lower bounds on resource constraints. The author applied the TLR to the same case studies presented by Cullenbine in 2011 which makes the comparison of the STWH with TLR easier. Although STWH was able to generate a solution for the model with 25000 blocks, TLR could not obtain a solution with an optimality gap less than 6.4% in 10 hours. By looking at the solution times of the remaining models where the number of blocks vary from 10000 blocks to 18000 blocks, it can be concluded that the STWH has a better performance than TLR Like STWH, the TLR method may also suffer from the weaknesses of the Lagrange relaxation approach since gap problems may exist. Lamghari and Dimitrakopoulos (2015) presented a case study where the Tabu Search (TS), variable neighborhood descent (VND), network flow (NF) and diversified local search (DLS) improvement heuristic methods are compared in terms of the solution times and the optimality gap they produce. The authors concluded that the TS has the worst performance and its solution time can increase depending on the quality of the initial integer feasible solution it starts with. Although VND performs better than NF for the small size models, NF can outperform VND for the relatively larger size problems but may take a longer time than VND to find a solution. The authors also concluded that DLS which is the combination of NF and VND methods performs the best in terms of the quality of the solution it generates and also it does not depend on the quality of the initial integer feasible solution. These 4 methods are implemented on the stochastic models which consist of at most 48000 blocks with upper bound mining and mill capacity constraints. A performance comparison of these methods with the LS, STWH and TLR has not been presented. So far, it can be concluded that among the existing improvement heuristic methods LS can solve the models that has at most 4 million blocks in a block model and 15 time periods subject to upper bound mining and mill capacity constraints within a 4% of optimality gap in 4 hours. Also, STWH remains the only local improvement heuristic that can solve the model with 25000 blocks and 15 time periods in 2 hr 40 min within an optimality gap of 4.3%. If one considers solving a large case mine production scheduling problem that has 5 to 10 million blocks, multiple destinations subject to mining and mill capacity, blending and varying slope constraints within a binary context, the currently developed heuristic algorithms will not be able to produce an integer optimal solution.

2.4 Summary of the Current State of Open Pit Mine Production Scheduling

The researchers have been trying to solve this problem since 1960's unfortunately, the proposed solution techniques are not capable of providing an optimal integer solution to the mine production scheduling problems modeled with mining and mill capacity, blending and stockpile constraints under grade uncertainty. There are numerous pushback design, heuristic and aggregation methods investigated in the literature and the closest integer optimal solutions are accomplished for the problems modeled with upper bound mining capacity constraints. Since, the size of a mining problem makes the exact integer programming solution techniques inapplicable, many attempts are made to solve the problem with pushback design, heuristic and aggregation methods which cannot be proven to converge to the true optimal solution. So far, TopoSort heuristic algorithm together with the Local search heuristic algorithm can generate an integer solution for a block model consists of 4 million blocks with a 4% optimality gap in 4 hr when modeled with up to two upper bound capacity constraints and the sliding time window heuristic can provide an integer solution within a 4.3% optimality gap in 2 hr 40 min when modeled with an upper and lower bound capacity constraints for 25,000 blocks. Although these methods can generate close integer optimal solutions, their limited applicability results with a preclusion of their implementation on mine production scheduling problems. Contrarily, the presently disclosed integer solution algorithm proposed in this dissertation that can solve the mine production scheduling problems modeled with multi capacities, grade blending, grade uncertainty, stockpiles, variable pit slopes and multi destinations as an integer programming problem will realize the optimization process on real life mining problems.

### SUMMARY

Disclosed herein are integer solution algorithms developed through advantageously augmenting Bienstock-Zuckerberg algorithms to achieve optimality. The presently disclosed algorithm proceeds with splitting the original problem into master and subproblems, the subproblem solutions play a role in terms of defining the coordinates of the extreme point of a polytope located on the intersection of the hyperplanes. The solution to the subproblem is not necessarily integer feasible to the capacity constraints of the original problem. In the regular BZ algorithm, if the partitions defining the solution space of the master problem are infeasible to the capacity constraints, the λ variables which are essentially the weight of each partition may result with fractional values to honor the requirements enforced by the capacity constraints. As this is natural from a linear programming point of view, if the λ variables are defined as binary variables, the solution to the master problem may end up being infeasible. Henceforth, the subproblem solutions which are indeed max closures, must be partitioned into sub-closures that are integer feasible to the capacity constraints of the original problem. As it is illustrated in FIG. 4.14, the outer polytope represents the subproblem solution space where the blue dots are the extreme points which may not appear in the capacity feasible region bounded with a green outline. The solution space to the original problem which is further defined by the hyperplanes representing the additional side constraints will be inside the capacity feasible region and is shown in FIG. 4.14 outlined in black. While the yellow colored corner point defines the LP optimal solution to the original problem, the red points are the set of integer feasible points to the original problem space.

At each iteration k, the solution to the subproblem generates a max closure \vec{C}ₖ which may violate the capacity constraints. Although \vec{C}ₖ only contains the blocks mined in the closure, we still know the actual periods the blocks are mined in since the subproblem is a multi-time period sequencing problem. If the problem has t number of periods, there may exist at least t number of capacity constraints. Hence, the number of blocks or total tonnage mined in closure \vec{C}ₖ at each period can be checked against the capacity requirements of that period. Any time period where the capacity requirements to be satisfied will be further split into sub-closures where each sub-closure honors the capacity requirements. The splitting may continue for a given period until the remaining blocks for that period satisfies the capacity requirements. The mining problem may consist of a number of capacity constraints in an upper bound form where it may not be possible to generate a closure which all constraints are binding. The underlying reason could be a gap problem which is inevitable in parametrization concepts if it exists. Nevertheless, we haven't observed any downside of not being exact with the processing and production requirements as long as the sub-closures are integer feasible. Eventually, by splitting \vec{C}ₖ into sub-closures, each period will end up having its own integer feasible sub-closures as long as the blocks are mined for that period in \vec{C}ₖ.

### BRIEF DESCRIPTION OF THE DRAWINGS

FIG. 1.1 shows an example of a flowchart of BZ algorithm together with the TopoSort Heuristic technique.

FIG. 1.2 shows an example of a solution methodology.

FIG. 4.1 shows an example of a solution methodology.

FIG. 4.2 shows an example of a cross section of a polytope illustrating the subproblem solution space (outer polytope) and the original problem solution space (inner polytope). Blue dots are the extreme points of the subproblem solutions, the red dot is the optimum extreme point of the original problem solution.

FIG. 4.3 shows an example of a node structure of the original problem variables and the subproblem variables.

FIG. 4.4 shows an example of an economic block model for the potential destinations of the blocks x^{t}_{bd}=1 if block b is mined in time period t and send to destination d; 0 otherwise.

FIG. 4.5 shows an example of production scheduling inputs.

FIG. 4.6 shows an example of fixing the destinations based on the highest block value. The shaded blocks represent the most valuable destinations for a block in time period 1 and period 2.

FIG. 4.7 shows an example of a subproblem solution column and the mining plans generated per period.

FIG. 4.8 shows an example of a subproblem solution column on the left is split into destination segments on the right in order to represent the original problem variable z^{t}_{bd} node structure in the master problem.

FIG. 4.9 shows an example of modified block values by the duals for period 1 and period 2. The shaded blocks represent the most valuable destinations for a block in time period 1 and period 2.

FIG. 4.10 shows an example of a subproblem solution column and the mining plans generated per period.

FIG. 4.11 shows an example of a subproblem solution column on the left is split into destination segments on the right in order to represent the original problem variable z^{t}_{bd} node structure in the master problem.

FIG. 4.12 shows an example of a current state of the partitions after appending the \vec{v₃} solution column to the previous set of partitions. At this stage \vec{v₃} is not orthogonal to \vec{v₁} and \vec{v₂} yet.

FIG. 4.13 shows an example of new set of partitions after the orthogonalization process.

FIG. 4.14 shows an example of a cross section of a polytope illustrating the solution space of the presently disclosed integer solution algorithm.

FIG. 4.15 shows an example of orthogonal partitions of \vec{Cₘ} and \vec{Cₙ} on a plane.

FIG. 4.16 shows an example of a primal-dual relationship of the master problem.

FIG. 4.17 shows an example of a solution space of the original problem and the final set of partitions.

FIG. 4.18 shows an example of classification of the blocks into ore and waste.

FIG. 4.19 shows an example of undiscounted economic values of the blocks.

FIG. 4.20 shows an example of a production scheduling input.

FIG. 4.21 shows an example of iteration 1—Integer feasible mine plan for period 1 with penalized values.

FIG. 4.22 shows an example of iteration 1—Integer feasible mine plan for period 2 with penalized values.

FIG. 4.23 shows an example of iteration 1—Integer feasible mine plan for period 3 with penalized values.

FIG. 4.24 shows an example of iteration 1—Integer feasible mine plan for period 3 with penalized values.

FIG. 4.25 shows an example of Iteration 1—Integer feasible pits per period. Period 1 pit is shown with yellow, period 2 pit is shown with green and period 3 pits are shown with blue and pink colors

FIG. 4.26 shows an example of Iteration 1—Initial set of integer feasible orthogonal partitions. Colors represent the blocks considered in the partition.

FIG. 4.27 shows an example of Iteration 2—Mine plan generated by solving the subproblem shown by the shaded blocks.

FIG. 4.28 shows an example of Iteration 2—Period 2 pit is split into integer feasible mine plans where each color represents a pit.

FIG. 4.29 shows an example of Iteration 2—Subproblem solution column on the left is split into integer feasible columns on the right.

FIG. 4.30 shows an example of Iteration 2—Current state of the partitions after appending the integer feasible columns \vec{h} to the previous set of partitions \vec{v}. At this stage the columns \vec{h} are not orthogonal to \vec{v} yet.

FIG. 4.31 shows an example of Iteration 2—Integer feasible orthogonal partitions. Colors represent the blocks considered in the partition.

FIG. 4.32 shows an example of Iteration 2—Integer feasible orthogonal partitions presented as pits per period.

FIG. 4.33 shows an example of Iteration 3—Mine plan generated by solving the subproblem. Period 1 pit is shown with yellow color and period 2 pit is shown with blue color.

FIG. 4.34 shows an example of Integer feasible mine plan for period 2 with penalized values.

FIG. 4.35 shows an example of Integer feasible mine plan for period 2 with penalized values.

FIG. 4.36 shows an example of Iteration 2—Subproblem mine plan is split into integer feasible mine plans where each color represents a pit.

FIG. 4.37 shows an example of Iteration 3—Subproblem solution column on the left is split into integer feasible columns on the right.

FIG. 4.38 shows an example of Iteration 3—Current state of the partitions after appending the integer feasible columns \vec{h} to the previous set of partitions \vec{v}. At this stage the columns \vec{h} are not orthogonal to \vec{v} yet.

FIG. 4.39 shows an example of Iteration 3—Integer feasible orthogonal partitions. Colors represent the blocks considered in the partition.

FIG. 4.40 shows an example of Iteration 3—Integer feasible orthogonal partitions presented as pits per period.

FIG. 4.41 shows an example of a schedule of the optimal mine plan.

FIG. 5.1 shows an example of a McLaughlin Mine process flow.

FIG. 5.2 shows an example of a plan view of an ultimate pit.

FIG. 5.3 shows an example of East-11075 cross section taken from the ultimate pit of FIG. 5.2.

FIG. 5.4 shows an example of North-9800 cross section taken from the ultimate pit of FIG. 5.2.

FIG. 5.4 shows an example of yearly processed tonnage and the average grade at the mill.

FIG. 5.5 shows an example of yearly processed tonnage and the average grade at the mill.

FIG. 5.6 shows an example of yearly processed tonnage and the average grade at the leach pads.

FIG. 5.7 shows an example of risk behavior of the mine plan over the production years.

FIG. 5.8 shows an example of plan view of the yearly production schedules.

FIG. 5.9 shows an example of yearly production schedules on East-11075 cross section.

FIG. 5.10 shows an example of yearly production schedules on North-9800 cross section.

FIG. 5.11 shows an example of comparison of the ultimate pit vs final pit outline on a plan view.

FIG. 5.12 shows an example of a gold deposit mine process flow.

FIG. 5.13 shows an example of a plan view of the ultimate pits.

FIG. 5.14 shows an example of East-28000 cross section taken from the ultimate pit.

FIG. 5.15 shows an example of North-43000 cross section taken from the ultimate pit.

FIG. 5.16 shows an example of yearly processed tonnage and the average grade at the mill.

FIG. 5.17 shows an example of yearly processed mill and leach tonnage and the average grade at the leach pad.

FIG. 5.18 shows an example of yearly production schedules shown on a plan view.

FIG. 5.19 shows an example of yearly production schedules shown on East-27700 cross section.

FIG. 5.20 shows an example of yearly production schedules shown on North-55200 cross section.

### DETAILED DESCRIPTION

A method for optimizing a mining sequence for a pit mine is disclosed. The method includes determining an initial plurality of mining plans, wherein each mining plan of the plurality of mining plans includes a plurality of blocks of ore to be mined and each ore block of the plurality of ore blocks has a first economic value; determining an objective function subject to one or more time periods and one or more capacity constraints; modifying the first economic value of an ore block of the plurality of ore blocks based on one or more of the capacity constraints to determine a modified first economic value; determining one or more feasible mining plans based on the one or more capacity constraints; orthogonalizing the one or more feasible mining plans with respect to the initial plurality of mining plans; determining a second plurality of mining plans based on the one or more capacity constraints. According to some embodiments, one of the capacity constraints is mill capacity. According to some embodiments, one of the capacity constraints is leach field capacity. According to some embodiments, one of the capacity constraints is total mining capacity. The method can also include determining the first economic value of each or block of the plurality of ore blocks for a plurality of time periods.

The new NPV maximizing solution algorithm can solve the mine production scheduling problems modeled with multi capacities, grade blending, grade uncertainty, stockpiles, variable pit slopes, multi destinations and truck hours. Basis for a commercial software package that would provide optimal production scheduling for any company involved in open pit and underground mining. So far there is no known algorithm, either commercially available or presented in the literature, that can provide an optimal integer solution to the open pit mine production scheduling problem with capacity constraints together with lower and upper bound blending constraints. This invention has the potential to improve the profitability of a mining operation by 20-30%.

The theories outlined in this disclosure support the idea of breaking the subproblem solutions of the decomposition problem into “capacity integer feasible” solutions. Since the decomposition algorithms solve the master and subproblems iteratively, the description of the algorithm shown in the thesis applies the idea of generating capacity integer feasible solutions to the subproblem at each iteration. In a bigger scale problem, one can apply the idea of generating capacity integer feasible solutions at the beginning of the problem (before the iterations start) and continue solving the rest of the iterations with the decomposition routine. As it was outlined in the thesis, once the optimal LP solution is achieved, the final iteration of the decomposition algorithm which lead to a LP optimal solution will be solved one more time by declaring the variables as integers which will generate an optimal integer solution to the problem. A driver of this algorithm is the idea of breaking a subproblem solution of a decomposition problem into an integer feasible solution which will generate such a solution space where the LP optimal and integer solutions are captured when the decomposition algorithm converges to an optimality. Therefore, solving the final iteration of the decomposition algorithm with integer variables will provide an optimal integer solution. It should be noted that any intention of using a decomposition algorithm to solve a mine production scheduling problem either by starting the problem with integer feasible solutions and continuing with a decomposition routine or breaking the subproblem solutions generated at any iterations of the decomposition algorithm into integer feasible solutions to the constraints of the problem should be a violation of the provisional patent.

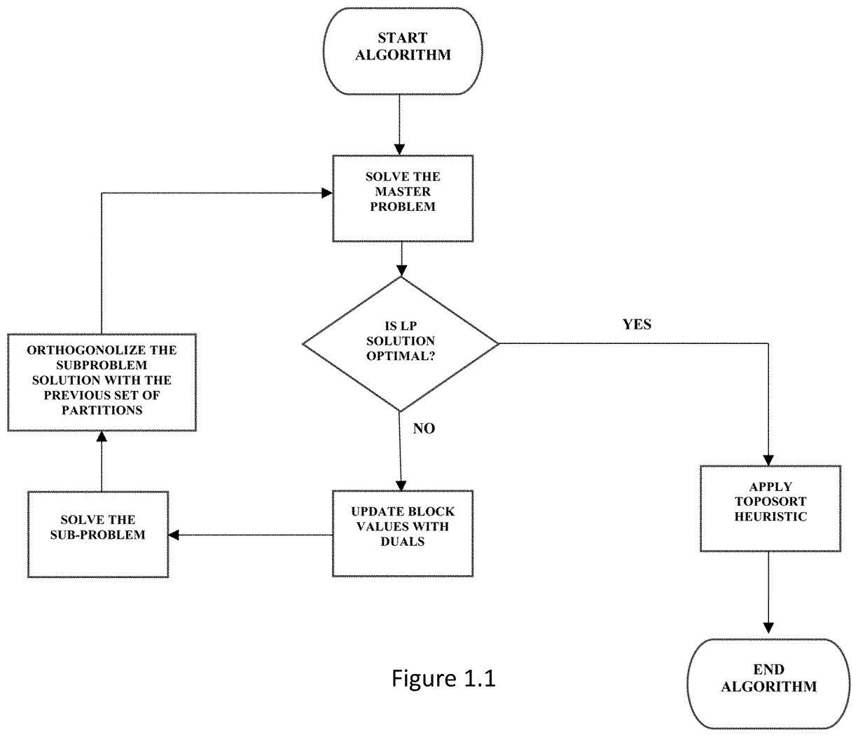

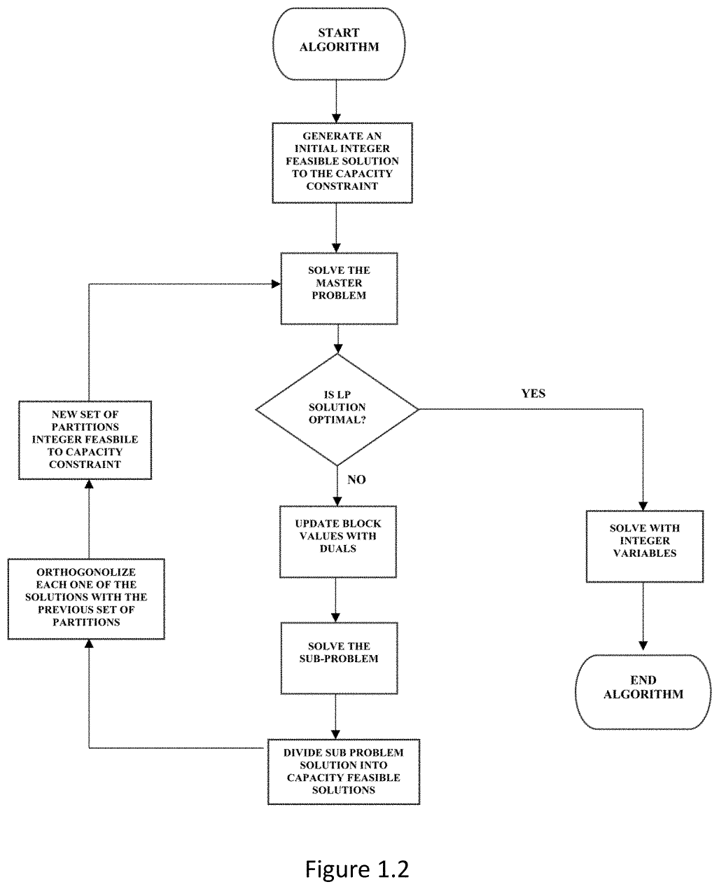

The FIG. 1.1 illustrates the TopoSort heuristic algorithm proposed by Chicoisne (2012) which benefits from the Bienstock-Zuckerberg (BZ) decomposition algorithm to determine the optimal LP solution as a guide to round the fractional solutions to an integer result. Expected extraction time of a block is determined by multiplying the proportion of the block mined with its extraction period. Once the integer feasible solution is found, Amaya's local heuristic technique is applied in order to improve the initial integer feasible solution. The algorithm can be applied for models with single or two capacity constraints in an upper bound form.

### Presently Disclosed Integer Solution Algorithm for Multi-Destination Open Pit Mine Production Scheduling Problem

The methods and systems of the present disclosure can solve the mine production scheduling problems modeled with multi capacities, grade blending, grade uncertainty, stockpiles, variable pit slopes, multi destinations and truck hours will be covered extensively. It should be stressed that the blocks will not have any pre-determined destinations based on grades, cycle times, material type or some other criteria since the best destination selection per block will be done during the optimization process to maximize the NPV. The mathematical model for the said problem is generated at the end of the previous section. A novel solution algorithm will be introduced to solve this complex model. The presently disclosed solution algorithm will exploit the mathematical theories behind the Bienstock-Zuckerberg decomposition algorithm which is presently the fastest solution algorithm for the precedence constrained production scheduling type problems such as mine production scheduling problems. In order to set the groundwork, the BZ algorithm will be covered in detail. Then, a comprehensive study on the presently disclosed integer solution algorithm will be presented. Discussions will be given to ensure the working mechanism of the algorithm functions within the frame of mathematical theories.

The mine production scheduling problem is an integer programming problem solved for mining decision variables in a binary form which constitutes the time period when the block is mined and the destination to which the block is sent. So far there is no method that can generate a theoretically proven optimal integer solution to the large-scale integer programming type problems, including mine production scheduling problems due to the exponential computational complexity of the existing exact algorithms. Nevertheless, a theoretical upper bound can be achieved if the linear relaxation of the mine production scheduling problem can be solved to a proven optimality. Henceforth, the knowledge of the optimal solution to a linear relaxation of the mine production scheduling problem will facilitate the comparison of the integer feasible solution to judge the success of the optimization process. In other words, if one can generate an integer feasible solution to the problem, the degree of success of the integer solution can be measured if the optimal solution to the linear relaxation of the same problem is known. The difference between the integer feasible solution and the optimal linear solution of the same problem is often called an “optimality gap”. The goal of the optimization process is finding an integer feasible solution that will minimize the optimality gap. The exhaustive search of the integer solutions attained by heuristic methods cannot provide the optimality gap since the methods are not fundamentally sophisticated with the mathematical theorems that will lead to a proven optimal solution. On the other hand, the decomposition algorithms are developed based on intricate mathematical theorems that can guarantee the optimality of the linear relaxation solutions for the mine production scheduling problems. Henceforth, the integer solution algorithm developed in this thesis relies heavily on the mathematical theories behind the Bienstock Zuckerberg decomposition algorithm.

The disclosed NPV maximizing solution algorithm can solve mine production scheduling problems modeled with multi capacities, grade blending, grade uncertainty, stockpiles, variable pit slopes, multi destinations and truck hours. It should be stressed that the blocks, in most cases, will not have any pre-determined destinations based on grades, cycle times, material type or some other criteria since, in many embodiments, the best destination selection per block may be done automatically during the optimization process to maximize the NPV. Presently there are no known algorithms, either commercially available or presented in the literature, that can provide an optimal integer solution to the open pit mine production scheduling problem with capacity constraints together with lower and upper bound blending constraints. In most embodiments, the difference between the integer feasible solution and the optimal linear solution of the same problem is called an “optimality gap”. One advantage of the presently disclosed integer solution algorithm developed and described here is highlighted by the unexpected ability of solving problems that have more than 7 million variables as an integer problem with an optimality gap as small as 0.01% within 5 hours 30 minutes as an example. This algorithm will be extremely beneficial to any company involved in open pit mining.

4.1 Flowchart of Solutions Methodology

4.2 The Bienstock-Zuckerberg Decomposition Algorithm

The Bienstock-Zuckerberg algorithm (BZ) is the most powerful decomposition algorithm that can solve the LP relaxation of the large-scale mine production scheduling problems to a proven optimality. The LP optimality is accomplished by iteratively solving the master and subproblem until the convergence criteria is satisfied. It has been reported by Munoz et al. ((2017). A study of the Bienstock-Zuckerberg algorithm: applications in mining and resource constrained project scheduling. Computational Optimization and Applications, 69(2), 501-534) that the BZ algorithm outperforms the counterpart Dantzig-Wolfe decomposition algorithm. The algorithm derives its strength mainly by exploiting certain mathematical structures. First, the subproblem formulation defines a totally unimodular system that allows the subproblem to be formulated as a max flow problem as first shown by Johnson (1968). The subproblem is a multi-time period sequencing problem which can be represented on a network structure as first shown by Dagdelen (1985). Hochbaum (2008) proposed the Pseudoflow algorithm which is the fastest known algorithm for solving the max flow problems. Henceforth, realizing the underlying network structure of the subproblem and implementing the Pseudoflow algorithm to solve the subproblem as a max flow problem will speed up the convergence process. Secondly, the orthogonalization process that takes place between the subproblem solution and the former partitions increases the dimension of the solution space at each iteration which will allow the LP optimal solution to be captured quickly. The third strength is the contraction operation that leads to the conservation of the original problem structure at the master problem while working with the reduced number of rows and columns.

The generic representation of the original problem adopted in this research is initially shown by Bienstock Zuckerberg (2009, 2010 and 2015) and extended by Munoz (2017) as presented below.

Original Problem:

Max Z=c^{T}z (4.1)

Subject to:

Az≤b (4.2)

Hz≤h (4.3)

z∈{0,1}ⁿ (4.4)

(4.1) represents the objective function value of the original problem where c^{T} is the cost vector. (4.2) encompasses the sequencing and reserve (ensures that the block is mined only once) constraints. (4.3) represents the resource capacity, blending and risk constraints in other words the side constraints. (4.4) ensures that the mining decision variables are in binary form.

The original problem is a well-known NP-hard problem form due to the presence of side constraints and the binary variables. Nevertheless, the LP relaxation of the problem can be solved by decomposing the problem into a master problem and a subproblem. Below is the representation of the subproblem.

Subproblem:

Max Z=c^{T}v−π(Hv−h) (4.5)

Subject to:

Av≤b (4.6)

v∈{0,1}ⁿ (4.7)

The subproblem objective function (4.5) is written by penalizing the side constraints (4.3) of the original problem with the dual values “π^{T}” obtained by solving the master problem. The subproblem is often called a Lagrange relaxation problem. The subproblem is similar to the ultimate pit problem except the blocks are sequenced in multi time period. Since the subproblem or Lagrange relaxation problem has a totally unimodular structure, Johnson (1968) showed that the single period version of the subproblem can be solved as a maximum flow network problem which is faster than solving the problem as a LP. The idea is extended by Dagdelen (1985) by exposing the mathematical relationship between the dual of the multi time period Lagrange relaxation problem which is identical to this subproblem and the underlying network structure. Currently Hochbaum's Pseudoflow algorithm is the fastest known algorithm that can solve the ultimate pit limit problem or multi time period sequencing problem as a maximum flow and minimum s-t cut problem. The steps of the Pseudoflow algorithm will be outlined in the next section.

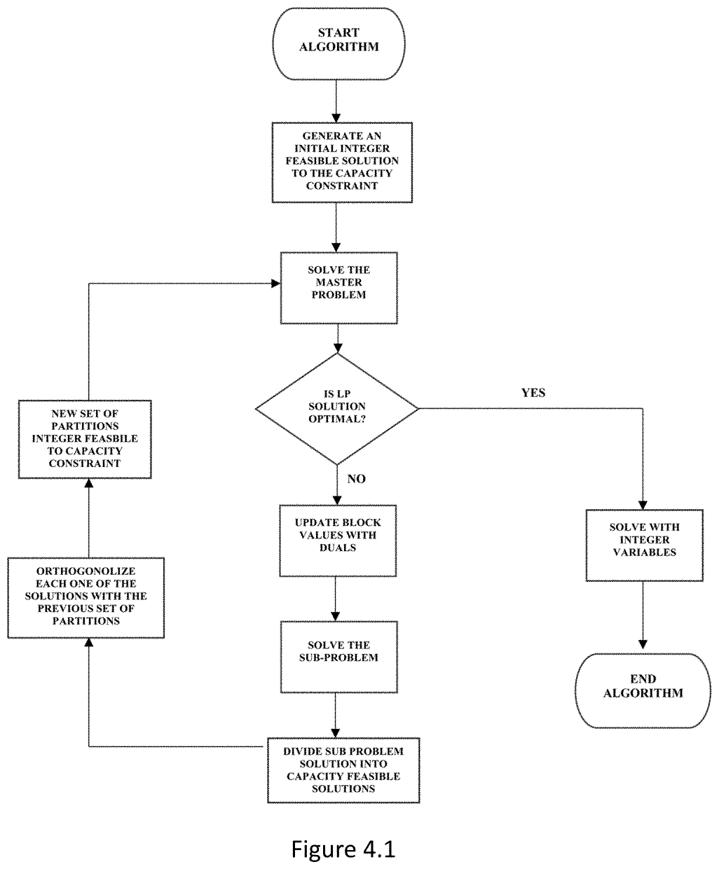

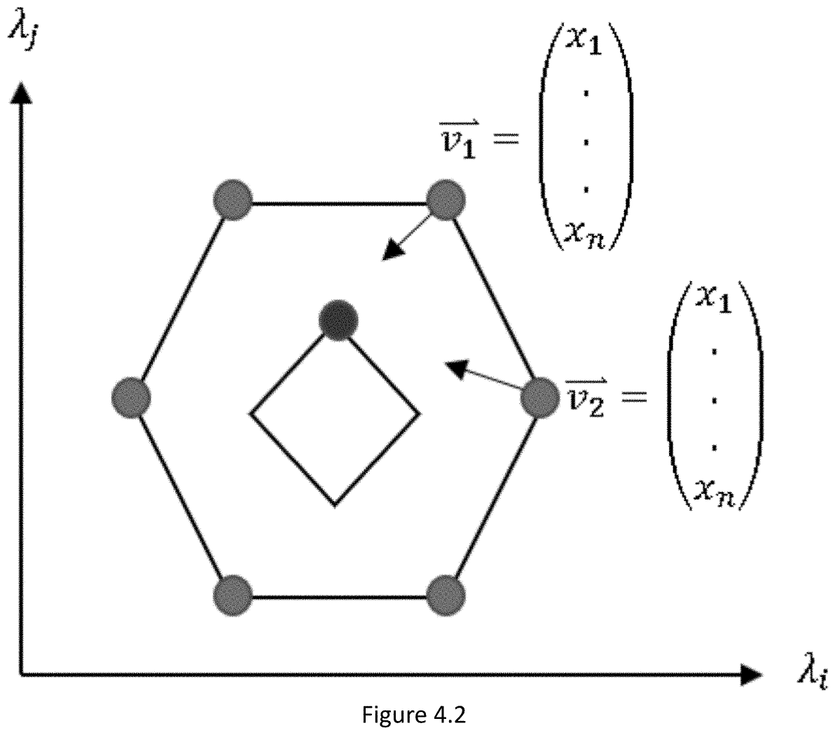

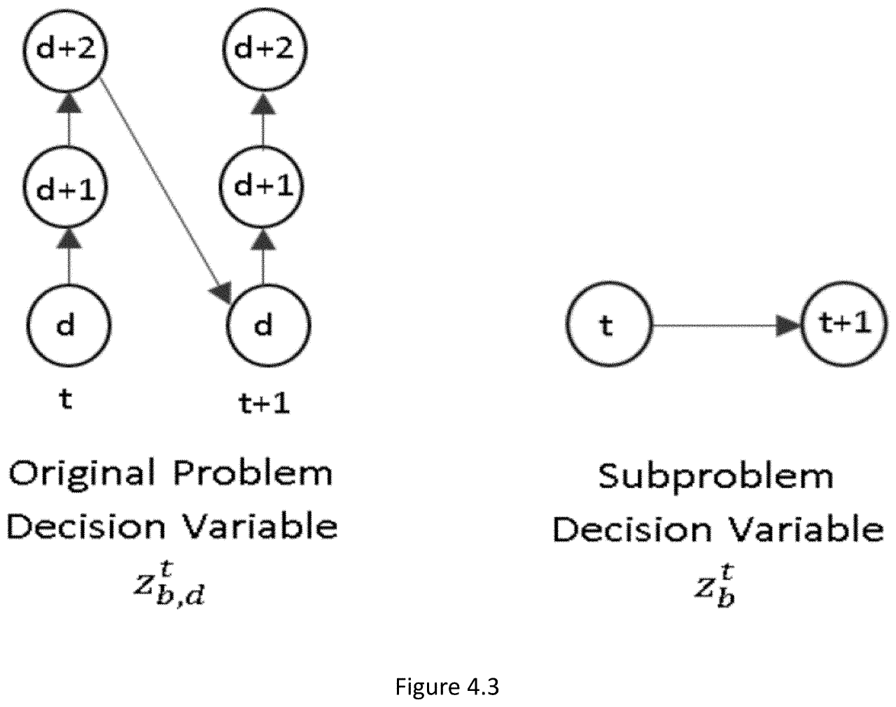

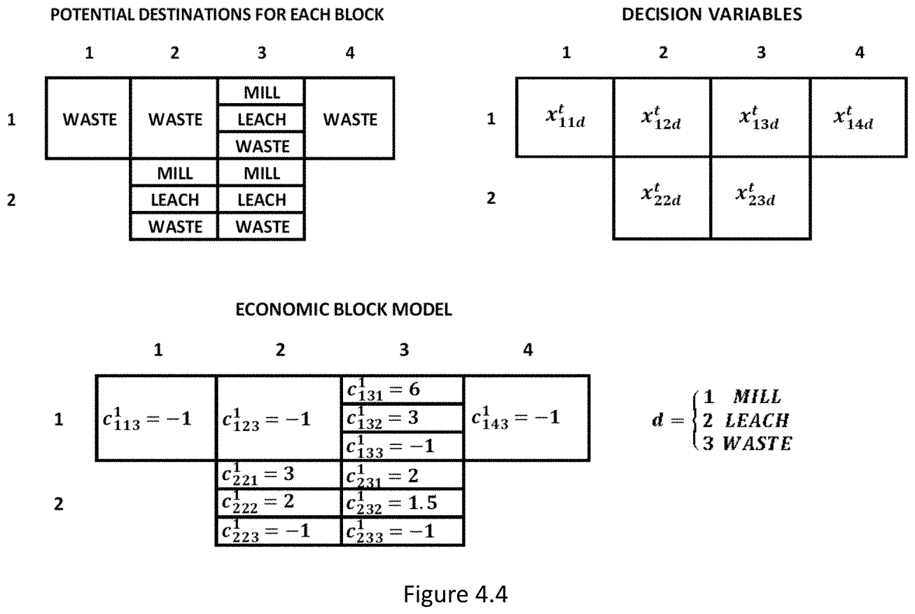

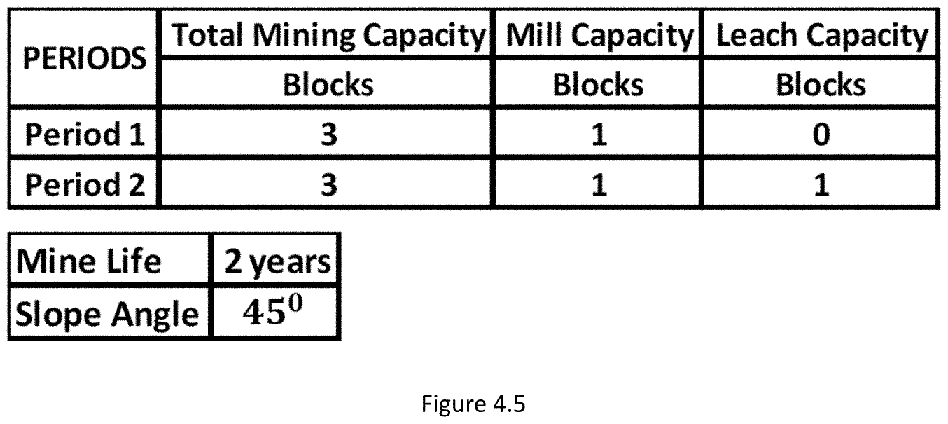

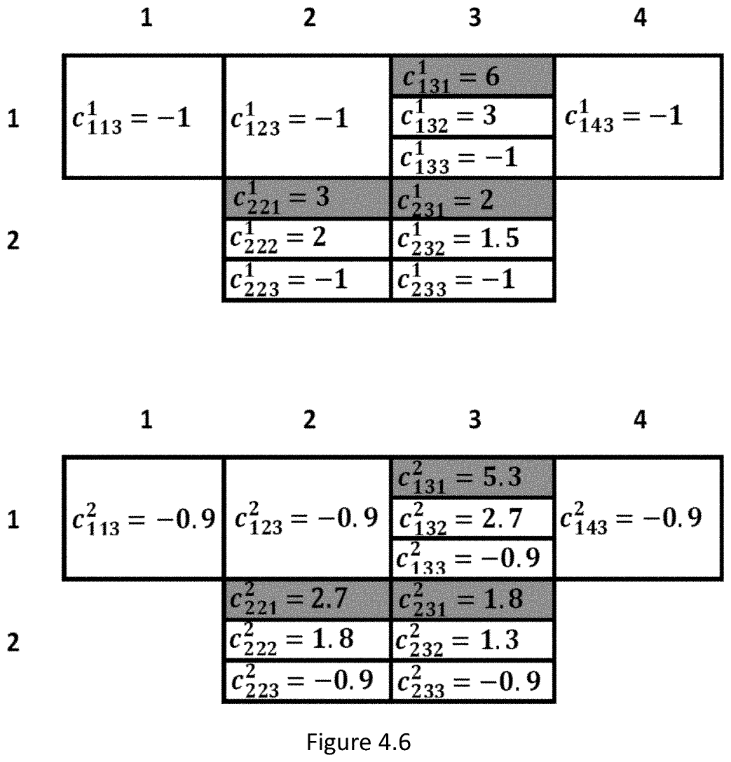

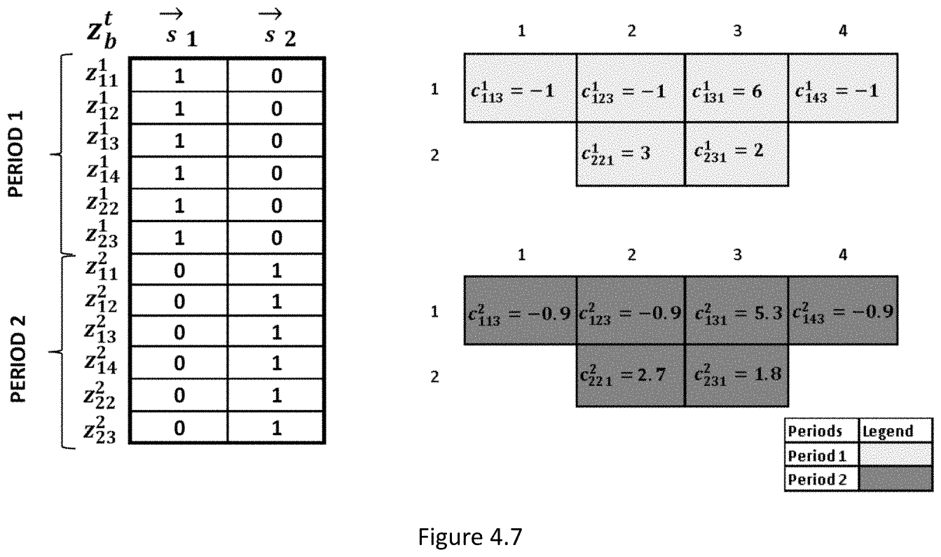

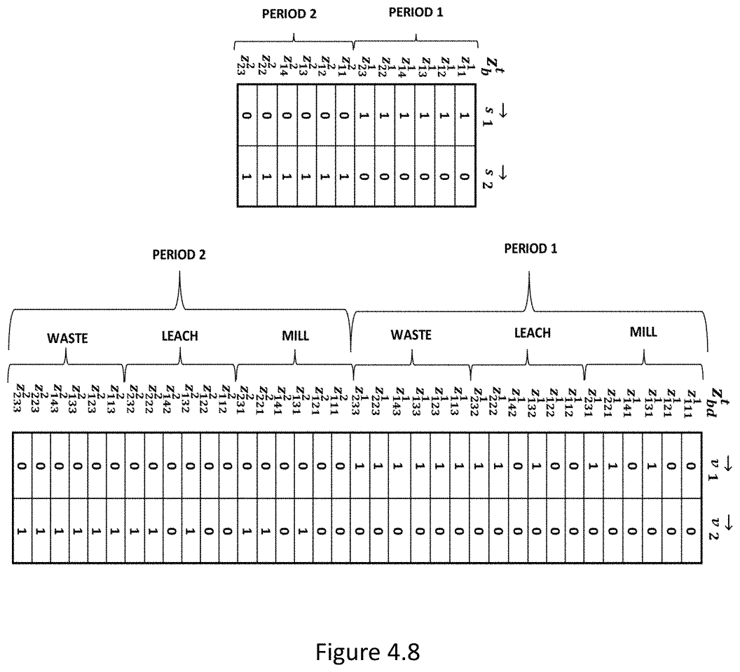

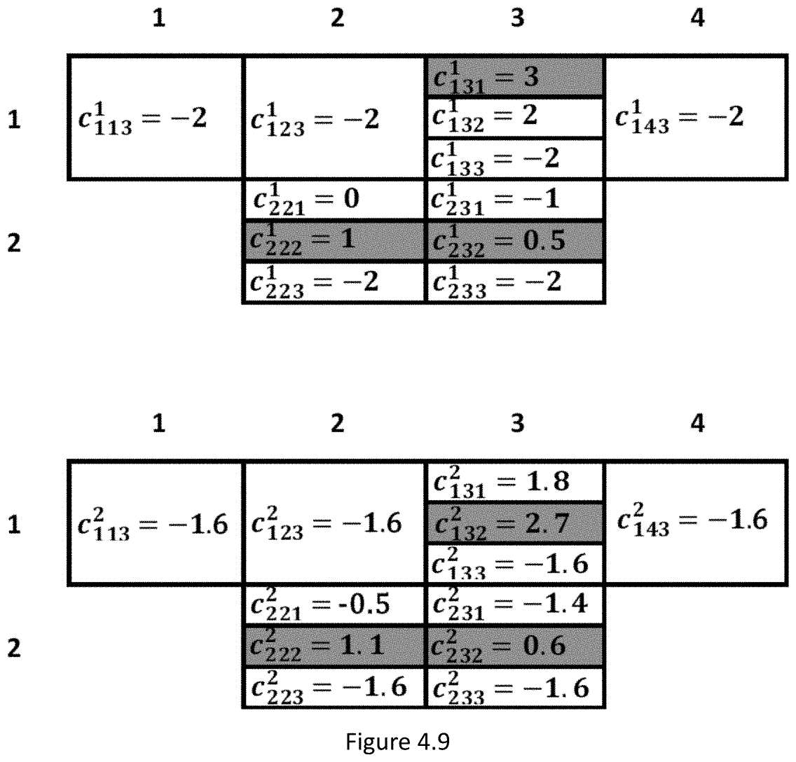

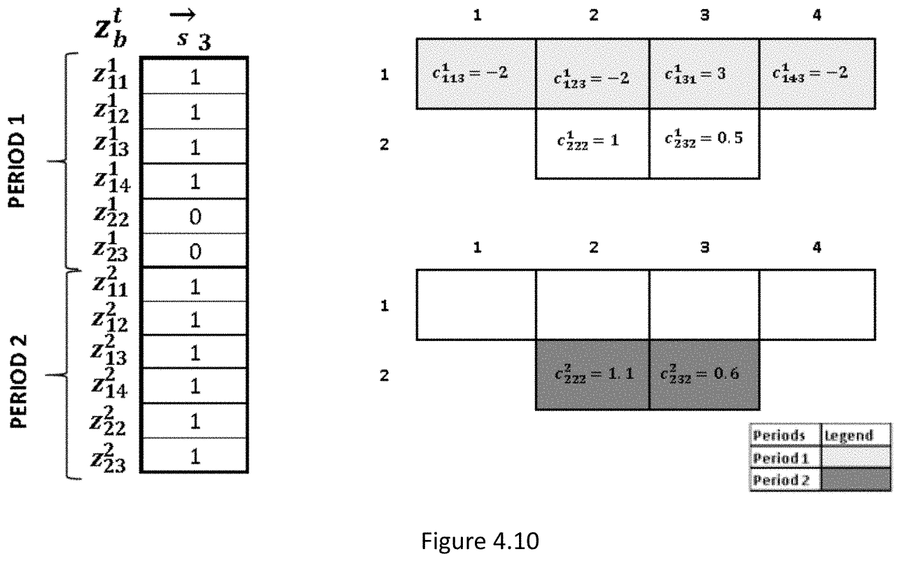

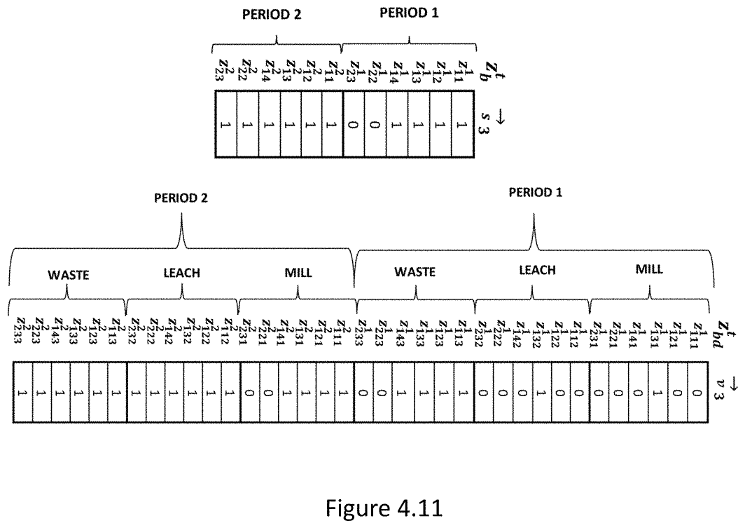

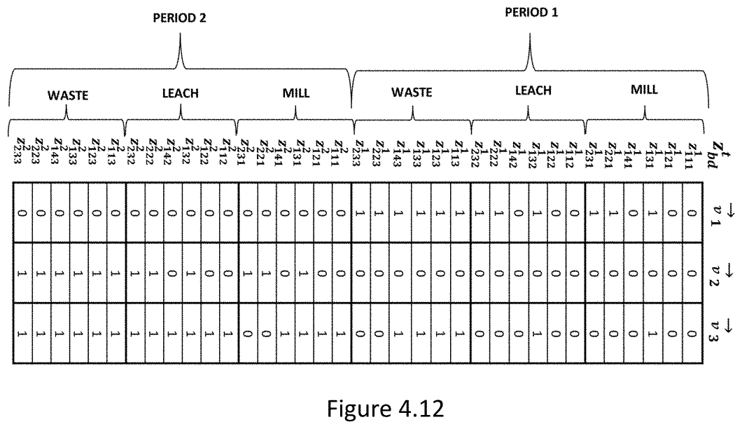

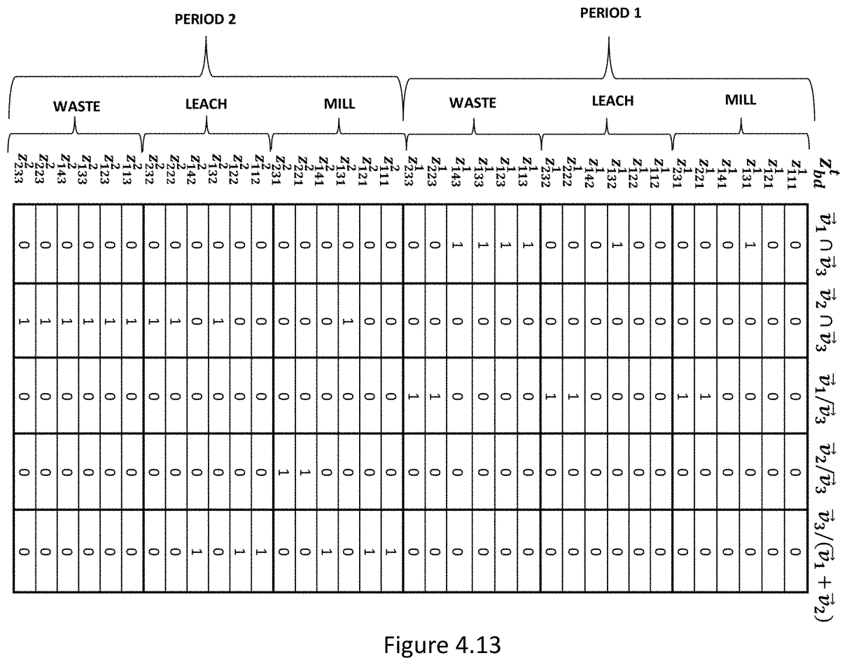

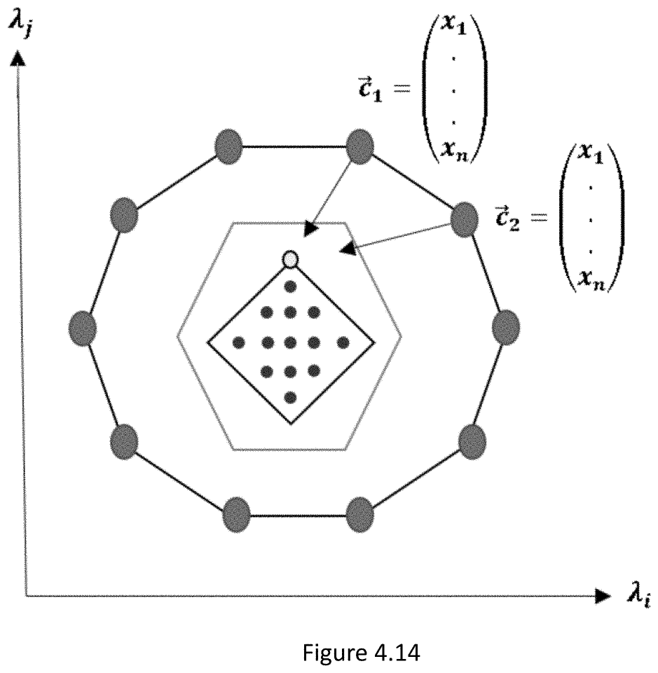

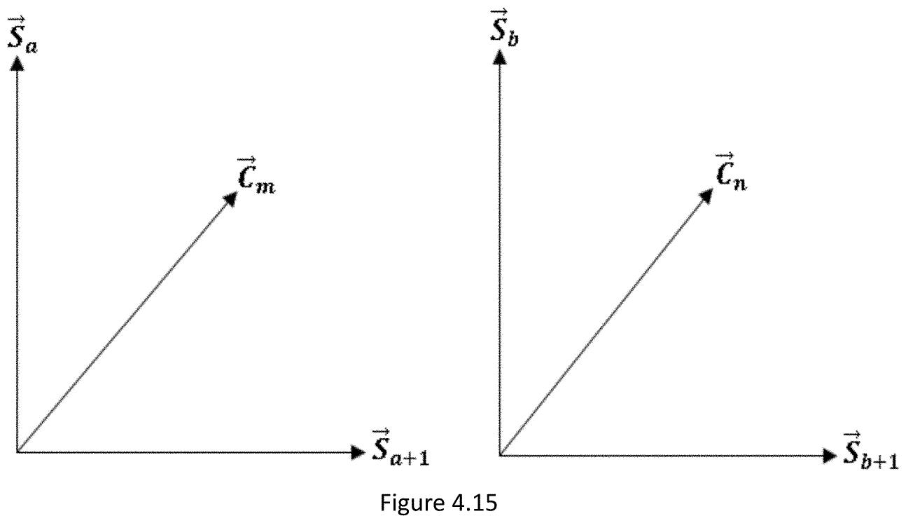

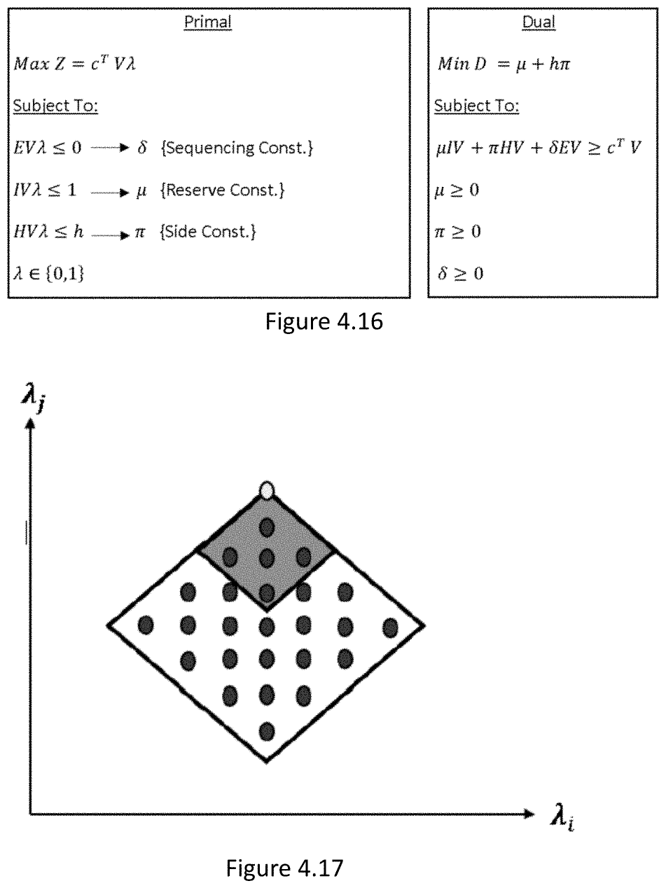

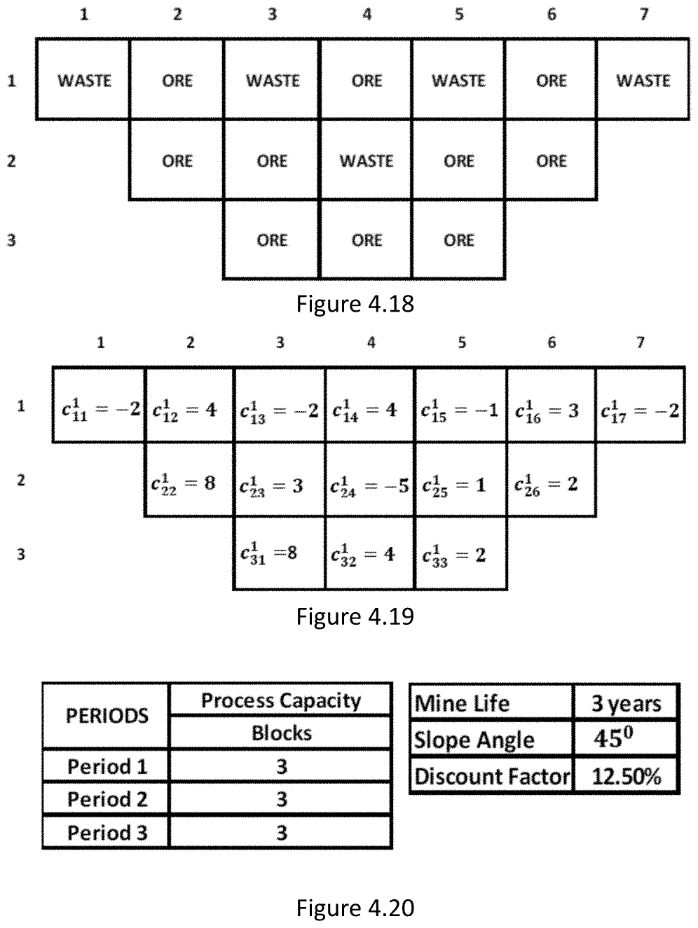

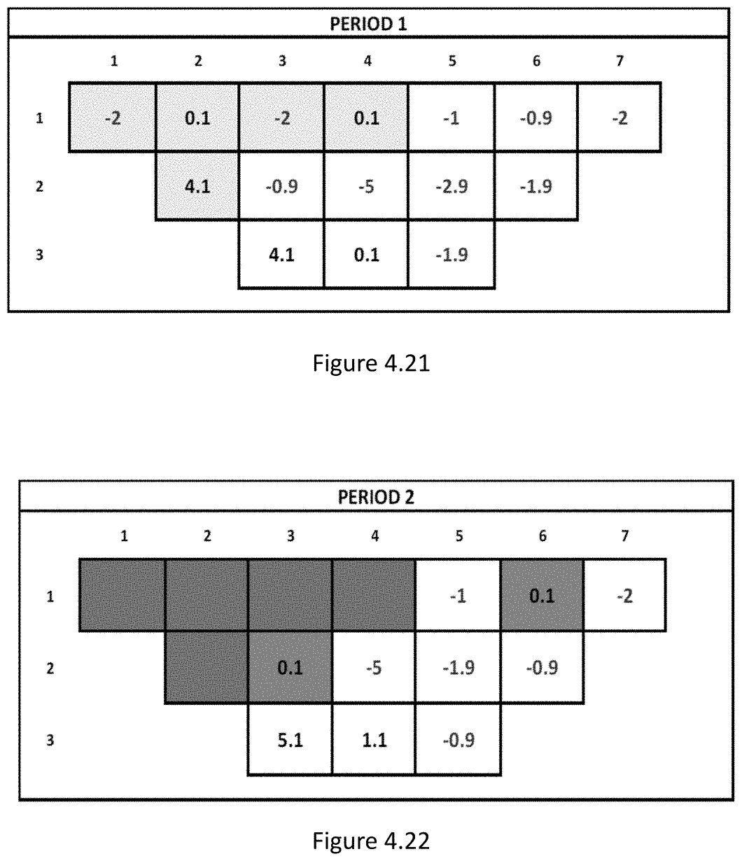

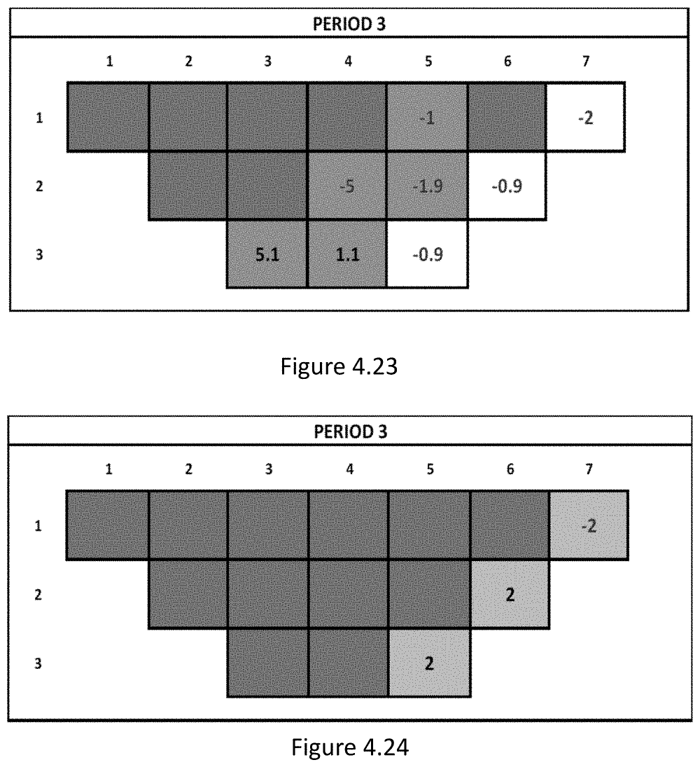

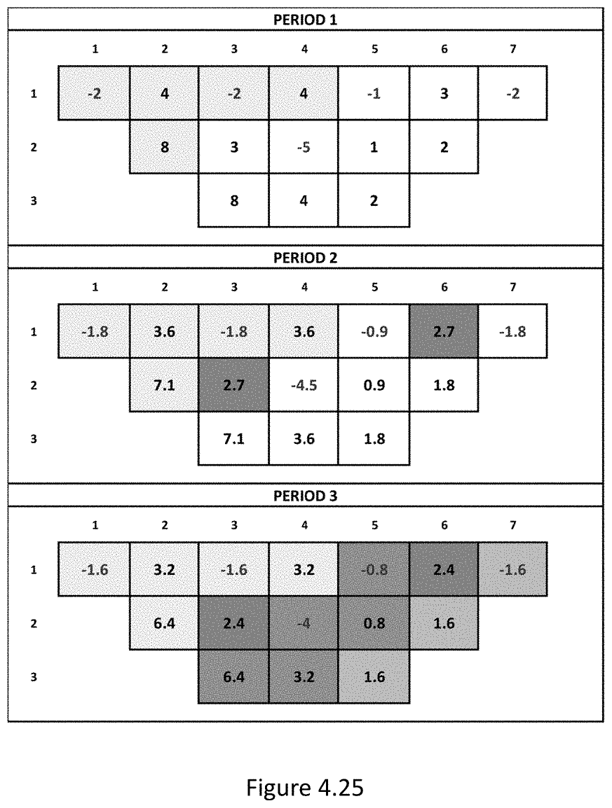

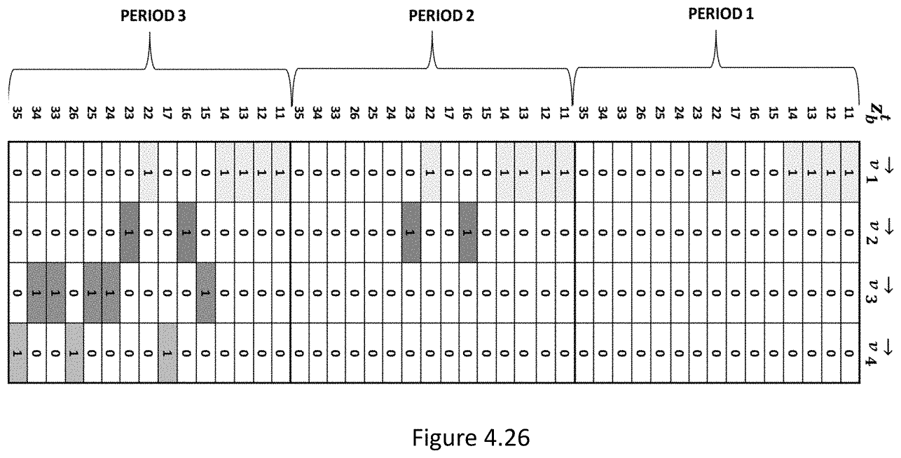

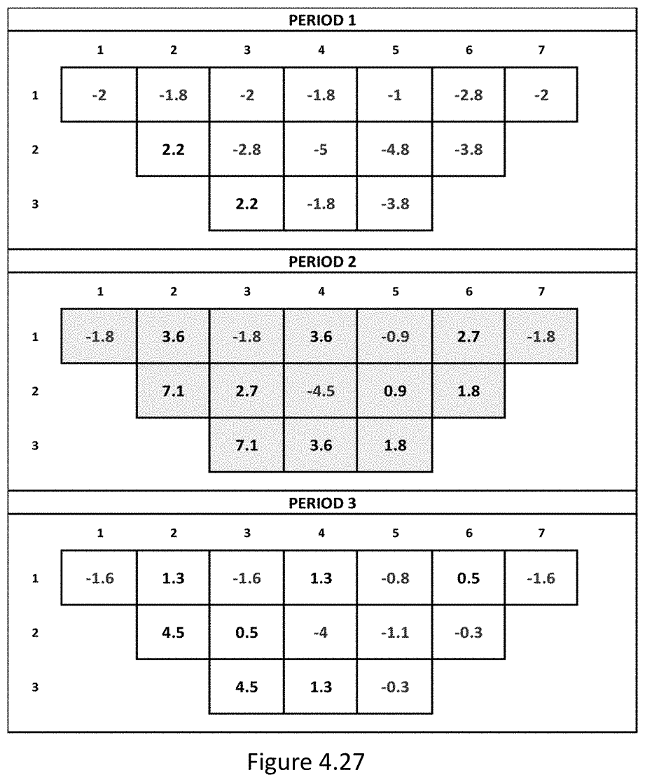

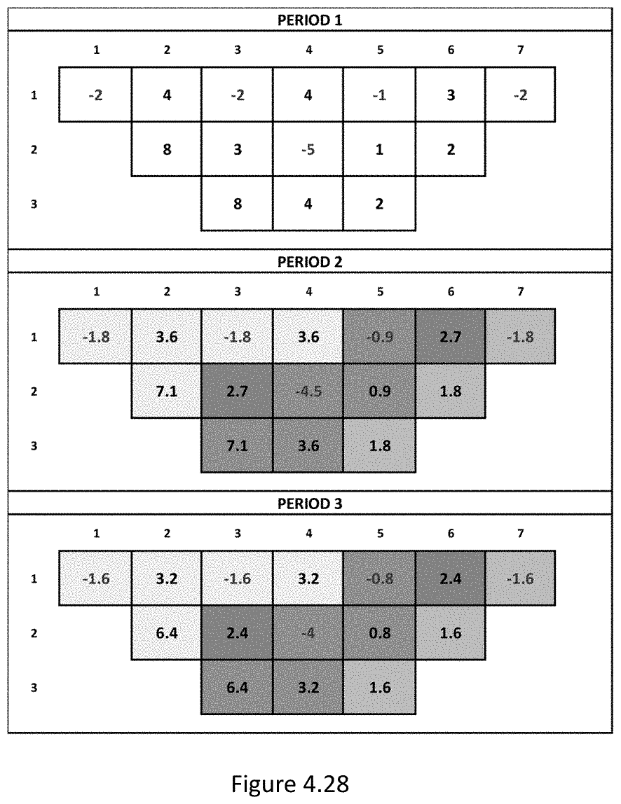

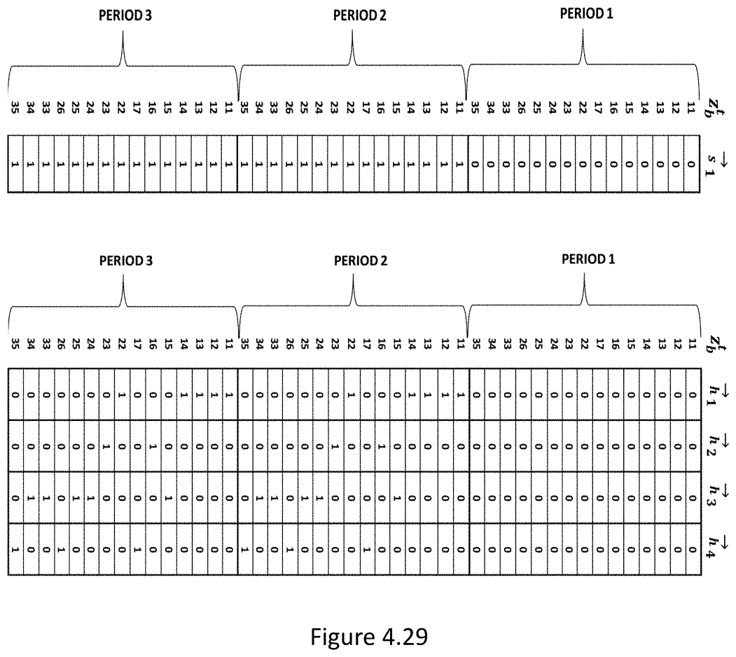

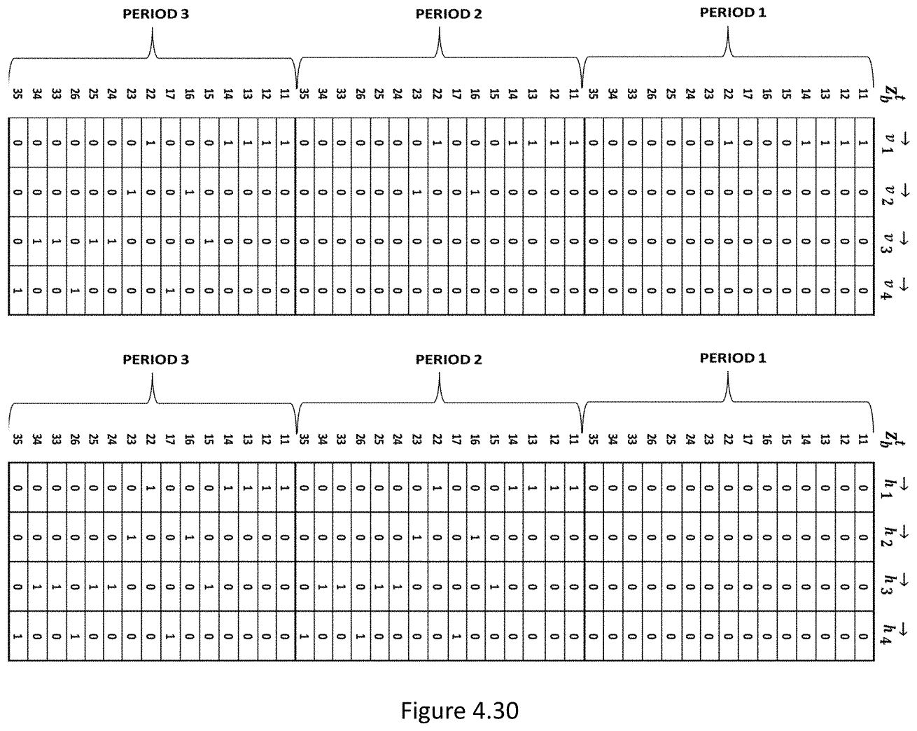

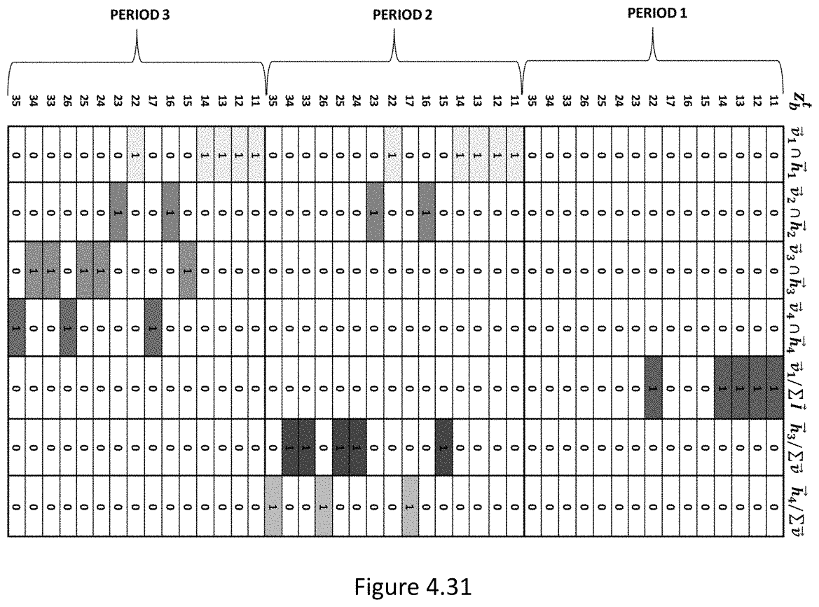

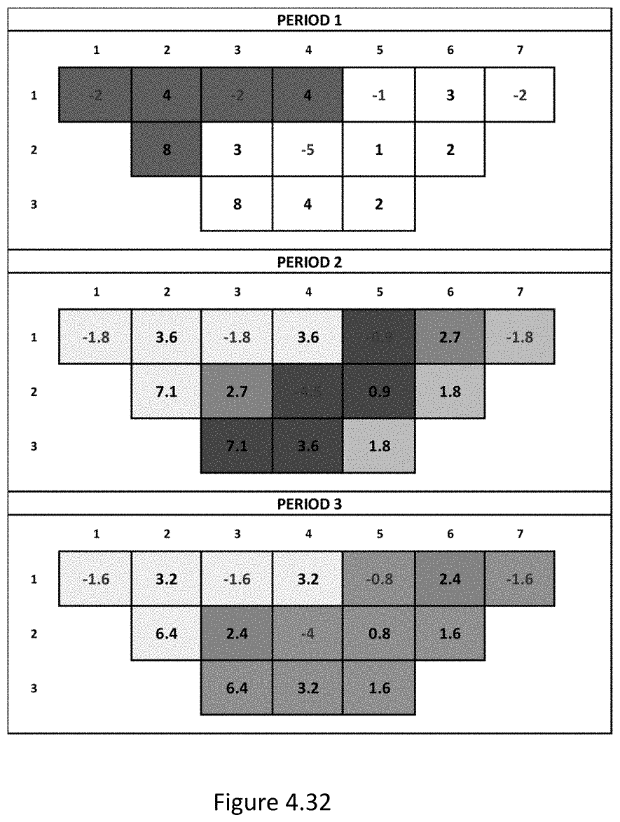

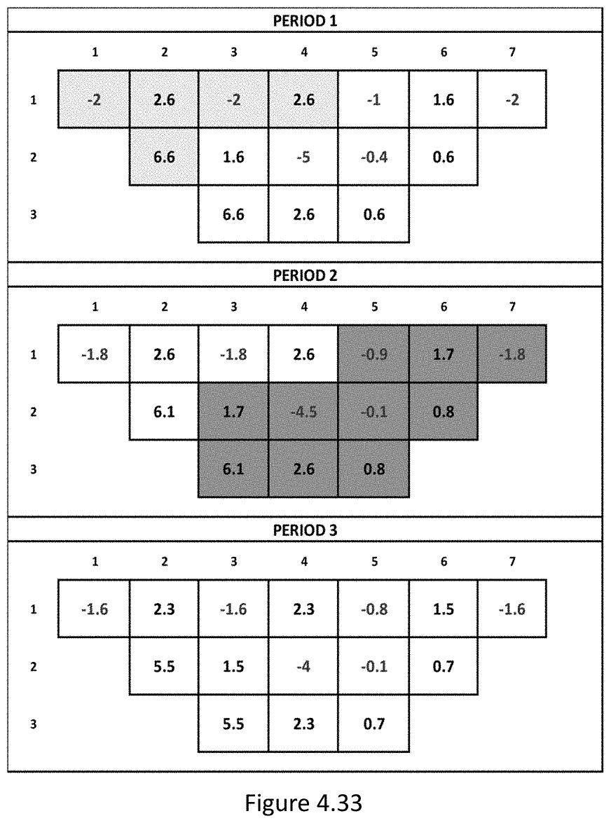

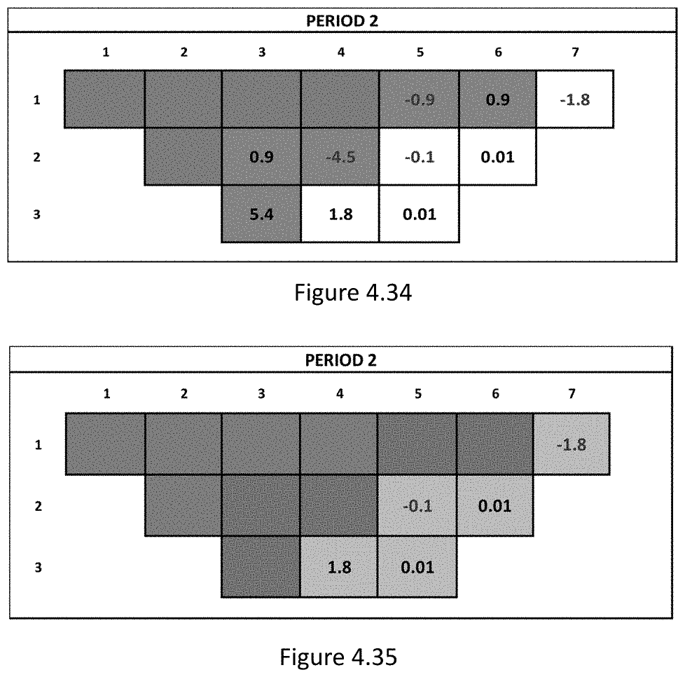

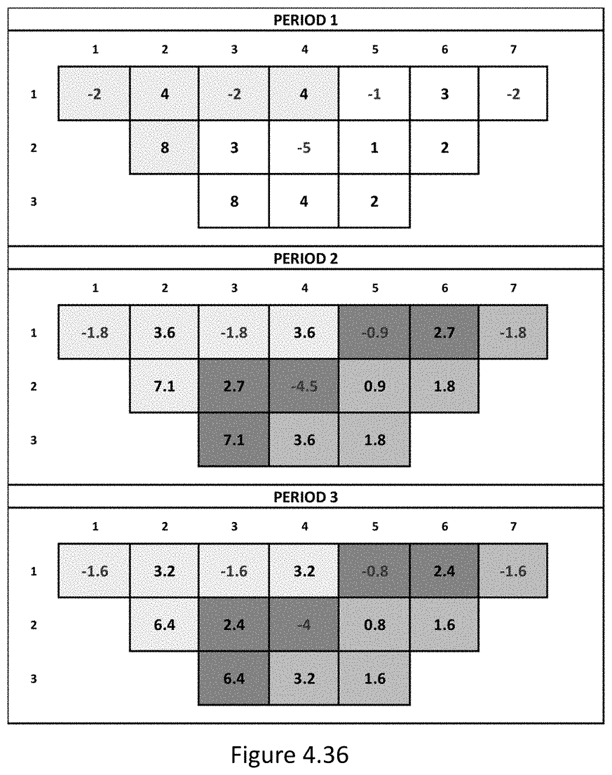

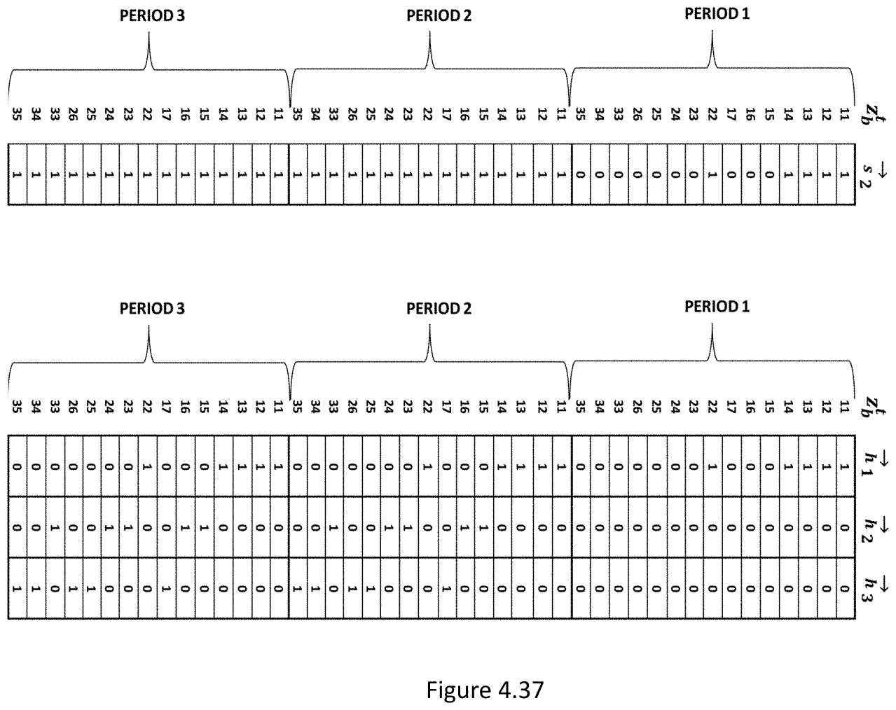

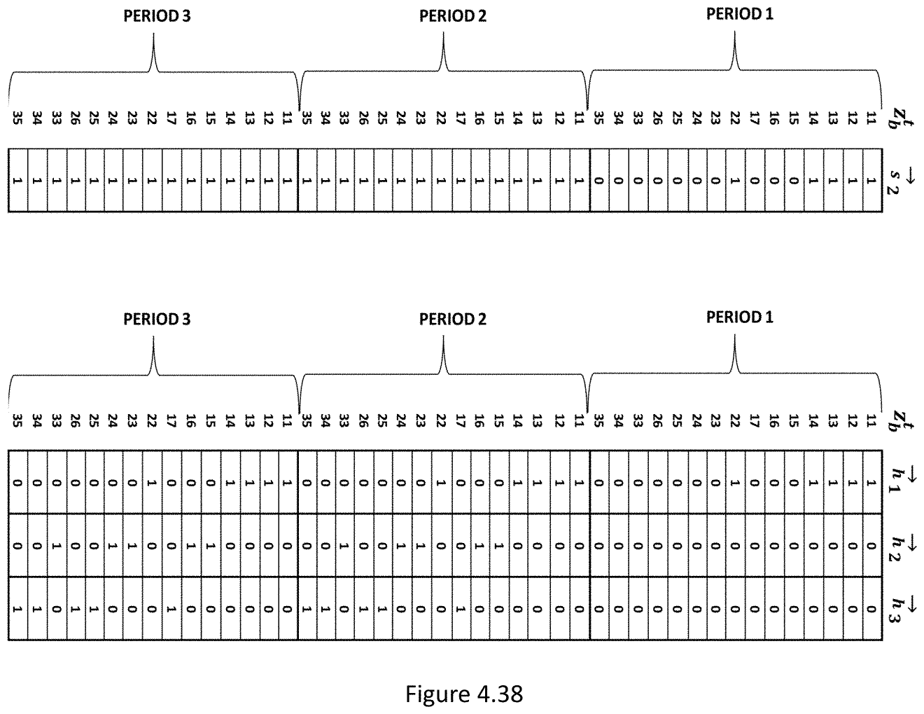

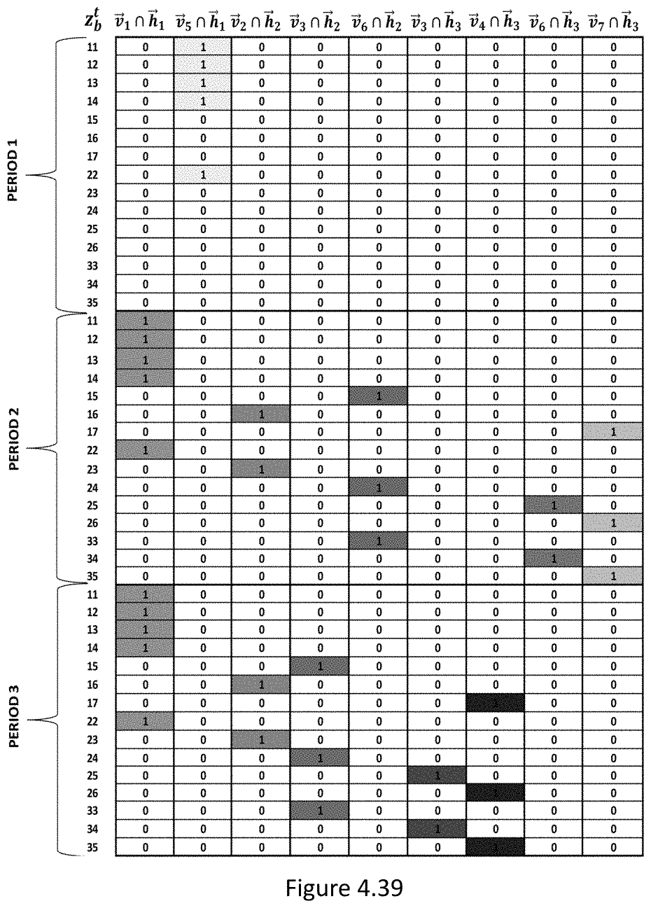

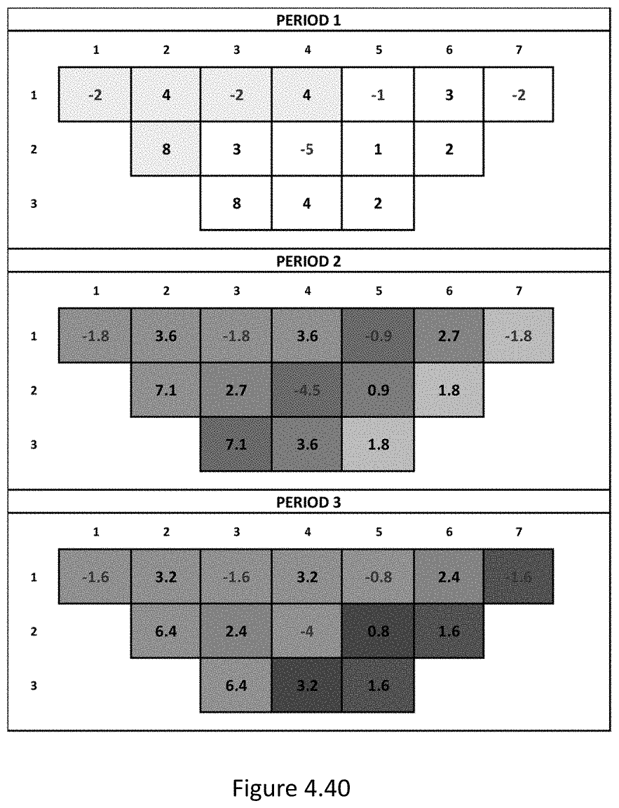

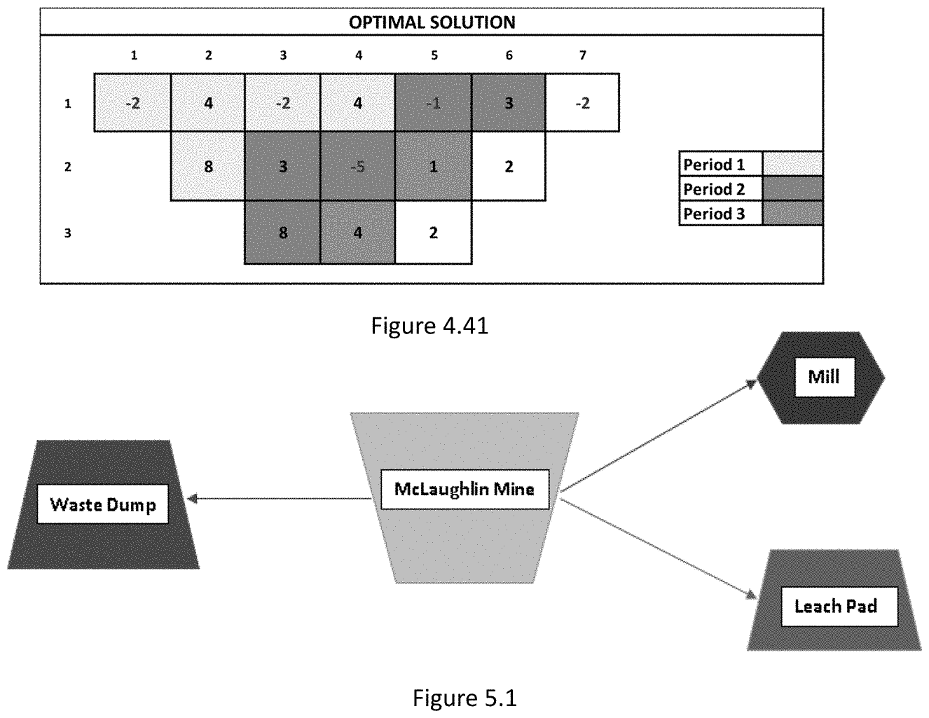

The solution space of the BZ algorithm takes place in Euclidean n-space which encompasses points with n coordinate values if the original problem contains n number of variables. Since all the variables are positive, the positive orthant of Euclidean n-space will be considered. The constraints of the subproblem are the hyperplanes and the region bounded by their intersections forms a polytope in n-space. Each subproblem solution is essentially a column that represents the coordinate of an extreme point, located on the intersection of the hyperplanes (Av≤b) on the polytope. The FIG. 4.2 below represents a cross section taken from a polytope and the blue colored points represent the extreme points where the subproblem solution could potentially take place.

Let's assume that [symbol] and [symbol] are the solution vectors obtained from the two consecutive iterations of the subproblem. The next step is the orthogonalization process of the [symbol] and [symbol] which will indeed result with a solution space greater than the one defined by the span of [symbol] and [symbol] . The idea behind the orthogonalization process is to expand the solution space defined by the partitions from the previous iterations by adding more axis to the solution space. In other words, expanding the set of axes that span the solution space will lead to a higher dimensional solution space where ultimately the optimal solution to the original problem will be captured.

The orthogonalization process is described by Munoz et al. (2017), where the authors often call it a refining process. For iteration k, the orthogonalization process proceeds towards obtaining the new set of partitions V^{k} by performing set intersection and set difference operations on V^{k-1} and the current solution to the subproblem v̅ₖ̅. The authors define set intersection operations as such: for two vectors x, y∈{0,1}ⁿ, define x∩y∈{0,1}ⁿ such that (x∩y)ᵢ=1 if f xᵢ=1 and yᵢ=1. Additionally, set difference operations are defined as such: for two vectors x, y∈{0,1}ⁿ, define x\y∈{0,1}ⁿ such that (x/y)ᵢ=1 if xᵢ=1 and yᵢ=0. Assuming V^{k-1} is comprised of {v̅₁̅ . . . , v̅ᵣ̅} then the new partition set V^{k} will consist of at most 2r+1 number of columns at the end of the following orthogonalization process:

{ [symbol] ∧\hat{v}:1≤j≤r}∪{ [symbol] \\hat{v}:1≤j≤r}∪{\hat{v}\(Σⱼ₌₁^{k-1}\vec{v}ⱼ)} (4.8)

Let's assume the new partition set V^{k} encompasses orthogonal columns { [symbol] . . . , [symbol] }. Then, there exists scalars or variables λᵢ associated with each \vec{vᵢ}∀i=1 . . . s. The solution space of the new partition set is formed by taking the linear combination of the partitions as follows:

$$\begin{matrix}Span ( V ) = \{ {λ}_{1} \vec{{v}_{1}} + {λ}_{2} \vec{{v}_{2}} … … {λ}_{s} \vec{{v}_{s}} \} = V \vec{λ} = \vec{x} & ( 4.9 ) \\ where \vec{λ} = \begin{matrix}{λ}_{1} \\ {λ}_{2} \\ \cdot \\ \cdot \\ {λ}_{s}\end{matrix} & \end{matrix}$$

After the orthogonalization process, the resulting partitions lead to a contraction operation which may reduce the number of rows and columns in the master problem while preserving the original problem structure. Let's assume that the partition v̅₁̅ represents the variables {x₁, x₂, . . . , x₁₀₀₀} in the original problem. Normally, each variable constitutes an axis in the original problem where the solution space of the x variables will span an immense space in 1000 dimensions. This gigantic space can be contracted by equating the variables in partition to each other and replacing them with the variable λ₁. Henceforth, instead of working with 1000 different axes, there may only be a λ₁ axis passing through the coordinates of {x₁, x₂, . . . , x₁₀₀₀}. The Theorem 31 in Bienstock Zuckerberg (2009) shows that given the LP optimal solution, if q linearly independent side constraints are binding, then the LP optimal solution will contain no more than q distinct fractional values. An insight to this theorem could be illustrated as follows. Let's assume that the original problem includes n number of variables and the optimal LP solution results with q number of distinct fractional values where n>>q. Although the solution space of the original problem is governed by n number of axes, q number of distinct fractional values confirm that n−q number of axes are redundant. Henceforth, if we can generate λ axis for each one of the distinct fractional values, a set of {λ₁, λ₂, . . . , λ_{q}} would be enough to capture the LP optimal solution. Every λ variable is essentially replacing a set of x variables within the original problem. Since the LP optimal solution exists in much lower dimensions then the original problem solution space, the contraction operation replaces the original axes of the problem with λ axes which will lead to a master problem formulation with a considerably lower number of variables and constraints. Below is the representation of the master problem.

Master Problem:

Max Z=c^{T}Vλ (4.10)

Subject to:

AVλ≤b (4.11)

HVλ≤h (4.12)

λ∈[0,1] (4.13)

u≥0 (4.14)

The master problem is a reformulation of the original problem constraints from (4.1) to (4.4) by replacing the x variables with the associated λ variables which qualifies as a restricted original problem. Furthermore, the set of constraints in the form of (4.12) are often called side constraints which destroys the underlying network structure which will prevent the implementation of the max flow solving algorithms. Nevertheless, due to the contraction operation, the number of λ variables and the constraints in the master problem are still small enough to generate fast optimal solutions to the master problem. The polytope corresponding to the feasible region of the original problem takes place inside the subproblem solution space as shown in FIG. 4.2. The optimal solution generated for the master problem is a feasible solution to the original problem solution space if not the optimal solution. Once the master problem solution is achieved; the dual vectors corresponding to the side constrains (4.12) are also generated. The significance of the dual vectors in the decomposition mechanism may be realized better if the relevance of the duality in the LP concept is emphasized. Furthermore, the working mechanism of the dual vectors form a strong connection between the simplex algorithm and the BZ decomposition algorithm which will be also illustrated.

Given a LP problem, based on the strong duality theorem; if the feasible solutions of the primal and the dual optimal solutions are equal, then the solution is proven to be the optimal LP solution. Each constraint of the primal problem has an associated dual variable and the right-hand side of the constraints are perceived as available resources. The non-zero dual values will only exist if the available resources are fully consumed, in other words if the constraints are binding. The value of the associated dual variable in other words the shadow price will provide a useful measure on the impact of a unit change in the available resource on the objective function value. If the primal problem is a maximization problem, the positive dual variable can be interpreted as such that expanding the available resource will have a positive contribution to the objective function value and the opposite is true if the dual variable has a negative value. Let's also explore the significance of the duals in the simplex algorithm. In each iteration of the simplex algorithm, the non-basic variable which has the highest contribution to the objective function value is identified and included to the basic feasible solution. The variable selection process has an underlying economic interpretation. For each non-basic variable, its net worth is determined by the following equation c̅ᵢ=cᵢ−πaₖ where cᵢ the original coefficient of the variable in the objective function can be interpreted as revenue, dual variable or the reduce cost π represents the cost of consuming a unit of a resource and aₖ is the amount of the resources consumed. Thus, c̅ᵢ can be interpreted as the modified value of the blocks.

The relationship between the master and subproblem of the BZ algorithm is apparent in the light of the duality concept. The dual vector π corresponding to the side constraints (4.12) will be used similarly to characterize the net worth of the mining decision variables. To be more precise, the block values will be modified with the corresponding dual values which may either make the blocks favorable or not. In the simplex algorithm we include the decision variable with the highest net worth, c̅ᵢ, into the basis. The pivoting process of the simplex algorithm is analogous to the subproblem solution. The modified block values are the net worth of the blocks based on the duals, and the solution to the subproblem may be essentially the best mining plan generated with the modified block values. Henceforth, the λ variable corresponding to the plan enters the basis of the system. If the master problem is constrained as a single destination problem, then the dual vector π will modify the discounted value of the blocks over the time periods which may make the blocks more profitable for the later periods for the subproblem. If the blocks can be sent to multiple destinations as in the original problem that is being solved in this research, then the value of the block at each destination will be modified with the dual values per time period and the destination with the best value will be selected for each time period in the subproblem. This was proven by Johnson (1968). In a sense, the dual values will work similar to the cutoff grades to determine the best destination for the blocks. The relationship between the destination variables across the time periods for a single block was shown in the previous section. As it can be seen in FIG. 4.3 below, the subproblem variable z^{t} is essentially represented by a single node, when the destination nodes of the z_{b,d}^{t} variable is collapsed by picking the best destination from the modified block values.

So far, the working mechanism of the BZ decomposition algorithm is explained in detail to set the groundwork for the presently disclosed integer solution algorithm. The strengths of the BZ algorithm are mainly driven by the underlying network structure of the subproblem, the orthogonalization process and the contraction operation as illustrated in the example that follows. Also, the analogous relationship between the master and subproblem and the pivoting operation in the simplex algorithm is demonstrated in the light of the duality concept.

4.2.1 Small 2D BZ Example

In this section, the implementation of the BZ algorithm on a multi destination mine production scheduling problem will be demonstrated on a small 2D example. The deposit characteristics together with the decision variables and the economic block model is given in FIG. 4.4. The production scheduling requirements are given in FIG. 4.5.

In this example, the mine plan includes three constraints namely total mining capacity, mill capacity and leach capacity. The life of mine is 2 years and the pit walls must satisfy 45° angle requirement. The ore blocks are assumed to be cubes and can be treated at one of the three potential destinations which are mill, leach and waste dump. The optimization process will determine the best destination for the block by realizing the interactions within the mining system. The original model formulation with the variables as derived in the previous section is given below.

Original Problem Formulation:

z_{bd}^{t} the fraction of block b, that is extracted by time period t and sent by destination d

Objective Function:

Max z=z₁₁₃¹c₁₁₃¹+z₁₂₃¹c₁₂₃¹+z₁₄₃¹c₁₄₃¹+z₁₃₁¹(c₁₃₁¹−c₁₃₂¹)+z₁₃₁¹(c₁₃₁¹−c₁₃₂¹)+

z₁₃₂¹(c₁₃₂¹−c₁₃₃¹)+z₁₃₃¹(c₁₃₃¹−c₁₃₁²)+z₂₂₁¹(c₂₂₁¹−c₂₂₂¹)+z₁₂₂¹(c₁₂₂¹−c₂₂₃¹)+

z₂₂₃¹(c₂₂₃¹−c₂₂₁²)+z₂₃₁¹(c₂₃₁¹−c₂₃₂¹)+z₂₃₂¹(c₂₃₂¹−c₂₃₃¹)+z₂₃₃¹(c₂₃₃¹−c₂₃₁²)+

z₁₃₁²(c₁₃₁²−c₁₃₂²)+z₁₃₂₃²(c₁₃₂²−c₁₃₃²)+z₁₃₃²c₁₃₃²+z₂₂₁²(c₂₂₁²−c₂₂₂²)+z₂₂₂²(c₂₂₂²−

c₂₂₃²)+z₂₂₃²c₂₂₃²+Z₂₃₁²(c₂₃₁²−c₂₃₂²)+z₂₃₂²(c₂₃₂²−c₂₃₃²)+z₂₃₃²c₂₃₃²+z₁₁₃²c₁₁₃²+

z₁₂₃²c₁₂₃²+z₁₄₃²c₁₄₃² (4.15)

Subject to:

Ensures Sequencing Across Time Periods

z₁₁₃¹≤z₁₁₃² (4.16)

z₁₂₃¹≤z₁₂₃² (4.17)

z₁₃₃¹≤z₁₃₁² (4.18)

z₁₄₃¹≤z₁₄₃² (4.19)

z₂₂₃¹≤z₂₂₁² (4.20)

z₂₃₃¹≤z₁₂₃₁² (4.21)

Ensures Sequencing Between Destinations Within Time Periods:

z₁₃₁¹≤z₁₃₂¹ (4.22)

z₁₃₂¹≤z₁₃₃¹ (4.23)

z₂₂₁¹≤z₂₂₂¹ (4.24)

z₂₂₂¹≤z₂₂₃¹ (4.25)

z₂₃₁¹≤z₂₃₂¹ (4.26)

z₂₃₂¹≤z₂₃₃¹ (4.27)

z₁₃₁²≤z₁₃₂² (4.28)

z₁₃₂²≤z₁₃₃² (4.29)

z₂₁²≤z₂₂₂² (4.30)

z₂₂₂²≤z₂₂₃² (4.31)

z₂₃₁²≤z₂₃₂² (4.32)

z₂₃₂²≤z₂₃₃² (4.33)

Block Sequencing Constraints:

z₂₂₃¹≤z₁₁₃¹ (4.34)

z₂₂₃¹≤z₁₂₃¹ (4.35)

z₂₂₃¹≤z₁₃₃¹ (4.36)

z₂₃₃¹≤z₁₂₃¹ (4.37)

z₂₃₃¹≤z₁₃₃¹ (4.38)

z₂₃₃¹≤z₁₄₃¹ (4.39)

z₂₂₃²≤z₁₁₃² (4.40)

z₂₂₃²≤z₁₂₃² (4.41)

z₂₂₃²≤z₁₃₃² (4.42)

z₂₃₃²≤z₁₂₃² (4.43)

z₂₃₃²≤z₁₃₃² (4.44)

z₂₃₃²≤z₁₄₃² (4.45)

Capacity Constraints:

Mill Capacity Constraints:

z₁₃₁¹+z₂₂₁¹+z₂₃₁¹≤1 (4.46)

(z₁₃₁²−z₁₃₃¹)+(z₂₂₁²−z₂₂₃¹)+(z₂₃₁²−z₂₃₃¹)≤₁ (4.47)

Leach Capacity Constraints:

(z₁₃₂²−z₁₃₁²)+(z₂₂₂²−z₂₂₁²)+(z₂₃₂²−z₂₃₁¹)≤₁ (4.48)

Total Mining Capacity Constraints:

z₁₁₃¹+z₁₂₃¹+z₁₃₁¹+(z₁₃₂¹−z₁₃₁¹)+(z₁₃₃¹−z₁₃₂¹)+z₁₄₃¹+z₂₂₁¹+(z₂₂₂¹−z₂₂₁¹)+(z₂₂₃¹−z₂₂₂¹)+z₂₃₁¹+(z₂₃₂¹−z₂₃₁¹)+(z₂₃₃¹−z₂₃₂¹)≤3 (4.49)

z₁₁₃²+z₁₂₃²+(z₁₃₁²−z₁₃₃¹)+(z₁₃₂²−z₁₃₁²)+(z₁₃₃²−z₁₃₂²)+z₁₄₃²+(z₂₂₁²−z₂₂₃¹)+(z₂₂₂²−z₂₂₁²)+(z₂₂₃²−z₂₂₂²)+(z₂₃₁²−z₂₃₃¹)+(z₂₃₂²−z₂₃₁²)+(z₂₃₃²−z₂₃₂²)≤3 (4.50)

Variable Restrictions:

0≤z_{ijd}^{t}≤1 ∀i∈{1,2}∀j∈{1,2,3,4},∀t∈{1,2},∀d∈{1,2,3} (4.51)

Step 1:

The first step of the BZ algorithm will start by determining the initial set of partitions V⁰ to formulate the master problem. Each partition is essentially a mine plan and there are no feasibility requirements for the selected mine plan. In other words, the starting mine plan does not have to be feasible to the original problem solution space. Hence, a partition will be created from the set of blocks within the ultimate pit. If the life of mine is t periods, then t number of orthogonal partitions will be generated where each partition has all the blocks within the ultimate pit. Indeed, a number of mine plans are generated where each plan mines the ultimate pit. This plan is most likely infeasible to the original problem space. The orthogonality between the partitions are also preserved by allowing each partition to represent the blocks within the ultimate pit for a specific time period. Furthermore, generating an ultimate pit is similar to solving the subproblem with the original block values by assuming the dual values are zero.

In FIG. 4.6, the economic block model is shown for year 1 and discounted for year 2. The blocks have value depending on the treatment type at the destination. The ultimate pit calculation may have as an input a predetermined destination of a block. Hence, the destination where the block gains the highest value will be selected. The selected block values are shown with light blue color in FIG. 4.6. The ultimate pit limit will be determined by using Pseudoflow algorithm. The FIG. 4.7 shows the resulting orthogonal columns s̅₁̅ and s̅₂̅ where s̅₁̅ represents the blocks mined in the ultimate pit in period 1, and s̅₂̅ represents the blocks mined in the ultimate pit in period 2. Since each period segment of the solution column can be perceived as a pit, the blocks mined in the period 1 segment of the column s̅₁̅ is colored with yellow and the period 2 segment of the column s̅₂̅ is colored with green. This is essentially the representation of the orthogonal columns in terms of mining pits.

The original variable z_{bd}^{t} has a destination index, however the subproblem solution does not have the destination index since the destinations are predetermined. The blocks that exist in columns s̅₁̅ and s̅₂̅ are assigned to the destinations with the highest value. In order to model the master problem, the solution columns s̅₁̅ and s̅₂̅ are converted to v̅₁̅ and v̅₂̅ and as shown in FIG. 4.8. The conversion process follows the node structure of the original problem variable z_{bd}^{t} which is illustrated in the previous section. Since the column v̅₁̅ has the same structure of the original problem variables, the λ variable associated for each column v will easily replace the original problem variables z_{bd}^{t}. The solution column of the subproblem is split into period segments. For the conversion process, each period segment needs to be split further into destination segments as shown in FIG. 4.8. For example, the block z₁₃¹ shows up in column [symbol] and we know that the block was designated to the mill. Hence, the location of z₁₃₁¹ in column [symbol] must be 1. Due to the “by” relationship between the destinations, the location of z₁₃₂¹ and z₁₃₃¹ of will also be 1. Eventually, every block variable z_{b}^{t} in [symbol] will be converted to z_{bd}^{t} and placed in [symbol] . If the predetermined destination is d in time period t, then “1” will be assigned to the location of the same block for destination d to D and time period t to T.

Step 2:

Once the orthogonal partitions [symbol] and [symbol] are obtained, the master problem is ready to be formulated. The formulation will proceed with the contraction operation where λ₁ and λ₂ will replace the variables that exist in the partitions \vec{v₁} and \vec{v₂}. The contraction operation preserves the original problem structure. Intuitively, the master problem formulation is the original problem formulation with the extra equality constraints between the variables that exist in the same partition. Below is the mathematical model for the master problem generated by substituting z_{bd}^{t} variables of the original problem with the corresponding λ variables.

λ₁→\vec{v}₁{z₁₁₃¹,z₁₂₃¹,z₁₃₃¹,z₁₄₃¹,z₂₂₃¹,z₂₃₃¹,z₁₃₁¹,z₂₂₁¹,z₂₃₁¹,z₁₃₂¹,z₂₂₂¹,z₂₃₂¹,}

λ₂→\vec{v}₂{z₁₁₃²,z₁₂₃²,z₁₃₃²,z₁₄₃²,z₂₂₃²,z₂₃₃²,z₁₃₁²,z₂₂₁²,z₂₃₁²,z₁₃₂²,z₂₂₂²,z₂₃₂²,}

Master Problem Formulation:

Objective Function:

Max Z=λ₁c₁₁₃¹+λ₁c₁₂₃¹+λ₁c₁₄₃¹+λ₁(c₁₃₁¹−c₁₃₂¹)+λ₁(c₁₃₁¹−c₁₃₂¹)

+λ₁(c₁₃₂¹−c₁₃₃¹)+λ₁(c₁₃₃¹−c₁₃₁²)+λ₁(c₂₂₁¹−c₂₂₂¹)+λ₁(c₂₂₂¹−c₂₂₃¹)

+λ₁(c₂₂₃¹−c₂₂₁²)+λ₁(c₂₃₁¹−c₂₃₂¹)+λ₁(c₂₃₂¹−c₂₃₃¹)+λ₁(c₂₃₃¹−c₂₃₁²)

+λ₂(c₁₃₁²−c₁₃₂²)+λ₂(c₁₃₂²−c₁₃₃²)+λ₂c₁₃₃²+λ₂(c₂₂₁²−c₂₂₂²)

+λ₂(c₂₂₂²−c₂₂₃²)+λ₂c₂₂₃²+λ₂(c₂₃₁²−c₂₃₂²)+λ₂(c₂₃₂²−c₂₃₃²)+λ₂c₂₃₃²

+λ₂c₁₁₃²+λ₂c₁₂₃²+λ₂c₁₄₃² (4.52)

Subject to:

Ensures Sequencing Across Time Periods:

λ₁≤λ₂ replaces (eq 4.16,4.17,4.18,4,19,4.20,4.21) (4.53)

Ensures Sequencing Between Destinations Within Time Periods:

λ₁≤λ₁ replaces (eq 4.22,4.23,4.24,4,25,4.26,4.27) (4.54)

λ₂≤λ₂ replaces (eq 4.28,4.29,4.30,4,31,4.32,4.33) (4.55)

Block Sequencing Constraints:

λ₁≤λ₁ replaces (eq 4.34,4.35,4.36,4,37,4.38,4.39) (4.56)

λ₂≤λ₂ replaces (eq 4.40,4.41,4.42,4,43,4.44,4.45) (4.57)

Capacity Constraints:

Mill Capacity Constraints:

λ₁+λ₁+λ₁≤1 replaces (eq 4.47) (4.58)

(λ₂−λ₁)+(λ₂−λ₁)+(λ₂−λ₁)≤1 replaces (eq 4.47) (4.59)

Leach Capacity Constraints:

(λ₂−λ₂)+(λ₂−λ₂)+(λ₂−λ₂)≤1 replaces (eq 4.48) (4.60)

Total Mining Capacity Constraints:

λ₁+λ₁+λ₁+(λ₁−λ₁)+(λ₁−λ₁)+λ₁+λ₁+(λ₁−λ₁)+(λ₁−λ₁)+λ₁+(λ₁−λ₁)+(λ₁−λ₁)≤3 replaces (eq 4.49) (4.61)

λ₂+λ₂+(λ₂−λ₁)+(λ₂−λ₂)+(λ₂−λ₂)+λ₂+(λ₂−λ₁)+(λ₂−λ₂)+(λ₂−λ₁)+(λ₂−λ₁)+(λ₂−λ₂)+(λ₂−λ₂)≤3 replaces (eq 4.50) (4.62)

Variable Restrictions:

0≤λ₁≤1 (4.63)

0≤λ₂≤1 (4.64)

The mathematical model generated by direct variable substitution includes many redundant constraints. Below is the simplified mathematical model for the master problem.

Objective Function:

Max Z=7.1λ₁−4.2λ₂ (4.65)

Subject to:

Sequencing Constraint:

λ₁≤λ₂ (4.66)

Capacity Constraints:

Mill Capacity Constraints:

3λ₁≤1 (4.67)

3λ₂−3λ₁≤1 (4.68)

Total Mining Capacity Constraints:

6λ₁≤3 (4.69)

7λ₂−4λ₁≤3 (4.70)

Variable Restrictions:

0≤λ₁≤1 (4.71)

0≤λ₂≤1 (4.72)

When the problem is solved with the simplex algorithm, we get λ₁=⅓, λ₂=⅓, which means that the mining decision variables in set [symbol] and [symbol] are also equal to ⅓.

Step 3:

Once the master problem is solved, the dual values μₖ^{t} are generated for the side constraints. The dual values for this problem are assumed for demonstration purposes.

| | | |
|---|---|---|
| Duals For Mill Capacity Constraints | μ₁¹ = 2, | μ₁² = 2.5 |
| Duals For Leach Capacity Constraints | μ₂¹ = 0, | μ₂² = 0 |
| Duals For Total Mining Capacity Constraints | μ₃¹ = 1, | μ₃² = 0.7 |

The dual values will be used to modify the original block values. If the block is a waste block, the dual from the total mining capacity constraint will be used. For the mill blocks, the duals for the mill capacity and the total mining capacity constraints will be used. Similarly, the leach block values will be penalized with the duals from the leach capacity and the total mining capacity constraints. The modified block values are shown in FIG. 4.9. In order to solve the multi time period sequencing subproblem, the destinations of the blocks should be predetermined. Henceforth, by looking at the modified value of the blocks at each destination, the destination with the highest value will be selected. Once the selection is completed, the subproblem is solved by implementing the Pseudoflow algorithm. In FIG. 4.10, the column s̅₃̅ represents the solution to the subproblem which may be the best current mine plan qualified to enter the basis. Since the solution is in “by” form, the blocks mine in period 1 also shows in the period 2 section of column s̅₃̅. As it can be seen in FIG. 4.10, the first bench is mined in period 1 colored by yellow. The modified block values delay the production of the second bench to the second period which leads to a higher profit as shown by green color. The next step is converting the subproblem solution column s̅₃̅ to v̅₃̅, in order to preserve the node structure of the original problem variables. The FIG. 4.11 makes it easier to see how the resolution is increased by splitting each period segment of column s̅₃̅ into destinations in column v̅₃̅. The orthogonal partitions from the previous iteration are v̅₁̅ and v̅₂̅. If v̅₃̅ is introduced as a new partition to the set of previous partitions, it will be clear v̅₃̅ is not orthogonal to v̅₁̅ and v̅₂̅ as shown in FIG. 4.12. Hence, the orthogonalization process must be initiated, in order to expand the solution space defined by the partitions from the previous iterations by adding more axis to the solution space. FIG. 4.13 demonstrates the new partitions after the orthogonalization process.

In the previous iteration, the linear combination of λ₁ and λ₂ variables formed a solution space in two dimensions, while the orthogonalization process in the current iteration resulted with a solution space in higher dimensions spanned by λ₁, λ₂, λ₃, λ₄, λ₅ variables. With the contraction operation, the original z_{bd}^{t} variables stored in the partitions \vec{v}₁ to \vec{v}₂ will be replaced with the variables λ₁ to λ₅ and the master problem will be formulated.

λ₁ \vec{v}₁={z₁₃₁¹,z₁₃₂¹,z₁₁₃¹,z₁₂₃¹,z₁₃₃¹,z₁₄₃¹}

λ₂ \vec{v}₂={z₁₃₁²,z₁₃₂²,z₂₂₂²,z₂₃₂²,z₁₁₃²,z₁₂₃²,z₁₃₃²,z₁₄₃²,z₂₂₃²,z₂₃₃²}

λ₃ \vec{v}₃={z₂₂₁¹,z₂₃₁¹,z₂₂₂¹,z₂₃₂¹,z₂₂₃¹,z₂₃₃¹}

λ₄ \vec{v}₄={z₂₂₁²,z₂₃₁²}

λ₅ \vec{v}₅={z₁₁₁²,z₁₂₁²,z₁₄₁²,z₁₁₂²,z₁₂₂²,z₁₄₂²}

Master Problem Formulation:

Objective Function:

Max Z=λ₁c₁₁₃¹+λ₁c₁₂₃¹+λ₁c₁₄₃¹+λ₁(c₁₃₁¹−c₁₃₂¹)

+λ₁(c₁₃₁¹−c₁₃₂¹)+λ₁(c₁₃₂¹−c₁₃₃¹)+λ₁(c₁₃₃¹−c₁₃₁²)

+λ₃(c₂₂₂¹−c₂₂₂¹)+λ₃(c₂₂₂¹−c₂₂₃¹)+λ₃(c₂₂₃¹−c₂₂₁²)

+λ₃(c₂₃₁¹−c₂₃₂¹)+λ₃(c₂₃₂¹−c₂₃₃¹)+λ₃(c₂₃₃¹−c₂₃₁²)

+λ₂(c₁₃₁²−c₁₃₂²)+λ₂(c₁₃₂²−c₁₃₃²)+λ₂c₁₃₃²

+λ₄(c₂₂₁²−c₂₂₂²)+λ₄(c₂₂₂²−c₂₂₃²)+λ₂c₂₂₃²

+λ₄(c₂₃₁²−c₂₃₂²)+λ₂(c₂₃₂²−c₂₃₃²)+λ₂c₂₃₃²

+λ₂c₁₁₃²+λ₂c₁₂₃²+λ₂c₁₄₃² (4.73)

Subject to:

Ensures Sequencing Across Time Periods:

λ₁≤λ₂ replaces (eq 4.16,4.17,4.18,4.19) (4.74)

λ₃≤λ₄ replaces (eq 4.20,4.21) (4.75)

Ensures Sequencing Between Destinations within Time Periods:

λ₁≤λ₂ replaces (eq 4.22) (4.76)

λ₁≤λ₁ replaces (eq 4.23) (4.77)

λ₃≤λ₃ replaces (eq 4.24,4.25,4.26,4.27) (4.78)

λ₂≤λ₂ replaces (eq 4.28,4.29,4.31,4.33) (4.79)

λ₄≤λ₂ replaces (eq 4.30,4.32) (4.80)

Block Sequencing Constraints:

λ₃≤λ₁ replaces (eq 4.34,4.35,4.36,4.37,4.38,4.39) (4.81)

λ₂≤λ₂ replaces (eq 4.40,4.41,4.42,4.43,4.44,4.45) (4.82)

Capacity Constraints:

Mill Capacity Constraints:

λ₁+λ₃₊+λ₃≤1 replaces (eq 4.46) (4.83)

(λ₂−λ₁)+(λ₄−λ₃)+(λ₄−λ₃)≤1 replaces (eq 4.47) (4.84)

Leach Capacity Constraints:

(λ₂−λ₂)+(λ₂−λ₄)+(λ₂−λ₄)≤1 replaces (eq 4.48) (4.85)

Total Mining Capacity Constraints:

λ₁+λ₁+λ₁+(λ₁−λ₁)+(λ₁−λ₁)+λ₁+λ₃+(λ₃−λ₃)+(λ₃−λ₃)+λ₃+(λ₃−λ₃)+(λ₃−λ₃)≤3 replaces (eq 4.49) (4.86)

λ₂+λ₂+(λ₂−λ₁)+(λ₂−λ₂)+(λ₂−λ₂)+λ₂+(λ₄−λ₃)+(λ₂−λ₄)+(λ₂−λ₂)+(λ₄−λ₃)+(λ₂−λ₄)+(λ₂−λ₂)≤3 replaces (eq 4.50) (4.87)

Variable Restrictions:

0≤λ₁≤1 (4.88)

0≤λ₂≤1 (4.89)

0≤λ₃≤1 (4.90)

0≤λ₄≤1 (4.91)

After eliminating the redundant constraints and finalizing the cost calculations for the objective function, simplified mathematical model for the master problem in the following is obtained.

Objective Function:

Max Z=2.3λ₁+5.7λ₂+0.5λ₃+1.4λ₄ (4.92)

Subject to:

Ensures Sequencing Across Time Periods:

λ₁≤λ₂ (4.93)

λ₃≤λ₄ (4.94)

Ensures Sequencing Between Destinations within Time Periods:

λ₄≤λ₂ (4.95)

Block Sequencing Constraints:

λ₃≤λ₁ (4.96)

Capacity Constraints:

Mill Capacity Constraints:

λ₁+2λ₃≤1 (4.97)

λ₂−λ₁+2λ₄−2λ₃≤1 (4.98)

Leach Capacity Constraints:

2λ₂+2λ₄≤1 (4.99)

Total Mining Capacity Constraints:

4λ₁+2λ₃≤3 (4.100)

6λ₂−λ₁ 2λ₃≤3 (4.101)

Variable Restrictions:

0≤λ₁≤1 (4.102)

0≤λ₂≤1 (4.103)

0≤λ₃≤1 (4.104)

0≤λ₄≤1 (4.105)

The solution to the master problem is achieved by implementing the simplex algorithm.

λ₁=⅓, λ₂=⅔, λ₃=⅓, λ₄=⅓

Each λ variable is essentially representing a set of z_{bd}^{t} variables from the original problem, henceforth the value of the λ variables can be disintegrated to the corresponding z_{bd}^{t} variables of the original problem. Since the contraction operation preserves the original problem structure, the objective function value of the master problem calculated by λ variables and the original problem calculated by replacing the solution values of the λ variables with the associated z_{bd}^{t} variables will be equal to each other.

The next step is to check if the dual values generated from the master problem solution is equal to the duals of the previous iteration to confirm the optimality condition. If not, then the previous steps will be repeated by solving the subproblem with the modified block values, orthogonalizing the new partition with the previous set of partitions and solving the master problem with the corresponding variables to the new set of partitions until the optimality conditions are satisfied. Although this example was not carried to optimality, it is believed that the steps illustrated provide a basic understanding of the BZ algorithm.

4.3 Pseudoflow Algorithm

The Pseudoflow algorithm is so far the fastest known solution algorithm for the network flow problems modeled as max-flow or min-cut type problems. The strength of the Pseudoflow algorithm is exploited in the BZ algorithm as well as the presently disclosed integer solution algorithm. The subproblem of the BZ algorithm is a multi-period sequencing problem which constitutes a totally unimodular structure that allows the Pseudoflow algorithm to take the advantage of the underlying network structure. Moreover, the presently disclosed integer solution algorithm further splits these subproblem max closures into single time period integer feasible sub-closures by iteratively solving the max flow problems with the Pseudoflow algorithm. As this integerizing step may take many iterations to satisfy the feasibility conditions, the fast working mechanism of the Pseudoflow algorithm motivates the implementation of the presently disclosed integer solution algorithm on large scale open pit mining problems.

The theories behind the working mechanism of the Pseudoflow algorithm is extensively discussed in the original paper by Hochbaum (2008), therefore only the summary of the steps of the Pseudoflow algorithm will be presented. Moreover, the computational study of the Pseudoflow algorithm and the push-relabel algorithm is presented by Chandran and Hochbaum (2009). Also, the detailed review of the Pseudoflow algorithm is provided by Van Dunem (2016).

The specific steps of the single iteration of the Pseudoflow algorithm is summarized below (Hochbaum 2008, Van Dunem 2016):

1. Initialize the algorithm by selecting a normalized tree. One simple normalized tree corresponds to a Pseudoflow in Gₛₜ (s, t graph that contains two distinguished nodes s and t; source and sink nodes respectively) saturating all arcs adjacent to the source A(s) and all the arcs adjacent to the sink A(t), and zero on all other arcs.

2. Find a residual arc from a strong set of nodes to a weak set of nodes called as merger arc. If such an arc does not exist, the current solution is optimal.

3. If residual arcs going from a strong node to a weak node exist then, the selected merger arc is appended to the tree, the excess arc of the strong merger branch is removed, and the strong branch is merged with the weak branch.

4. Push the excess of the respective strong branch along the unique path from the root of the strong branch to the root of the weak branch.

5. Split any arc encountered along the path described in 3) which does not have sufficient residual capacity to accommodate the amount pushed. The tail node of that arc becomes a root of a new strong branch with excess equal to the difference between the amount pushed and the residual capacity.

6. The process of pushing excess and splitting is called normalization. The residual capacity of the split arc is pushed further until it either reaches another arc to split or the deficit arc adjacent to the root of the weak branch.

4.4 The Presently Disclosed Integer Solution Algorithm

The presently disclosed integer solution algorithm is developed mainly by exploiting the strengths of the Bienstock-Zuckerberg algorithm outlined in the previous section. The algorithm works towards optimality in conjunction with the BZ algorithm. Although the BZ algorithm is presently the most powerful decomposition algorithm to solve the LP relaxation of the mine production scheduling problems towards proven optimality, the solutions are fractional which results in impractical mine plans. However, the information that will lead solutions towards integrality is also preserved in each iteration. The presently disclosed integer solution algorithm will enjoy the implicit use of this information together with all of the theories behind the working mechanism of the BZ algorithm while unlocking presently disclosed integer solution spaces for the master problem to satisfy the integrality conditions. The algorithm ensures that every column solution generated by the subproblem is partitioned into components that are integer feasible to the capacity constraints of the original problem. This can be achieved simply by converting the original problem into a single time period max flow problem (ultimate pit problem) and parametrizing the block values. While it may take many iterations to be integer feasible to the capacity constraints, the Pseudoflow algorithm will process the underlying network structure quite fast which may result with solution times around 2-3 seconds per iteration. Since mine production scheduling problems also include blending constraints, the duals generated by solving the master problem at each iteration will guide the subproblem solutions towards feasibility for the blending constraints. At each iteration, the orthogonalization process will further increase the dimension of the solution space where integer feasible solutions for the master problem are also available. Furthermore, the contraction operation will allow the master problem to work with a reduced number of rows and columns. This will ensure fast solution times to be achieved for the master problem. Once the optimal LP solution is achieved, there will be set of partitions or solution columns which are integer feasible to the original problem space. The master problem that results with the optimal LP solution can be solved with the integer feasible solution columns to generate an optimal integer solution.

As the algorithm proceeds with splitting the original problem into master and subproblems, the subproblem solutions play a role in terms of defining the coordinates of the extreme point of a polytope located on the intersection of the hyperplanes. The solution to the subproblem is not necessarily integer feasible to the capacity constraints of the original problem. In the regular BZ algorithm, if the partitions defining the solution space of the master problem are infeasible to the capacity constraints, the λ variables which are essentially the weight of each partition may result with fractional values to honor the requirements enforced by the capacity constraints. As this is natural from a linear programming point of view, if the λ variables are defined as binary variables, the solution to the master problem may end up being infeasible. Henceforth, the subproblem solutions which are indeed max closures, must be partitioned into sub-closures that are integer feasible to the capacity constraints of the original problem. As it is illustrated in FIG. 4.14, the outer polytope represents the subproblem solution space where the blue dots are the extreme points which may not appear in the capacity feasible region bounded with a green outline. The solution space to the original problem which is further defined by the hyperplanes representing the additional side constraints will be inside the capacity feasible region and is shown in FIG. 4.14 outlined in black. While the yellow colored corner point defines the LP optimal solution to the original problem, the red points are the set of integer feasible points to the original problem space.

At each iteration k, the solution to the subproblem generates a max closure \vec{C}ₖ which may violate the capacity constraints. Although \vec{C}ₖ only contains the blocks mined in the closure, we still know the actual periods the blocks are mined in since the subproblem is a multi-time period sequencing problem. If the problem has t number of periods, there may exist at least t number of capacity constraints. Hence, the number of blocks or total tonnage mined in closure \vec{C}ₖ at each period can be checked against the capacity requirements of that period. Any time period where the capacity requirements to be satisfied will be further split into sub-closures where each sub-closure honors the capacity requirements. The splitting may continue for a given period until the remaining blocks for that period satisfies the capacity requirements. The mining problem may consist of a number of capacity constraints in an upper bound form where it may not be possible to generate a closure which all constraints are binding. The underlying reason could be a gap problem which is inevitable in parametrization concepts if it exists. Nevertheless, we haven't observed any downside of not being exact with the processing and production requirements as long as the sub-closures are integer feasible. Eventually, by splitting \vec{C}ₖ into sub-closures, each period will end up having its own integer feasible sub-closures as long as the blocks are mined for that period in \vec{C}ₖ.

Theorem 4.1: The set of sub-closures {\vec{S}₁, \vec{S}₂, . . . \vec{S}ₗ} obtained by partitioning the max closure of the subproblem \vec{C}ₖ will span the solution space governed by \vec{C}ₖ.

Proof: Let \vec{C}ₘ be the subproblem closure for some iteration m and \vec{C}ₙ be the subproblem closure for some iteration n. Let {\vec{S}₁, \vec{S}₂, . . . \vec{S}ₖ} be the integer feasible sub-closures for iteration m and {\vec{S}ₖ₊₁, \vec{S}ₖ₊₂, . . . \vec{S}ₖ} be the integer feasible sub-closures for iteration n. By splitting the closure \vec{C}ₘ into {\vec{S}₁, \vec{S}₂, . . . \vec{S}ₖ} and into {\vec{S}ₖ₊₁, \vec{S}ₖ₊₂, . . . \vec{S}ᵣ}, the sets \vec{C}ₘ and \vec{C}ₙ are being partitioned into orthogonal components or axes as shown in FIG. 4.15. Since {\vec{S}₁, \vec{S}₂, . . . \vec{S}ₖ} are orthogonal axes in k-dimensional space, any solution that exists in k-dimensional space can be represented by taking the linear combination of \vec{S}₁, \vec{S}₂ . . . \vec{S}ₖ, therefore \vec{C}ₘ is captured. The same argument holds for \vec{C}ₙ since it is also decomposed into orthogonal axes of {\vec{S}ₖ₊₁, \vec{S}ₖ₊₂, . . . \vec{S}ᵣ}.

Assume that \vec{C}₁, \vec{C}₂, . . . \vec{C}_{q}, are orthogonal columns and their orthogonal partitions are \vec{S}₁, \vec{S}₂, . . . \vec{S}ᵣ. If C={\vec{C}₁, \vec{C}₂, . . . \vec{C}_{q}} and S={\vec{S}₁, \vec{S}₂, . . . \vec{S}ᵣ}, then their convex hull can be represented as:

Span(C)={\vec{C}₁λ₁+\vec{C}₂λ₂+ . . . +\vec{C}_{q}λ_{q}}

Span(S)={\vec{S}₁λ₁+\vec{S}₂λ₂+ . . . +\vec{S}ᵣλᵣ}

Span(S) takes place in q-dimensional space and Span(S) covers the r-dimensional space where r>q, therefore Span(C)⊆Span(S) which completes the proof that any linear combination of the sub-closures spans the solution space where the original closure takes place.

The max closure \vec{C}ₖ is the best solution column or a mining plan generated by solving the subproblem that enters the basis of the system in iteration k, processed as a function of dual variables obtained by solving the master problem. As it was proven by the authors of the BZ algorithm, the partitions generated by iteratively orthogonalizing the \vec{C}ₖ spans the solution space where the extreme point of the original problem or the optimal LP solution is captured.

Corollary 4.2: The further partitioning of max closure \vec{C}ₖ into sub-closures {\vec{S}₁, \vec{S}₂, . . . \vec{S}ₗ} will also lead to an optimal LP solution to the original problem due to Theorem 4.1

We know that the net worth of the mining decision variables is determined as a function of dual vector by the following equation c̅=cᵢ−πaₖ. The dual π column can be characterized as a function of the side constraint it is associated with. The side constraints can be categorized as capacity type and blending type constraints. Since the contribution of the dual values towards subproblem solution space is determined by the side constraints, the role of the dual values will be analyzed for the capacity and blending type constraints separately. Capacity type constraints may limit the number of blocks handled or processed in some way such as total mining production, processed tonnage, amount of material a crusher can handle, total available truck hours, waste dump capacity or amount of material stored in stockpile. Given a mine planning problem constrained with upper bound capacity constraints, implementing the regular BZ algorithm to solve the subproblem by penalizing the block values with the capacity duals is in fact a well-known parametrization approach. The duals will modify the block values that exist in the capacity constraint with the same penalty.

Axiom 4.3: As the penalty values increase, in the absence of gaps there may be an opportunity to obtain max closure \vec{C}ₖ which is integer feasible to the original problem capacity constraints.

In the light of axiom 4.3, we can expect to generate an integer feasible solution towards capacity constraint space at some iteration if the dual values constantly increase in consecutive iterations.

Proposition 4.4: The value of the duals does not constitute a monotonically non-decreasing pattern on consecutive iterations.

Proof: The primal and dual formulation of the master problem is given in FIG. 4.16. It has already been proven that the master problem objective function values are monotonically non-decreasing. Once the master problem is optimal for a particular iteration, the dual objective function value must be equal to the primal objective function value due to the strong duality theorem. This shows that since primal objective function values are monotonically non-decreasing, the dual objective function values must be also monotonically non-decreasing.

It is clear that the objective function coefficients of the dual of a problem (1, h) are constant in every iteration which means that any improvement on the objective function value must be justified by increasing either one or both of the value of the duals π and μ. Also, the dual variable δ does not have any contribution to the objective function value. We also know that the dual values may be non-zero only if the primal constraints are binding. Let's investigate the behavior of the dual variables, first when a mine plan which is infeasible to the capacity constraint is obtained by solving the subproblem and passed to the master problem solution space. If the partitions are infeasible to the capacity constraint, the λ variables will be fractional which means some of the reserve constraints and some of the sequencing constraints will be non-binding. This will result with some of the μ variables having 0 values. Since the capacity constraints will be binding, all the π variables will be greater than or equal to 0. Hence, if consecutive iterations consist of infeasible partitions, π or μ must increase in order to justify the improvement of the objective function value. If the subproblem solution generates a mine plan feasible to the capacity constraint, we know that this is the most valuable integer feasible plan since in a max flow problem the penalized block values will be the best ones to be mined. Therefore, once this plan is passed to the master problem, any λ variable associated with this plan must become 1 in the master problem solution space. Any resource constraint that contain this λ variable must be a binding constraint which makes some of the μ variables become greater than or equal to 0. In this case, the justification of the improvement in the objective function value can be made by increasing either π or μ. In either case, there is no guarantee that the π variable will get a value greater than its former value, in fact the value of π may even decrease if the value of μ increases. Therefore, we cannot claim a monotonically non-decreasing pattern for the capacity dual values.

The proposition 4.4 may justify an integerizing approach towards the subproblem solution space, since the regular BZ algorithm does not guarantee a mining plan integer feasible to the original problem capacity constraint space. Although an integer feasible region for the capacity constraints at each iteration can be secured, the original problem may consist of blending constraints where mining plans generated by the subproblem may need to be integer feasible for the blending constraints. Let's investigate the significance of the dual values generated for the blending type of constraints. First of all, the blending type of constraints can be average grade, material type proportions or risk proportions used at any type of processing destinations. In order to clarify the role of the duals for the blending constraints, a mine plan will be assumed to be constrained with only lower bound blending constraints.

Proposition 4.5: The duals generated for the blending constraints by solving the master problem drive the subproblem solution space towards feasibility for the blending constraints of the original problem.

Proof: Let's assume the following is a lower bound grade blending constraint of the original problem for the time period 1.

Σ_{b∈B}(Gₚ¹−g_{b})p_{b}x_{bp}¹≤0 p∈P (process destinations) (4.106)

Then the master problem formulation for the blending constraint would be as follows:

Σ_{s∈S}(Gₚ¹−gₛ)pₛλₛ≤0 p∈P (4.107)

The master problem variable λₛ is essentially the weight of the closure or partition Cₛ for s=1 to S. The variable λₛ will only exist in the blending constraint for the closure Cₛ, if any blocks in the closure has an existing processing option. At each iteration, the optimal solution to the master problem generates a dual variable π corresponding to the blending constraint (4.107). Then, in order to run the subproblem, the blocks that has a potential value at process destination p will be penalized with the dual value π as shown in the following equation:

c_{bp}^{1*}=c_{bp}¹−πₚ¹(Gₚ¹−g_{b}) p∈P,b∈B (4.108)

Let's analyze the contribution of dual value πₚ¹ towards the modified value c_{bp}^{1*}. First of all, we know that πₚ¹≥0 since the blending constraint (4.107) is written as an upper bound constraint. Since c_{bp}¹ is constant and πₚ¹≥0, the value of the c_{bp}^{1*} will be heavily dependent on the individual grade of a block g_{b}. If g_{b}>Gₚ¹, it means that the grade of the block is greater than the average grade, therefore the value of the block will be increased where c_{bp}^{1*}>c_{bp}¹. If g_{b}>Gₚ¹, then the grade of the block does not honor the average grade requirements, therefore the value of the block will be decreased where c_{bp}^{1*}<c_{bp}¹. This shows that the duals of the blending constraints will implicitly favor the blocks that are integer feasible to the average grade requirements and penalize any blocks that fail to meet the average grade criteria.

To summarize, proposition 4.4 shows that the closure Cₖ is not guaranteed to be integer feasible towards capacity constraints whereas proposition 4.5 shows that the duals obtained for the blending constraints drives the subproblem solution towards feasibility in the case of the blending constraints. In the light of proposition 4.4 and proposition 4.5, we can clearly see the need for an integerizing approach to make each closure Cₖ integer feasible towards capacity constraints.

The iterative integerizing process where the closure Cₖ is divided into integer feasible sub-closures is the backbone of this algorithm. The complexity of the integerizing process depends on the number of the capacity constraints. First of all, let's examine the case where there is only one capacity constraint that limits the number of ore blocks processed per period t with a right-hand side value of CAP^{t}. At each iteration, the subproblem closure Cₖ which represents the best mining plan needs to be split into partitions where each partition Eₜ represents the blocks mined in time period t. In other words, multi time period closure Cₖ is divided into single time period components such as Cₖ={E₁, E₂ . . . E_{T}}. Furthermore, each closure {E₁, E₂ . . . E_{T}} will be split into ore and waste components such as {O₁, O₂ . . . O_{T}} and {W₁, W₂ . . . W_{T}}. In the next step, the number of blocks mined in each period's ore closure will be checked against CAP^{t} for t=1 to T. Any set {E₁, E₂ . . . E_{T}} that satisfies the capacity requirements will be converted into a “by” form and stored in a set Hₖ that holds only the capacity feasible columns of iteration k. If at some period r where |Oᵣ|>CAP^{r}, then the ore closure Oᵣ has failed to meet with the capacity requirements CAP^{r} at period r which means the set Oᵣ needs to be integerized. The integerizing process will be carried out iteratively similar to the parametrization approach until the feasibility conditions are met. Given “R” the set of infeasible periods and “S” the number of iterations, the penalty variable αₛ^{t} is calculated by taking the average of the block values within set Oᵣ as shown in the following:

$${α}_{s}^{t} = \frac{{\sum }_{b ∈ {0}_{t}} {c}_{b}^{t}}{\vert {O}_{t} \vert} t ∈ R , s ∈ S \qquad ( 4.109 )$$

Once αₛ^{t} is calculated, the original block values of the blocks in set Oᵣ will be penalized as follows:

c_{bs}^{t*}=c_{b}^{t}−αₛ^{t} b∈Oₜ,t∈R (4.110)

A single time period block sequencing problem will be formulated with the blocks in the set Eᵣ by using the modified block values c_{bs}^{t*}. Since the problem has an underlying network structure, the Pseudoflow algorithm will be used to solve the problem. Let Iₛ^{r} be the set of blocks mined with the modified block values c_{bs}^{t*} and let Oreₛ^{r} be the set of ore blocks in set Iₛ^{r}. If |Oreₛ^{r}|>CAP^{r}, then the new set Iₛ^{r} is infeasible therefore the blocks in the set Eᵣ should be penalized further by increasing the value of αₛ^{t} until |Oreₛ^{r}|≤CAP^{r}. Once the ore blocks in set Iₛ^{r} satisfy the feasibility conditions of the capacity constraint, they should be taken out from the set Eᵣ such that Eᵣ′=Eᵣ\Iₛr and place in the integer feasible partition set Hₖ. The set of ore blocks Oᵣ′ inside the set of remaining blocks Eᵣ′ will be checked against CAP^{r}. If it fails the capacity requirement, then the block values in set Oᵣ′ are penalized with a new αₛ^{t} calculated by taking the average of the block values within set Oᵣ′ and the single time period network problem is solved for Eᵣ′. The rest of the process will repeat similarly until the remaining blocks are integer feasible for the capacity constraints. The steps outlined above to integerize the subproblem solution so that each sub-closure meets the capacity constraint requirements can be implemented even if the mine plan includes multi capacity destinations. Let's assume that there are p number of processing destinations with a capacity requirement of CAP_{P}^{t}. Similar to the single destination problem, the subproblem closure Cₖ will be split into period closures {E₁, E₂ . . . E_{T}} where each period closure will be split into ore closures per destination such as {O₁^{p}, O₂^{p} . . . O_{T}^{p}}. The penalty variable αₛₚ^{t} will be calculated by taking the average of the block values for each destination p within set Oₚ^{t} as shown in the following:

$${α}_{sp}^{t} = \frac{{\sum }_{b ∈ {O}_{t}} {c}_{bp}^{t}}{\vert {O}_{t}^{p} \vert} t ∈ R , s ∈ S , p ∈ P \qquad ( 4.111 )$$

The original block values at destination Oₜ^{p} in set or will be penalized as follows:

c_{bsp}^{t*}=c_{bp}^{t}−αₛₚ^{t} b∈Oₜ^{p},t∈R,p∈P (4.112)

This shows that the ore blocks are penalized based on the average value of the blocks in the predetermined destinations accomplished by the dual values before solving the subproblem. For example, if there exist 2 processing destinations such as mill and leach. Then, the blocks designated to mill will be penalized with the average block values at mill and the leach blocks will be penalized with the average value of the leach blocks. The rest of the steps will be similar to the single destination case except that now each period's ore set {O₁^{p}, O₂^{p} . . . O_{T}^{p}} needs to meet with the capacity requirements of each destination p at each period t which is CAP_{P}^{t}.

Once the subproblem closure or the best mining plan Cₖ generated under the direction of dual variables is integerized for the capacity constraints of the original problem, the set of integer feasible columns Hₖ is ready to be orthogonalized with the previous iteration's set of orthogonal partitions Vₖ₋₁. The BZ algorithm shown in the previous section may be useful when a single column is orthogonalized with a set of partitions. The presently disclosed integer solution algorithm may have new refinement rules since each integer feasible column in set Hₖ needs to be orthogonalized with each partition in set V^{k-1}; in other words, a set of orthogonal integer feasible columns are orthogonalized with the previous iteration's set of partitions. Assume that V^{k-1} includes {v̅ . . . , v̅ᵣ̅} and Hₖ is includes {h̅ . . . , h̅ₘ̅} where within each column, the blocks are labeled with 1 if they are part of the partition. First, we intersect each one of the columns in Hₖ with each one of the columns in V^{k-1}. If the blocks in column v̅ⱼ̅ are also in column h̅_̅{̅b̅}̅, then the blocks are placed in an intersection column ι and the intersection column ι is placed in the intersection set I as shown in (4.113). The set operation (4.114) shows that non-intersecting part of the column vⱼ is a new column r placed in set R̅. If the blocks exist in column h̅_̅{̅b̅}̅ but do not exist in any of the columns in V^{k-1}, then the blocks are stored in column n̅ which is placed in set N̅ as shown in (4.115). In the end, the set of columns in I, R̅ and N̅ unite to create the set of orthogonal partitions V̅ₖ̅ (4.116).

[symbol]

={ [symbol] = [symbol] ∧ [symbol] :1≤j≤r, 1≤b≤m} (4.113)

[symbol]

={ [symbol] = [symbol] \(Σ_{b=1}^{m×r} [symbol] ):1≤j≤r} (4.114)

[symbol]

{ [symbol] = [symbol] \(Σⱼ₌₁^{r} [symbol] ):1≤b≤m} (4.115)

[symbol]

={ [symbol] }∪{ [symbol] }∪{ [symbol] } (4.116)

The orthogonalization process leads to a higher dimensional solution space spanned by the linear combination of each partition { [symbol] , . . . , [symbol] } in set [symbol] with the variables λⱼ ∀i=1 . . . s. Since the orthogonal partitions are derived from the set of integer feasible columns Hₖ, each partition in set [symbol] is guaranteed to be integer feasible for the capacity constraints. Furthermore, even if the columns in Hₖ are integer feasible for the blending constraints, after the orthogonalization some of the columns may become infeasible. Let's assume set h̅₁̅={x₁, x₂ . . . xₘ} where h̅₁̅ satisfies the blending constraints. Let the orthogonal partitions derived from h̅₁̅ be v̅₁̅={x₁, x₂ . . . xₙ} and v̅₂̅={xₙ, xₙ₊₁ . . . xₘ} where |v̅₁̅|+|v̅₂̅|=m. Since h̅₁̅ is integer feasible for the blending constraints, v̅₁̅ and v̅₂̅ have a mutually exclusive relationship in terms of being infeasible towards blending constraints. Because v̅₁̅ and v̅₂̅ are sub-partitions of h̅₁̅, based on theorem 4.1, any solution space governed by h̅₁̅ will be captured from the span of v̅₁̅ and v̅₂̅. In other words, the blend of v̅₁̅ and v̅₂̅ still preserves the feasibility conditions for the blending constraints.

Once the optimality conditions mentioned in the BZ section are satisfied, the optimal LP solution will be generated. The set of partitions generated in the final iteration will play a role in achieving an integer solution for the original problem. the final set of partitions may be comprised of capacity feasible and combination of blending feasible and infeasible columns. The relationship between the original problem constraint space and the span of the final set of partitions is illustrated in FIG. 4.17. The blue colored region represents the solution space generated by the partitions whereas the outer polytope is the solution space of the original problem. It should be pointed out that the linear combination of the partitions captures a much smaller space where the optimal LP solution which is the extreme point colored with yellow is included as well as some of the integer solutions shown with red color. This shows that once the LP optimal solution is captured, the algorithm is ready to develop an optimal integer solution within the span of the final set of partitions. This can be simply done by declaring the final set of λ variables as binary variables and resolving the last iteration's master problem. The reduced number of rows and columns in the master problem allow the integer solution algorithms of CPLEX to exploit the underlying mathematical structure and obtain an integer solution quickly. Although the final integer solutions are optimal integer solutions within the solution space of the final partitions, it cannot be proven that the solutions are true optimal integer solutions of the original problem. Nevertheless, it was mentioned by the authors the BZ algorithm that the integrality gap between the integer programming solution and the linear programming relaxation is often small. The results indicate that there is a high potential for achieving an integrality gap of less than 1% for the large-scale mining problems constrained with capacity and blending constraints which will be presented in the next section.

4.4.1 Small 2D Example

In this section, the implementation of the presently disclosed integer solution algorithm will be demonstrated on a small 2D example. For the clarity of the example, the destinations of the blocks are pre-determined which means that if the block is classified as an ore it must be processed once it is mined, otherwise it must be wasted. FIG. 4.18 and FIG. 4.19 illustrates the deposit characteristics and the economic block model respectively, and FIG. 4.20 shows the production scheduling requirements.

In this example, a single process capacity constraint will be used. The number of ore blocks mined and processed per period cannot exceed 3 ore blocks. The life of mine is 3 years and the pit walls must not exceed 45 degrees. The presently disclosed integer solution algorithm embedded into BZ algorithm will be implemented in order to generate an optimal mining sequence. The original model formulation with the variables derived in the previous section is given below.

Original Problem Formulation:

z_{bd}^{t}=the fraction of block b, that is extracted by time period t

Objective Function:

Max Z=z₁₁¹(c₁₁¹−c₁₁²)+z₁₂¹(c₁₂¹−c₁₂²)+z₁₃¹(c₁₃¹−c₁₃²)+z₁₄¹(c₁₄¹−c₁₄²)

+z₁₅¹(c₁₅¹−c₁₅²)+z₁₆¹(c₁₆¹−c₁₆²)+z₁₇¹(c₁₇¹−c₁₇²)+z₂₂¹(c₂₂¹−c₂₂²)

+z₂₃¹(c₂₃¹−c₂₃²)+z₂₄¹(c₂₄¹−c₂₄²)+z₂₅¹(c₂₅¹−c₂₅²)+z₂₆¹(c₂₆¹−c₂₆²)

+z₃₃¹(c₃₃¹−c₃₃²)+z₃₄¹(c₃₄¹−c₃₄²)+z₃₅¹(c₃₅¹−c₃₅²)+z₁₁²(c₁₁²−c₁₁³)

+z₁₂²(c₁₂²−c₁₂³)+z₁₃²(c₁₃²−c₁₃³)+z₁₄²(c₁₄²−c₁₄³)+z₁₅²(c₁₅²−c₁₅³)

+z₁₆²(c₁₆²−c₁₆³)+z₁₇²(c₁₇²−c₁₇³)+z₂₂²(c₂₂²−c₂₂³)+z₂₃²(c₂₃²−c₂₃³)

+z₂₄²(c₂₄²−c₂₄³)+z₂₅²(c₂₅²−c₂₅³)+z₂₆²(c₂₆²−c₂₆³)+z₃₃²(c₃₃²−c₃₃³)

+z₃₄²(c₃₄²−c₃₄³)+z₃₅²(c₃₅²−c₃₅³)+z₁₁³c₁₁³+z₁₂³c₁₂³+z₁₃³c₁₃³

+z₁₄³c₁₄³+z₁₅³c₁₅³+z₁₆³c₁₆³+z₁₇³c₁₇³+z₂₂³c₂₂³+z₂₃³c₂₃₃³+z₂₄³c₂₄³

+z₂₅³c₂₅³+z₂₆³c₂₆³+z₃₃³c₃₃³+z₃₄³c₃₄³+z₃₅³c₃₅³

Subject to:

Ensures Sequencing Across Time Periods:

| | | | |
|---|---|---|---|
| z₁₁¹ ≤ z₁₁² | (4.118) | z₁₁² ≤ z₁₁³ | (4.119) |
| z₁₂¹ ≤ z₁₂² | (4.120) | z₁₂² ≤ z₁₂³ | (4.121) |
| z₁₃¹ ≤ z₁₃² | (4.122) | z₁₃² ≤ z₁₃³ | (4.123) |
| z₁₄¹ ≤ z₁₄² | (4.124) | z₁₄² ≤ z₁₄³ | (4.125) |
| z₁₅¹ ≤ z₁₅² | (4.126) | z₁₅² ≤ z₁₅³ | (4.127) |
| z₁₆¹ ≤ z₂₆² | (4.128) | z₁₆² ≤ z₁₆³ | (4.129) |
| z₁₇¹ ≤ z₁₇² | (4.130) | z₁₇² ≤ z₁₇³ | (4.131) |
| z₂₂¹ ≤ z₂₂² | (4.132) | z₂₂² ≤ z₂₂³ | (4.133) |
| z₂₃¹ ≤ z₂₃² | (4.134) | z₂₃² ≤ z₂₃³ | (4.135) |
| z₂₄¹ ≤ z₂₄² | (4.136) | z₂₄² ≤ z₂₄³ | (4.137) |
| z₂₅¹ ≤ z₂₅² | (4.138) | z₂₅² ≤ z₂₅³ | (4.139) |
| z₂₆¹ ≤ z₂₆² | (4.140) | z₂₆² ≤ z₂₆³ | (4.141) |
| z₃₃¹ ≤ z₃₃² | (4.142) | z₃₃² ≤ z₃₃³ | (4.143) |
| z₃₄¹ ≤ z₃₄² | (4.144) | z₃₄² ≤ z₃₄³ | (4.145) |
| z₃₅¹ ≤ z₃₅² | (4.146) | z₃₅² ≤ z₃₅³ | (4.147) |

Block Sequencing Constraints:

| | | | | | |
|---|---|---|---|---|---|
| z₂₂¹ ≤ z₁₁¹ | (4.148) | z₂₂² ≤ z₁₁² | (4.149) | z₂₂³ ≤ z₁₁³ | (4.150) |
| z₂₂¹ ≤ z₁₂¹ | (4.151) | z₂₂² ≤ z₁₂² | (4.152) | z₂₂³ ≤ z₁₂³ | (4.153) |
| z₂₂¹ ≤ z₁₃¹ | (4.154) | z₂₂² ≤ z₁₃² | (4.155) | z₂₂³ ≤ z₁₃³ | (4.156) |
| z₂₃¹ ≤ z₁₂¹ | (4.157) | z₂₃² ≤ z₁₂² | (4.158) | z₂₃³ ≤ z₁₂³ | (4.159) |
| z₂₃¹ ≤ z₁₃¹ | (4.160) | z₂₃² ≤ z₁₃² | (4.161) | z₂₃³ ≤ z₁₃³ | (4.162) |
| z₂₃¹ ≤ z₁₄¹ | (4.163) | z₂₃² ≤ z₁₄² | (4.164) | z₂₃³ ≤ z₁₄³ | (4.165) |
| z₂₄¹ ≤ z₁₃¹ | (4.166) | z₂₄² ≤ z₁₃² | (4.167) | z₂₄³ ≤ z₁₃³ | (4.168) |
| z₂₄¹ ≤ z₁₄¹ | (4.169) | z₂₄² ≤ z₁₄² | (4.170) | z₂₄³ ≤ z₁₄³ | (4.171) |
| z₂₄¹ ≤ z₁₅¹ | (4.172) | z₂₄² ≤ z₁₄² | (4.173) | z₂₄³ ≤ z₁₅³ | (4.174) |
| z₂₅¹ ≤ z₁₄¹ | (4.175) | z₂₅² ≤ z₁₄² | (4.176) | z₂₅³ ≤ z₁₄³ | (4.177) |
| z₂₅¹ ≤ z₁₅¹ | (4.178) | z₂₅² ≤ z₁₅² | (4.179) | z₂₅³ ≤ z₁₅³ | (4.180) |
| z₂₅¹ ≤ z₁₆¹ | (4.181) | z₂₅² ≤ z₁₆² | (4.182) | z₂₅³ ≤ z₁₆³ | (4.183) |
| z₂₆¹ ≤ z₁₅¹ | (4.184) | z₂₆² ≤ z₁₅² | (4.185) | z₂₆³ ≤ z₁₅³ | (4.186) |
| z₂₆¹ ≤ z₁₆¹ | (4.187) | z₂₆² ≤ z₁₆² | (4.188) | z₂₆³ ≤ z₁₆³ | (4.189) |
| z₂₆¹ ≤ z₁₇¹ | (4.190) | z₂₆² ≤ z₁₇² | (4.191) | z₂₆³ ≤ z₁₇³ | (4.192) |
| z₃₃¹ ≤ z₂₂¹ | (4.193) | z₃₃² ≤ z₂₂² | (4.194) | z₃₃³ ≤ z₂₂³ | (4.195) |
| z₃₃¹ ≤ z₂₃¹ | (4.196) | z₃₃² ≤ z₂₃² | (4.197) | z₃₃³ ≤ z₂₃³ | (4.198) |
| z₃₃¹ ≤ z₂₄¹ | (4.199) | z₃₃² ≤ z₂₄² | (4.200) | z₃₃³ ≤ z₂₄³ | (4.201) |
| z₃₄¹ ≤ z₂₃¹ | (4.202) | z₃₄² ≤ z₂₃² | (4.203) | z₃₄³ ≤ z₂₃³ | (4.204) |
| z₃₄¹ ≤ z₂₄¹ | (4.205) | z₃₄² ≤ z₂₄² | (4.206) | z₃₄³ ≤ z₂₄³ | (4.207) |
| z₃₄¹ ≤ z₂₅¹ | (4.208) | z₃₄² ≤ z₂₅² | (4.209) | z₃₄³ ≤ z₂₅³ | (4.210) |
| z₃₅¹ ≤ z₂₄¹ | (4.211) | z₃₅² ≤ z₂₄² | (4.212) | z₃₅³ ≤ z₂₄³ | (4.213) |
| z₃₅¹ ≤ z₂₅¹ | (4.214) | z₃₅² ≤ z₂₅² | (4.215) | z₃₅³ ≤ z₂₅³ | (4.216) |
| z₃₅¹ ≤ z₂₆¹ | (4.217) | z₃₅² ≤ z₂₆² | (4.218) | z₃₅³ ≤ z₂₆³ | (4.219) |

Capacity Constraints:

Process Capacity Constraints:

z₁₂¹+z₁₄¹+z₁₆¹+z₂₂¹+z₂₃¹+z₂₅¹+z₂₆¹+z₃₃¹+z₃₄¹+z₃₅¹≤3 (4.220)

(z₁₂²−z₁₂¹)+(z₁₄²−z₁₄¹)+(z₁₆²−z₁₆¹)+(z₂₂²−z₂₂¹)+(z₂₃²−z₂₃¹)+(z₂₅²−z₂₅¹)+(z₂₆²−z₂₆¹)+(z₃₃²−z₃₃¹)+(z₃₄²−z₃₄¹)+(z₃₅²−z₃₅¹)≤3 (4.221)

(z₁₂³−z₁₂²)+(z₁₄³−z₁₄²)+(z₁₆³−z₁₆²)+(z₂₂³−z₂₂²)+(z₂₃³−z₂₃²)+(z₂₅³−z₂₅²)+(z₂₆³−z₂₆²)+(z₃₃³−z₃₃²)+(z₃₄³−z₃₄²)+(z₃₅³−z₃₅²)≤3 (4.222)

Variable Restrictions:

0≤zᵢⱼ^{t}≤1 ∀i∈{1,2,3}, ∀j∈{1,2,3,4,5,6,7}, ∀t∈{1,2,3} (4.223)

Iteration 1

The first step of the algorithm will start by splitting the ultimate pit closure \vec{C}₁ into integer feasible partitions \vec{h}ₖ, where each partition represents a single time period mine plan that honors the capacity requirements of a given period. We know that \vec{C}₁ is includes blocks in the ultimate pit such as \vec{C}₁={x₁₁, x₁₂, x₁₃, x₁₄, x₁₅, x₁₆, x₁₇, x₂₂, x₂₃, x₂₄, x₂₅, x₂₆, x₃₃, x₃₄, x₃₅}, where the ore blocks are \vec{O}₁={x₁₂, x₁₄, x₁₆, x₂₂, x₂₃, x₂₅, x₂₆, x₃₃, x₃₄x₃₅}. The process capacity is limited to 3 blocks per period such that CAP^{t}=3 for t=1, 2, 3. Since |\vec{O}₁|>CAP¹, the blocks in ore set \vec{O}₁ will be penalized with αₛ^{t} which is the average value of the ore blocks in set \vec{O}₁ at period t for iteration s as shown below:

$${α}_{1}^{1} = \frac{{\sum }_{b ∈ {O}_{1}} {c}_{b}^{1}}{\vert {\vec{O}}_{1} \vert} = \frac{39}{10} = 3.9 \qquad ( 4.224 )$$

Once, the original block values c_{b}¹ as shown in FIG. 4.19 are penalized with α₁¹=3.9, a single time period block sequencing problem is modeled as a network flow problem and the Pseudoflow algorithm is implemented to solve the problem. The solution to the problem is shown in FIG. 4.21. Let h̅₁̅ be the blocks in the parametrized plan and O̅r̅e̅₁̅¹̅ be the set of ore blocks mined in the plan. Since |O̅r̅e̅₁̅¹̅|=3, the capacity requirements are satisfied, and we are done with period 1.

The initial set \vec{C}₁ which holds the blocks in the ultimate pit will be updated by extracting the integer feasible plan for period 1 such as \vec{C}₁=\vec{C}₁\\vec{h}₁. The remaining blocks are shown in set \vec{C}₂ such as \vec{C}₂={x₁₅,x₁₆,x₁₇,x₂₃,x₂₄,x₂₅,x₂₆,x₃₃,x₃₄,x₃₅,} and the remaining ore blocks are \vec{O}₂={x₁₆,x₂₃,x₂₅,x₂₆,x₃₃,x₃₄,x₃₅,}. Since |\vec{O}₂|>CAP², the ore blocks should be penalized. This time the average value of the ore blocks α₁² in set \vec{O}₂ is calculated as 3.28. Once the original block values c_{b}¹ are penalized and the maximum flow network problem is solved, no ore blocks are mined. This may happen in real mining problems also where the penalty value is too high to allow an economic extraction sequence. The solution is incrementally adjusting the penalty values until a feasible sequence is achieved. In this particular example, a penalty value of 2.9 will be picked and the process will be continued. The feasible mining sequence obtained by solving the network flow problem with the adjusted penalty value α₂²=2.9 is shown in FIG. 4.22 where |\vec{Ore₁²}|=2. Since |\vec{Ore₁²}|<CAP², the mined blocks are stored in set \vec{h}₂.

Once the period 2 integer feasible mine plan is achieved, the remaining blocks are determined by extracting \vec{h}₂ from \vec{C}₂ such as \vec{C}₃=\vec{C}₂\\vec{h}₂ where \vec{C}₃={x₁₆,x₁₇,x₂₄,x₂₅,x₂₆,x₃₃,x₃₄,x₃₅,} and the new ore set \vec{O}₃={x₂₅,x₂₆,x₃₃,x₃₄,x₃₅,}. The ore blocks are further penalized because there are more blocks then the process capacity requirement for period 3; |\vec{O}₃|>CAP³. Again, the average ore value 3.4 is too high for a penalty; therefore, it will be discounted. The penalty value α₂³=2.3 is selected and the max flow problem is solved. The resulting feasible mining sequence is shown in FIG. 4.23. The number of ore blocks mined |\vec{Ore₁³}|=3 satisfies the capacity requirements of period 3, henceforth; the mined blocks are stored in set \vec{h}₃.

The pit will be updated by extracting the feasible region \vec{h}₃ from \vec{C}₃ such as \vec{C}₄=\vec{C}₃\\vec{h}₃ as shown in FIG. 4.24 where \vec{C}₄={x₁₇,x₂₆,x₃₅} and the new ore set \vec{O}₄={x₂₆,x₃₅}. Since period 3 is the last period and the remaining ore blocks satisfy the capacity requirements; |\vec{O}₄|<CAP⁴, the set of remaining blocks \vec{C}₄ will become a new partition \vec{h}₄.

Once the integer feasible pits \vec{h}₁, \vec{h}₂, \vec{h}₃, \vec{h}₄ are mapped into their physical locations as shown in FIG. 4.25, the sequencing of the pits across the periods becomes apparent. It is clear that the yellow colored pit \vec{h}₁ needs to be mined in period 1 in order to extract the green colored pit \vec{h}₂ in period 2. The blue colored pit \vec{h}₃ can be mined in period 3, once \vec{h}₁ and \vec{h}₂ are taken. The pink colored pit \vec{h}₄ will become available in period 3 only if \vec{h}₁, \vec{h}₂, \vec{h}₃ are extracted. Another important fact is, the integer feasible pits \vec{h}₁, \vec{h}₂, \vec{h}₃, \vec{h}₄ are orthogonal which can be identified easily from FIG. 4.25 that no blocks are shared between any pits. Since the columns \vec{h}₁, \vec{h}₂, \vec{h}₃, \vec{h}₄ are integer feasible and orthogonal, an initial set of partitions \vec{v}₁, \vec{v}₂, \vec{v}₃, \vec{v}₄ can be constructed as shown in FIG. 4.26.

The columns of the orthogonal partitions \vec{v}₁, \vec{v}₂, \vec{v}₃, \vec{v}₄ will lead to a contraction operation where each z_{b}^{t} variable that exists in the same partition will be replaced with the corresponding variable. Below is the master problem generated from the original problem by direct variable substitution.

λ₁ \vec{v}₁={z₁₁¹,z₁₂¹,z₁₃¹,z₁₄¹,z₂₂²,z₁₁²,z₁₂²,z₁₃²,z₁₄²,z₂₂²z₁₁³,z₁₂³,z₁₃³,z₁₄³,z₂₂³}

λ₂ \vec{v}₂={z₁₆²,z₂₃²,z₁₆³,z₂₃³}

λ₃ \vec{v}₃={z₁₅³,z₂₄³,z₂₅³,z₃₃³,z₃₄³}

λ₄ \vec{v}₄={z₁₇³,z₂₆³,z₃₅³}

Master Problem Formulation:

Objective Function:

Max Z=λ₁(c₁₁¹−c₁₁²)+λ₁(c₁₂¹−c₁₂²)+λ₁(c₁₃¹−c₁₃²)+λ₁(c₁₄¹−c₁₄²)

+λ₁(c₂₂¹−c₂₂₂²)+λ₁(c₁₁²−c₁₁³)+λ₁(c₁₂²−c₁₂³)+λ₁(c₁₃²−c₁₃³)

+λ₁(c₁₄²−c₁₄³)+λ₂(c₁₆²−c₁₆³)+λ₁(c₂₂²−c₂₂³)+λ₂(c₂₃²−c₂₃³)

+λ₁c₁₁³+λ₁c₂³+λ₁c₁₃³+λ₁c₁₄³+λ₃c₁₅³+λ₂c₁₆³+λ₄c₁₇³+λ₁c₂₂³

+λ₂c₂₃³+λ₃c₂₄³+λ₃c₂₅³+λ₄c₂₆³+λ₃c₃₃³+λ₃c₃₄³+λ₄c₃₅³ (4.225)

Subject to:

Block Sequencing Constraints:

λ₂≤λ₁ (4.226)

λ₃≤λ₂ (4.227)

λ₄≤λ₃ (4.228)

Capacity Constraints:

Process Capacity Constraints:

λ₁+λ₁+λ₁≤3 (4.229)

(λ₁−λ₁)+(λ₁−λ₁)+λ₂+(λ₁−λ₁)+λ₂≤3 (4.230)

(λ₁−λ₁)+(λ₁−λ₁)+(λ₂−λ₂)+(λ₁−λ₁)+(λ₂−λ₂)+λ₃+λ₄+λ₃+λ₃+λ₄≤3 (4.231)

Variable Restrictions:

0≤λᵢ≤1 ∀i∈{1,2,3,4} (4.232)

Once the mathematical model is simplified, the following model is generated.

Objective Function:

Max Z=λ₁+5.4λ₂+5.6λ₃+1.6λ₄ (4.233)

Subject to:

Block Sequencing Constraints:

λ₂≤λ₁ (4.234)

λ₃≤λ₂ (4.235)

λ₄≤λ₃ (4.236)

Capacity Constraints:

Process Capacity Constraints:

3λ₁≤3 (4.237)

2λ₂≤3 (4.238)

3λ₃+2λ₄≤3 (4.239)

Variable Restrictions:

0≤λᵢ≤1 ∀i∈{1,2,2,4} (4.240)

The solution to the model results with λ₁=1, λ₂=1, λ₃=1 and λ₄=0, which means that the value of the mining decision variables z_{b}^{t} in set \vec{v}₁, \vec{v}₂, \vec{v}₃ are also equal to 1. The NPV of the master problem is 23. The dual values generated for the capacity constraints (4.234), (4.235), and (4.236) are μ₁=5.8, μ₂=0, μ₃=1.87 respectively. It is clear that since the constraints (4.234) and (4.236) are binding, μ₁, μ₃>0 and the non-binding constraint (4.235) resulted with μ₂=0.

Iteration 2

The original block values of the ore blocks are penalized with the dual values. Period 1 ore block values will be penalized with μ₁ and period 3 ore block values will be penalized with μ₃. Then, the subproblem which is a multi-time period sequencing problem is solved with the Pseudoflow algorithm. The subproblem solution which is currently the best mining plan is shown in FIG. 4.27 where all the blocks are mined in period 2. Since this plan is not feasible for the period 2 capacity constraint, it should be partitioned into capacity feasible plans. The splitting process may be the same as iteration 1 because the closure obtained from the subproblem includes all the blocks. Moreover, the resulting partitions are equivalent to the period 3 partitions generated in Iteration 1 shown in FIG. 4.25. The physical locations of the integer feasible pits are shown in FIG. 4.28. The mathematical structure of the subproblem max closure and the integer feasible sub-closures are shown in FIG. 4.29 where the subproblem solution column \vec{s}₁ is decomposed into the integer feasible components \vec{h}₁, \vec{h}₂, \vec{h}₃, \vec{h}₄. It can be easily seen that \vec{s}₁=\vec{h}₁ ∪\vec{h}₂ ∪\vec{h}₃ ∪\vec{h}₄. Furthermore, we know that the orthogonal partitions of the previous iteration are \vec{v}₁, \vec{v}₂, \vec{v}₃, \vec{v}₄. Once the new integer feasible partitions \vec{h}₁, \vec{h}₂, \vec{h}₃, \vec{h}₄ are appended to the previous set of partitions as shown in FIG. 4.30, it is clear that the columns do not constitute an orthogonal structure. Henceforth, the orthogonalization process will take place between the two sets of partitions. The final set of partitions obtained from the orthogonalization process is demonstrated in FIG. 4.31. Also, the blocks captured in each partition is colored and these partitions are mapped into their physical location as illustrated in FIG. 4.32 to clarify the relationship between the orthogonal columns and the actual pit.

The original variables z_{b}^{t} that appear in the orthogonal columns \vec{v}₁ to \vec{v}₇ will be replaced with the variables λ₁ to λ₇ as part of the contraction operation and the master problem will be formulated as follows:

λ₁ \vec{v}₁={z₁₁²,z₁₂²,z₁₃²,z₁₄²,z₂₂²,z₁₁³,z₁₂³,z₁₃³,z₁₄³,z₂₂³}

λ₂ \vec{v}₂={z₁₆²,z₂₃²,z₁₆³,z₂₃³}

λ₃ \vec{v}₃={z₁₅³,z₂₄³,z₂₅³,z₃₃³z₃₄³}

λ₄ \vec{v}₄={z₁₇³,z₂₆³,z₃₅³}

λ₅ \vec{v}₅={z₁₁¹,z₁₂¹,z₁₃¹,z₁₄¹,z₂₂¹}

λ₆ \vec{v}₆={z₁₅²,z₂₄²,z₂₅²,z₃₃²,z₃₄²}

λ₇ \vec{v}₇={z₁₇²,z₂₆²,z₃₅²}

Master Problem Formulation:

Objective Function:

Max Z=λ₅(c₁₁¹−c₁₁²)+λ₅(c₁₂¹−c₁₂²)+λ₅(c₁₃¹−c₁₃²)+λ₅(c₁₄¹−c₁₄²)

+λ₅(c₂₂¹−c₂₂²)+λ₁(c₁₁²−c₁₁³)+λ₁(c₁₂²−c₁₂³)+λ₁(c₁₃²−c₁₃³)

+λ₁(c₁₄²−c₁₄³)+λ₆(c₁₅²−c₁₅³)+λ₂(c₁₆²−c₁₆³)+λ₇(c₁₇²−c₁₇³)

+λ₁(c₂₂²−c₂₂³)+λ₂(c₂₃²−c₂₃³)+λ₆(c₂₄²−c₂₄³)+λ₆(c₂₅²−c₂₅³)

+λ₇(c₂₆²−c₂₆³)+λ₆(c₃₃²−c₃₃³)+λ₆(c₃₄²−c₃₄³)+λ₇(c₃₅²−c₃₅³)+λ₁c₁₁³

+λ₁c₁₂³+λ₁c₁₃³+λ₁c₁₄³+λ₃c₁₅³+λ₂c₁₆³+λ₄c₁₇³+λ₁c₂₂³+λ₂c₂₃³

+λ₃c₂₄³+λ₃c₂₅³+λ₄c₂₆³+λ₃c₃₃³+λ₃c₃₄³+λ₄c₃₅³ (4.241)

Ensures Sequencing Across Time Periods:

λ₅≤λ₁ (4.242)

λ₆≤λ₃ (4.243)

λ₇≤λ₄ (4.244)

Block Sequencing Constraints:

λ₂≤λ₁ (4.245)

λ₆≤λ₂ (4.246)

λ₇≤λ₆ (4.247)

λ₃≤λ₂ (4.248)

λ₄≤λ₃ (4.249)

Capacity Constraints:

Process Capacity Constraints:

λ₅+λ₅+λ₅≤3 (4.250)

(λ₁−λ₅)+(λ₁−λ₅)+λ₂+(λ₁−λ₅)+λ₂+λ₆+λ₇+λ₆+λ₆+λ₇≤3 (4.251)

(λ₁−λ₁)+(λ₁−λ₁)+(λ₂−λ₂)+(λ₁−λ₁)+(λ₂−λ₂)+(λ₃−λ₆)+(λ₄−λ₇)+(λ₃−λ₆)+(λ₃−λ₆)+(λ₄−λ₇)≤3 (4.253)

Variable Restrictions:

0≤λᵢ≤1 ∀iϵ{1,2,3,4,5,6,7} (4.253)

The mathematical model is simplified as follows:

Max Z=10.7λ₁+5.4λ₂+5.6λ₃+1.6λ₄+1.3λ₅+0.7λ₆+0.2λ₇ (4.254)

Ensures Sequencing Across Time Periods:

λ₅≤λ₁ (4.255)

λ₆≤λ1₃ (4.256)

λ₇≤λ₄ (4.257)

Block Sequencing Constraints:

λ₂≤λ₁ (4.258)

λ₆≤λ₂ (4.259)

λ₇≤λ₆ (4.260)

λ₃≤λ₂ (4.261)

λ₄≤λ₃ (4.262)

Capacity Constraints:

Process Capacity Constraints:

3λ₅≤3 (4.263)

3λ₁−3λ₅+2λ₂+3λ₆+2λ₇≤3 (4.264)

3λ₃−3λ₆+2λ₄−2λ₇≤3 (4.265)

Variable Restrictions:

0≤λᵢ≤1 ∀iϵ{1,2,3,4,5,6,7} (4.266)

By applying the simplex algorithm, the following solution is achieved:

λ₁=1, λ₂=1, λ₃=1, λ₄=0.5, λ₅=1, λ₆=0.33, λ₇=0 where Z=24.03.

Duals For Capacity Constraints μ₁¹1.4, μ₁²=1, μ₁³=0.9

Iteration 3

After penalizing the original block values with the dual variables μ₁¹, μ₁², μ₁³, the subproblem is solved. The max closure which is essentially a mine plan generated by solving the subproblem is shown in FIG. 4.33. With the modified block values, the most valuable plan determined by the subproblem is to mine blocks in period 1 and period 2. Let \vec{C}₁ be the set of blocks mined in period 1 such as \vec{C}₁={x₁₁,x₁₂,x₁₃,x₁₄,x₂₂}. Let \vec{O}₁ be the set of ore blocks in \vec{C}₁ such as \vec{O}₁={x₁₂,x₁₄,x₂₂}. Since |\vec{O}₁|=CAP¹, the blocks in \vec{C}₁ are transferred to the integer feasible set \vec{h}₁. Let the closure \vec{C}₂ holds the blocks mined in period 2 such as; \vec{C}₂ {x₁₅,x₁₆,x₁₇,x₂₃,x₂₄,x₂₅,x₂₆,x₃₃,x₃₄,x₃₅} and the ore blocks in \vec{C}₂ are stored in ore set; \vec{O}₂={x₁₆,x₂₃,x₂₆,x₃₃,x₃₄,x₃₅}. The fact that |\vec{O}₂|>CAP² shows that the period 2 pit needs to be split into the integer feasible mine plans.

Initially, the penalty parameter α₁² is calculated as 2.9 by taking the average of the ore values in set \vec{O}₂. Once the ore blocks are penalized, the single time period sequencing problem is solved but no solution is achieved due to the uneconomic modified block values. The new penalty variable α₂² is selected as 0.75. Once the new max flow problem is solved, the mine plan shown in FIG. 4.34 is obtained. The number of ore blocks mined is |\vec{Ore₁²}|=3 which meets with the capacity requirements; therefore, the mined blocks are transferred to the integer feasible partition \vec{h}₂. The period 2 set \vec{C}₂ will be updated by extracting the new partition \vec{h}₂ such as \vec{C}₃=\vec{C}₂\\vec{h}₂.

The remaining blocks in the pit are \vec{C}₃={x₁₇,x₂₅,x₂₆,x₃₄,x₃₅} as shown in FIG. 4.35). The ore blocks in the remaining closure are \vec{O}₃={x₂₆,x₃₄,x₃₅} where |\vec{O}₃|=CAP³ which means the feasibility criteria is satisfied and the integerizing process is finalized by transferring the reaming blocks to the partitions \vec{h}₃.

Once the integerizing step is completed, the pit demonstrated in FIG. 4.36 which includes integer feasible mine plans is achieved. The subproblem column together with its integer feasible partitions is shown in FIG. 4.37 where the max closure \vec{s}₂ is decomposed into integer feasible sub-closures \vec{h}₁, \vec{h}₂, \vec{h}₃. The previous set of orthogonal partitions and the current integer feasible partitions are also presented together in FIG. 4.38 to emphasize the non-orthogonal relation between the two set of partitions. Once these partitions are orthogonalized, the resulting set of columns are shown in FIG. 4.39 where the blocks that exist in the same partition have the same color. Finally, the integer feasible orthogonal partitions are mapped into their physical locations shown in FIG. 4.40.

Below is the master problem formulation written by direct substitution of the original variables z_{b}^{t} that appear in the orthogonal columns \vec{v}₁ to \vec{v}₉ with the variables λ₁ to λ₉.

λ₁ \vec{v}₁={z₁₁²,z₁₂²,z₁₃²,z₁₄²,z₂₂²,z₁₁³,z₁₂³,z₁₃³,z₁₄³,z₂₂³}

λ₂ \vec{v}₂={z₁₁¹,z₁₂¹,z₁₃¹,z₁₄¹,z₂₂¹}

λ₃ \vec{v}₃={z₁₆²,z₂₃²,z₁₆³,z₂₃³}

λ₄ \vec{v}₄={z₁₅³,z₂₄³,z₃₃³}

λ₅ \vec{v}₅={z₁₅⁵,z₂₄⁵,z₃₃⁵}

λ₆ \vec{v}₆={z₂₅³,z₃₄³}

λ₇ \vec{v}₇={z₁₇³,z₂₆³,z₃₅³}

λ₈ \vec{v}₈={z₂₅²,z₃₄²}

λ₉ \vec{v}₉={z₁₇²,z₂₆²,z₃₅²}

Master Problem Formulation:

Objective Function:

Max Z=λ₂(c₁₁¹−c₁₁²)+λ₂(c₁₂¹−c₁₂²)+λ₂(c₁₃¹−c₁₃²)+λ₂(c₁₄¹−c₁₄²)

+λ₂(c₂₂¹−c₂₂²)+λ₁(c₁₁²−c₁₁³)+λ₁(c₁₂²−c₁₂³)+λ₁(c₁₃²−c₁₃³)

+λ₁(c₁₄²−c₁₄³)+λ₅(c₁₅²−c₁₅³)+λ₃(c₁₆²−c₁₆³)+λ₉(c₁₇²−c₁₇³)

+λ₁(c₂₂²−c₂₂³)+λ₃(c₂₃²−c₂₃³)+λ₅(c₂₄²−c₂₄³)λ₈(c₂₅²−c₂₅³)

+λ₉(c₂₆²−c₂₆³)+λ₅(c₃₃²−c₃₃³)+λ₈(c₃₄²−c₃₄³)+λ₉(c₃₅²−c₃₅³)+λ₁c₁₁³

+λ₁c₁₂³+λ₁c₁₃³+λ₁c₁₄³+λ₄c₁₅³+λ₃c₁₆³+λ₇c₁₇³+λ₁c₂₂³+λ₃c₂₃³

+λ₄c₂₄³+λ₆c₂₅³+λ₇c₂₆³+λ₄c₃₃³+λ₆c₃₄³+λ₇c₃₅³ (4.267)

By Constraints Across Time Periods:

λ₂≤λ₁ (4.268)

λ₆≤λ₃ (4.269)

λ₅≤λ₄ (4.270)

λ₈≤λ₆ (4.271)

λ₉≤λ₇ (4.272)

Block Sequencing Constraints:

λ₃≤λ₁ (4.273)

λ₅≤λ₃ (4.274)

λ₈≤λ₅ (4.275)

λ₉≤λ₈ (4.276)

λ₄≤λ₃ (4.277)

λ₆≤λ₄ (4.278)

λ₇≤λ₆ (4.279)

Capacity Constraints:

Process Capacity Constraints:

λ₂+λ₂+λ₂≤3 (4.280)

(λ₁−λ₂)+(λ₁−λ₂)+λ₃+(λ₁−λ₂)+λ₈+λ₉+λ₅+λ₈+λ₉≤3 (4.281)

(λ₁−λ₁)+(λ₁−λ₁)+(λ₃−λ₃)+(λ₁−λ₁)+(λ₃−λ₃)+(λ₆−λ₈)+(λ₇−λ₉)+(λ₄−λ₅)+(λ₆−λ₈)+(λ₇−λ₉)≤3 (4.282)

Variable Restrictions:

0≤λᵢ≤1 ∀iϵ{1,2,3,4,5,6,7,8,9} (4.283)

The simplified mathematical model for the master problem is in the following:

Max Z=10.7λ₁+1.3λ₂+5.4λ₃+1.6λ₄+0.2λ₅+4λ₆+1.6λ₇+0.5λ₈+0.2λ₉ (4.284)

By Constraints Across Time Periods:

λ₂≤λ₁ (4.285)

λ₆≤λ₃ (4.286)

λ₅≤λ₄ (4.287)

λ₈≤λ₆ (4.288)

λ₉≤λ₇ (4.289)

Block Sequencing Constraints:

λ₃≤λ₁ (4.290)

λ₅≤λ₃ (4.291)

λ₈≤λ₅ (4.292)

λ₉≤λ₈ (4.293)

λ₄≤λ₃ (4.294)

λ₆≤λ₄ (4.295)

λ₇≤λ₆ (4.296)

Capacity Constraints:

Process Capacity Constraints:

λ₂+λ₂+λ₂≤3 (4.297)

(λ₁−λ₂)+(λ₁−λ₂)+λ₃+(λ₁−λ₂)+λ₃+λ₈+λ₉+λ₅+λ₈+λ₉≤3 (4.298)

(λ₁−λ₁)+(λ₁−λ₁)+(λ₃−λ₃)+(λ₁−λ₁)+(λ₃−λ₃)+(λ₆−λ₈)+(λ₇−λ₉)+(λ₄−λ₅)+(λ₆λ−₈)+(λ₇−λ₉)≤3 (4.299)

Variable Restrictions:

0≤λᵢ≤1 ∀iϵ{1,2,3,4,5,6,7,8,9} (4.300)

The solution to the master problem is:

λ₁=1, λ₂=1, λ₃=1, λ₄=1, λ₅=0.33, λ₆=1, λ₇=0.5, λ₈=0.33, λ₉=0

where Z=24.03.

Duals For Capacity Constraints→μ₁¹=1.4, μ₁²=1, μ₁³=0.9

The dual values generated in consecutive iterations are equal, henceforth we can confirm that the optimal LP solution is achieved. Since the sub-problem max closures are broken into integer feasible sub-closures at each iteration, once the optimal LP solution is achieved, it can be concluded that we have a set of integer feasible partitions which are {\vec{v}₁,\vec{v}₂,\vec{v}₃,\vec{v}₄,\vec{v}₅,\vec{v}₆,\vec{v}₇,\vec{v}₈,\vec{v}₉} that span the optimal LP solution. In the next step, the optimal integer solution that exists within the solution space of these partitions will be identified. This will be done simply by replacing the continuous variable λᵢ∈[0,1] with the binary variable λᵢ∈{0,1} and re-solving the master problem of the last iteration. The optimal integer solution of the master problem is: λ₁=1, λ₂=1, λ₃=1, λ₄=1, λ₅=1, λ₆=1, λ₇=0, λ₈=0, λ₉=0, where Z=23.13. Since each λ variable represents a set of original problem variables, the value λ variable will be also the value of the associated original problem variables. Therefore, if the λ variables are converted back to the original mining variables, the following set which represents the period at which the blocks are mined will be generated:

Period 1={x₁₁¹, x₁₂¹, x₁₃¹, x₁₄¹, x₂₂¹}

Period 2={x₁₆², x₂₃², x₃₃²}

Period 3={x₁₅³, x₂₄³, x₂₅³, x₃₄³}

To verify the results, the true IP solution to the original problem formulation was also determined and matched the solution obtained with the presently disclosed integer solution algorithm presented in this thesis. As we know the optimal LP and optimal IP solutions, the true optimality gap is 3.75%. The physical locations of the optimal schedules are shown in FIG. 4.41.

Section 5. Implementation of the Presently Disclosed Integer Solution Algorithm to the Large-Scale Open Pit Mining Problems

In this chapter, case studies will be presented to illustrate the implementation of the presently disclosed integer solution algorithm on large scale open pit mining problems. Some of these mining problems may allow multiple processing options for a given block where the destination selection will be a function of a dynamic cutoff grade optimization process defined by the state of the system under capacity, average grade blending and risk blending constraints. Some of the mining problems may have multiple sources to feed the blocks into the process stream such as multiple pits and stockpiles. There is no known algorithm, either commercially available or presented in the literature, that can provide an optimal integer solution to the open pit mine production scheduling problem with capacity constraints together with lower and upper bound blending constraints. The strength of the integer solution algorithm developed in this thesis will be highlighted on the ability of solving problems that have more than 7 million variables as an integer problem with an optimality gap as small as 0.01% within 5 hours 30 minutes.

5.1 Case Study 1 (McLaughlin Deposit)

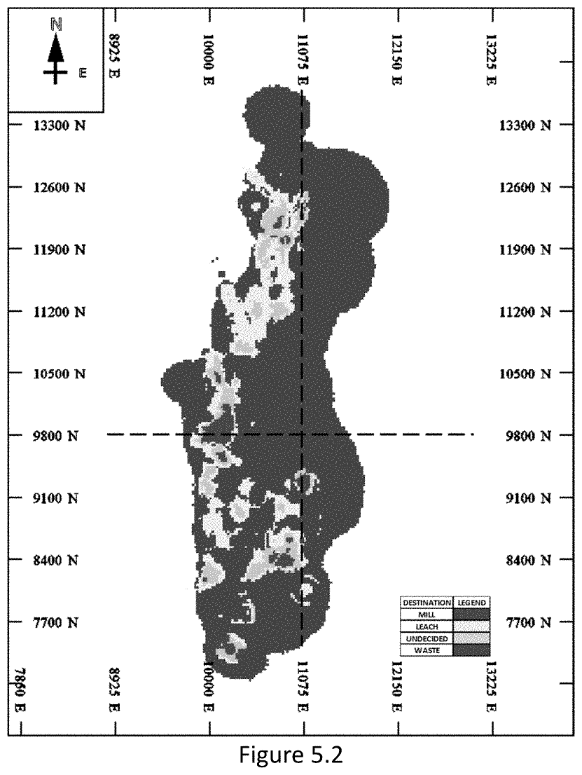

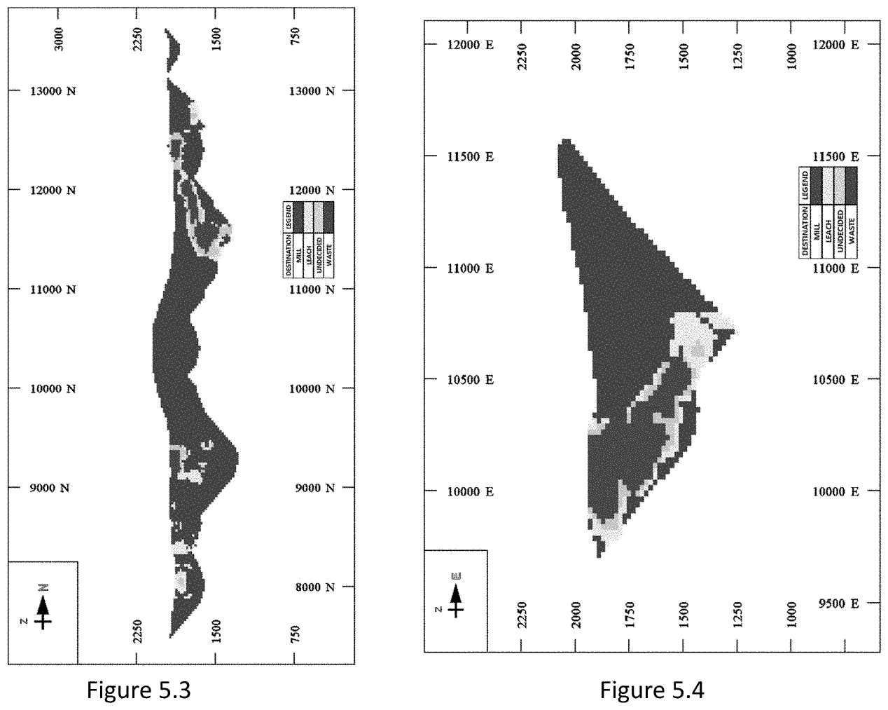

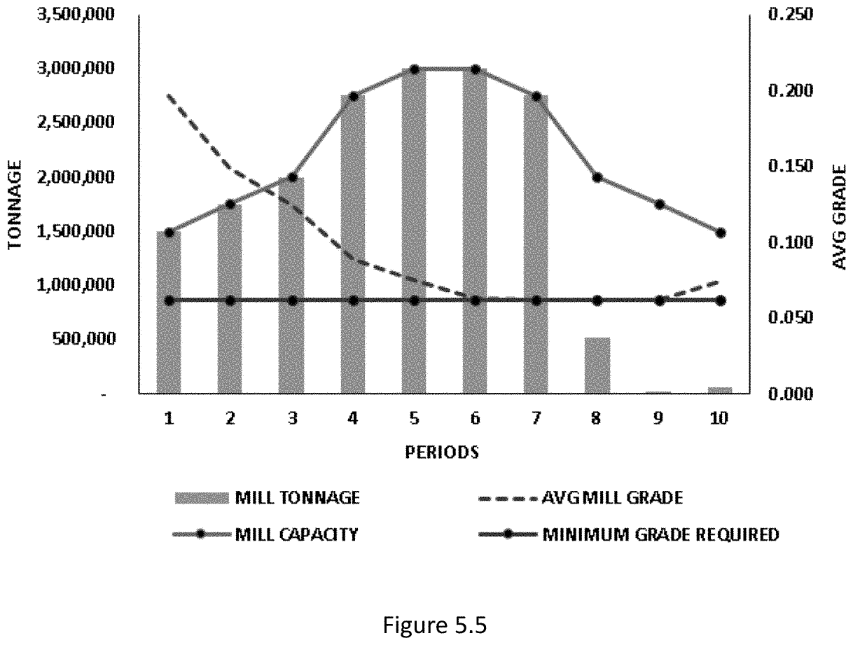

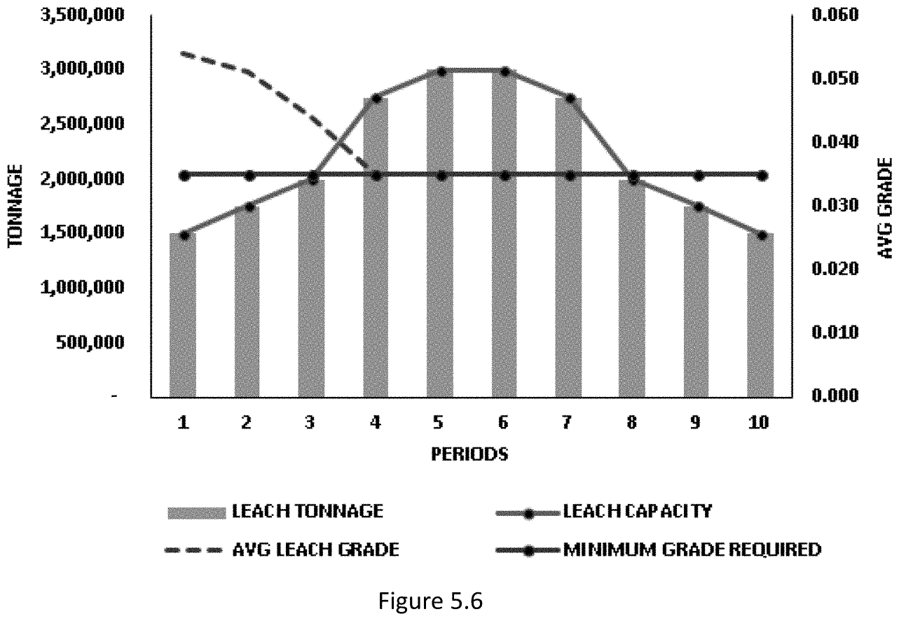

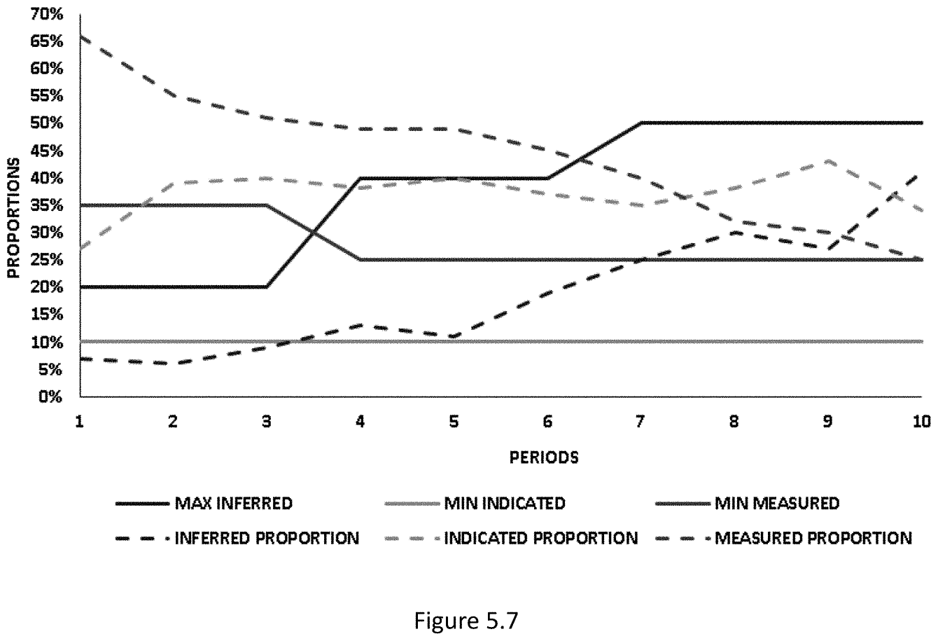

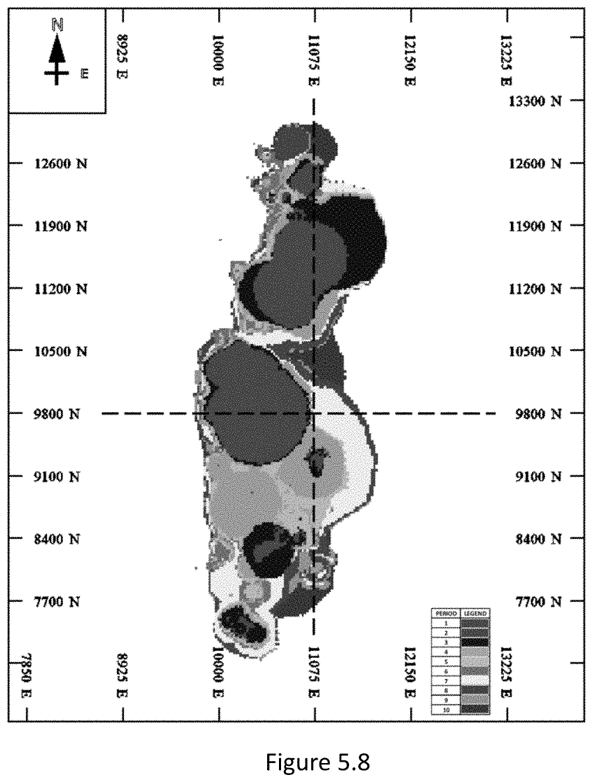

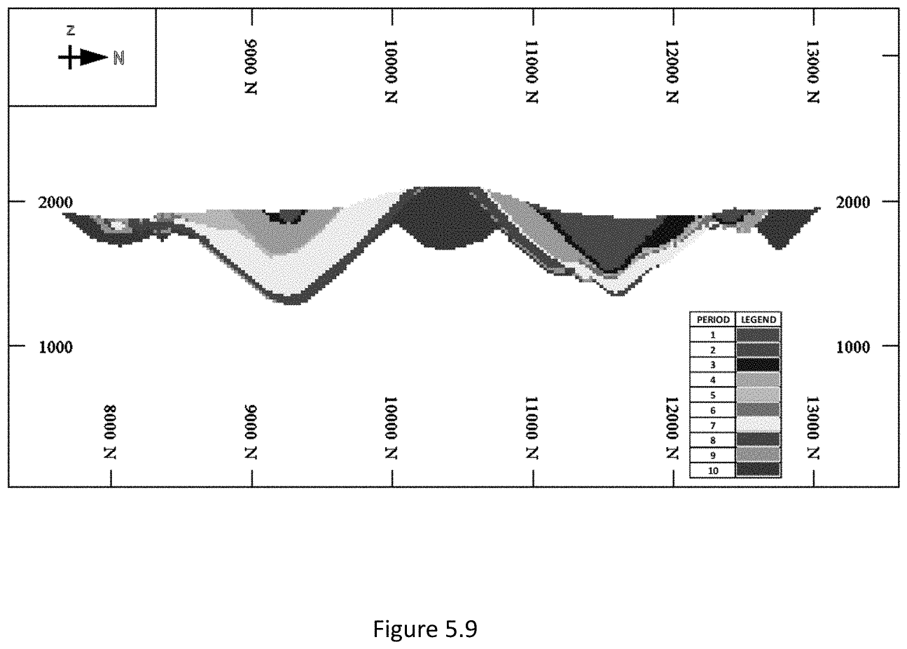

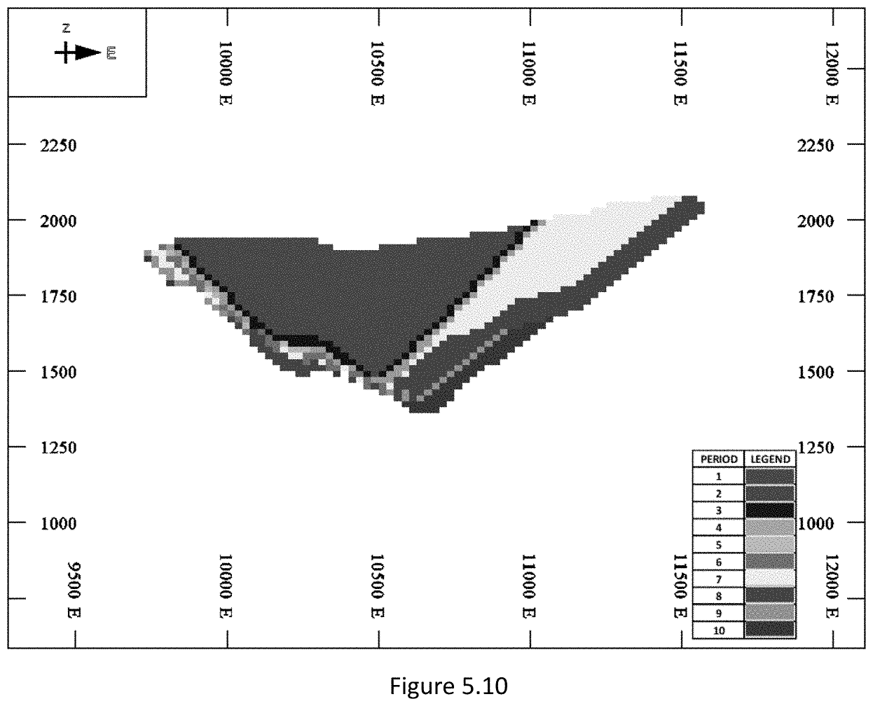

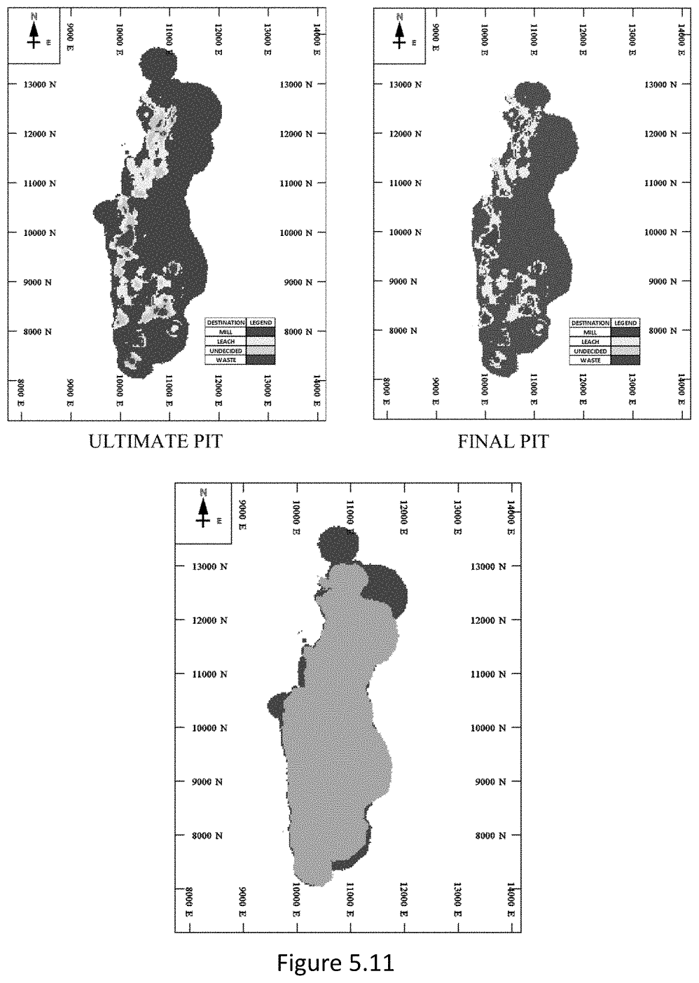

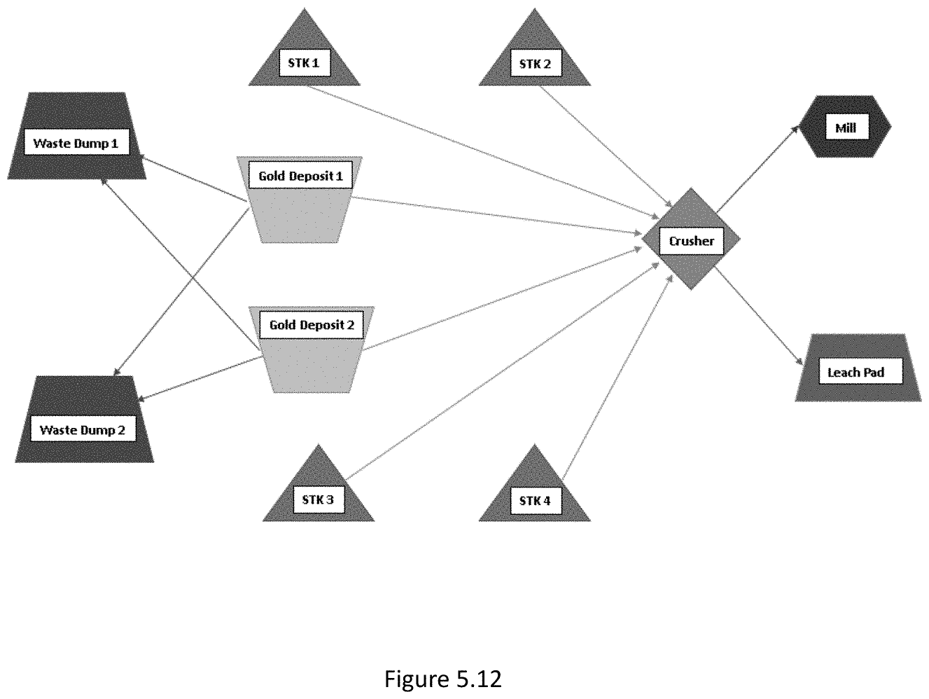

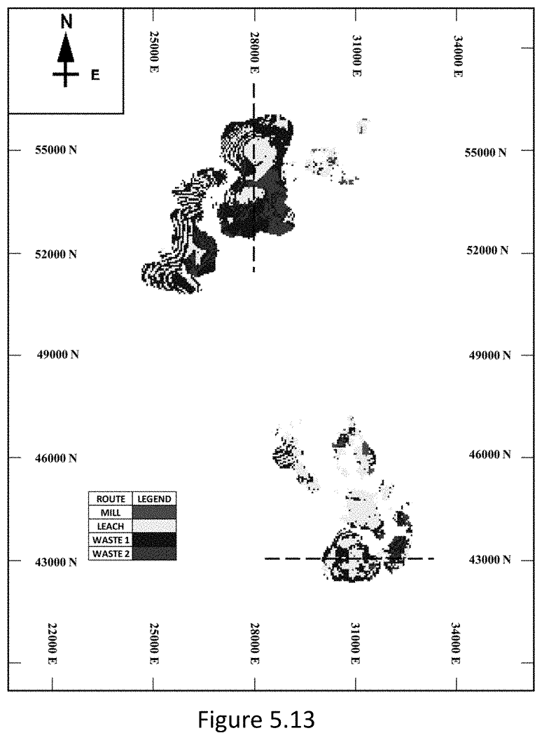

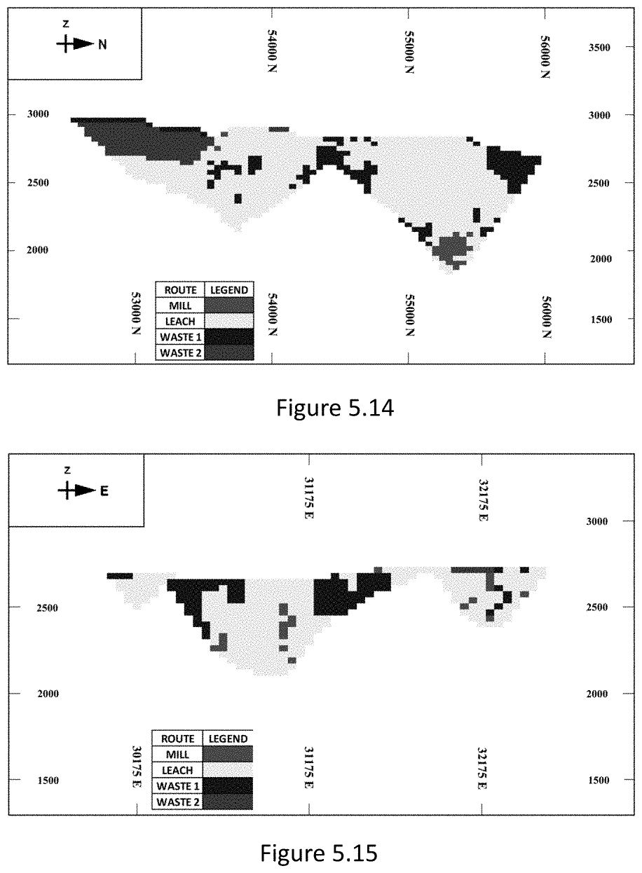

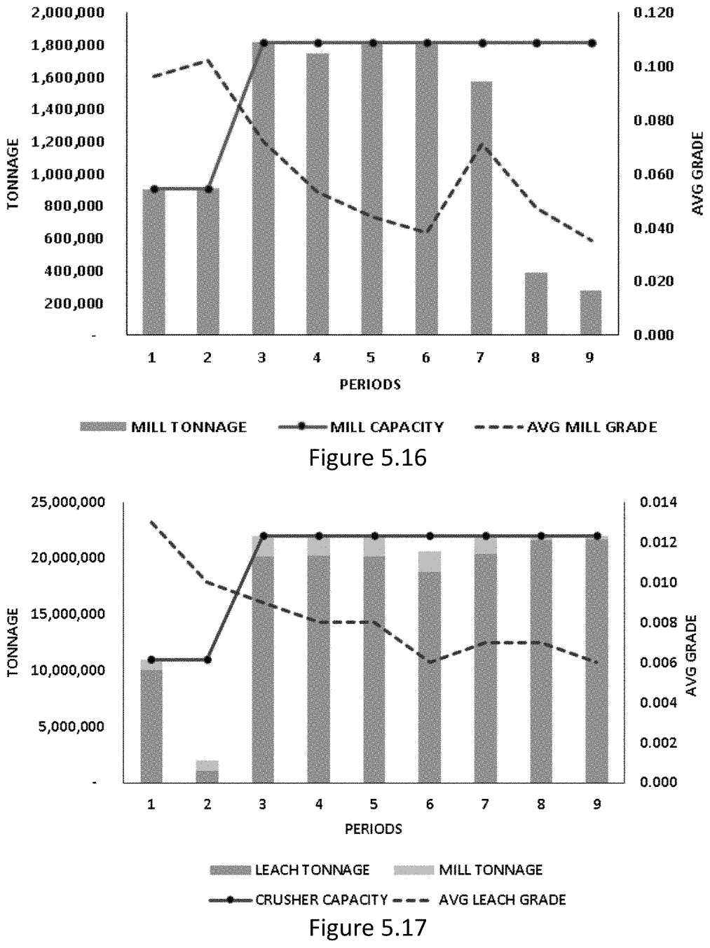

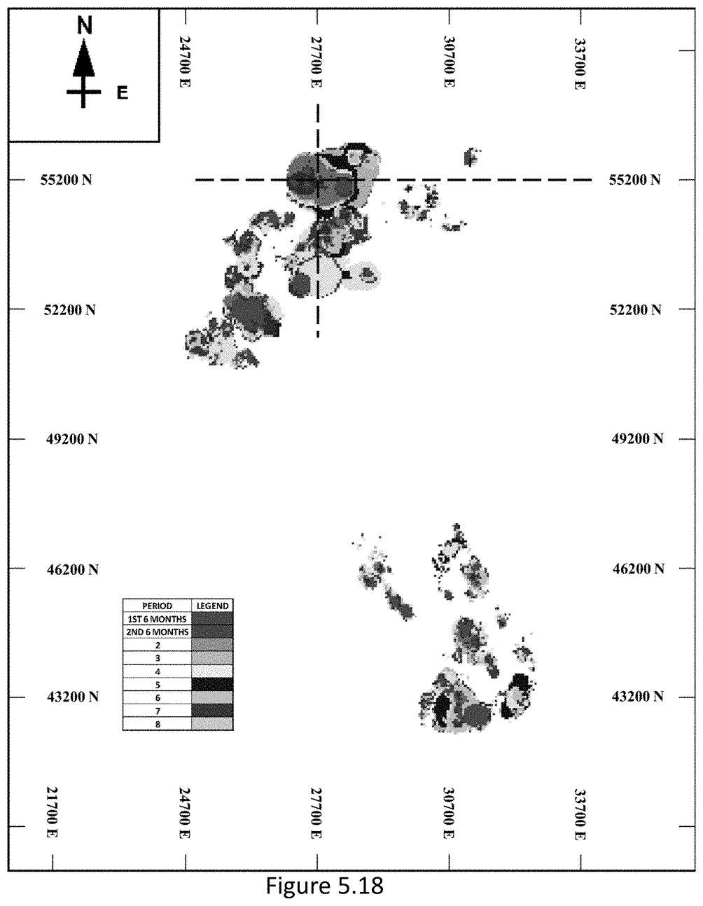

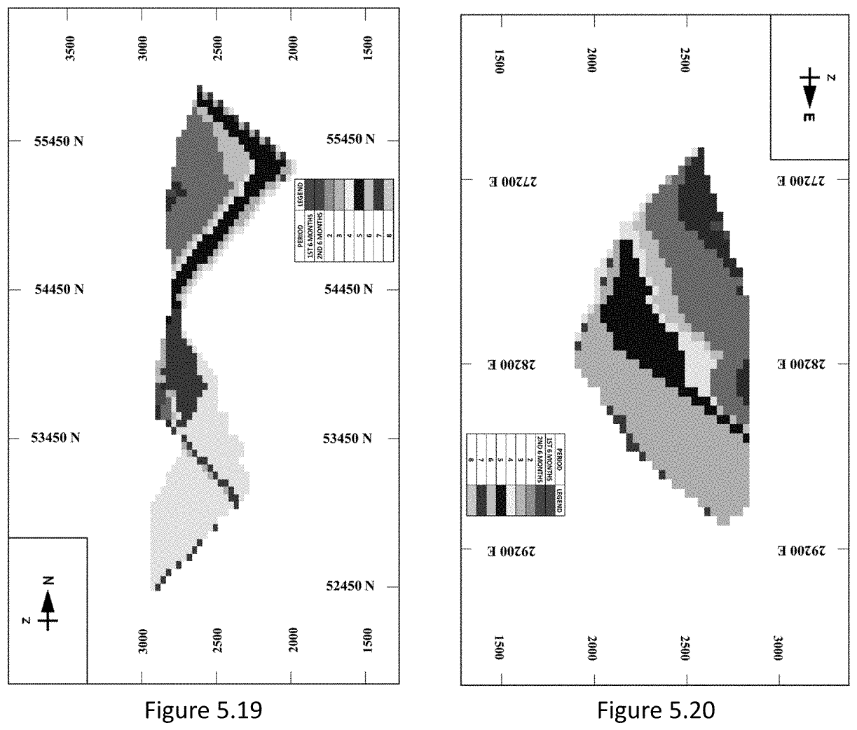

The first case study will demonstrate the implementation of the presently disclosed integer solution algorithm on scheduling a data set referred to as the McLaughlin Deposit for 10 years. The schematic description of the assumed mining complex is given in FIG. 5.1. The economic parameters that will be used to derive the block values are given in Table 5.1. The blocks will be initially subjected to a break even cutoff grade 0.03 oz/t which will separate the invaluable waste blocks from the ore blocks which carry a recoverable value once processed. Any ore block that has a grade less than 0.05 oz/t will be treated at the leach pads or sent to the waste dump once it is mined. Moreover, an ore block with a grade greater than or equal to 0.08 oz/t will be processed at the mill or sent to the waste dump. If the grade of a mined ore block is between 0.05 oz/t and 0.08 oz/t, it will be either processed at the mill, treated at the leach pads or sent to the waste dump. The ore blocks in these grade intervals are categorized as “undecided blocks” which means that the process destination is not designated based on a cutoff grade; instead the optimum destination will be determined based on the state of the system. Table 5.2 presents the cutoff grade intervals adopted for this particular example. Furthermore, the proportions of the blocks in the process stream that belong to different risk categories such as inferred, indicated and measured will be controlled by enforcing risk constraints which are in a form of blending constraints.

TABLE 5.1
Economic parameters

| PARAMETERS | VALUE |
|---|---|
| AU | 1250$/oz |
| MILL COST | 12$/t |
| LEACH COST | 6$/t |
| MILL RECOVERY | 90% |
| LEACH RECOVERY | 70& |
| DISCOUNT RATE | 12.5% |

TABLE 5.2
Summary of the cutoff grade intervals

| CUTOFF | GRADES |
|---|---|
| BREAKEVEN | >=0.03 oz/t |
| LEACH | <0.05 oz · t |
| UNDECIDED | >=0.05 oz/t AND <0.08 oz/t |
| MILL | >=0.08 oz/t |

The deposit characteristics are illustrated in Table 5.3. It is clear that out of 1.9 million blocks in the block model, only 87 thousand blocks are qualified to be ore blocks with an average grade of 0.061 oz/t. Among the ore blocks, almost half the blocks are leach blocks with an average grade of 0.034 oz/t, and on the remaining half there are 18.1 thousand mill blocks with an average grade of 0.133 oz/t, and 24.4 thousand undecided blocks with an average grade of 0.057 oz/t. Also, Table 5.4 shows that 19.8% of the blocks are categorized as inferred, 36% as indicated and 44.2% as measured.

TABLE 5.3
McLaughlin deposit characteristics

| MATERIAL TYPE | BLOCKS | TONNAGE | AVG GRADE |
|---|---|---|---|
| TOTAL | 1,922,749 | 961,374,500 | — |
| WASTE | 1,835,583 | 917,791,500 | — |
| ORE | 87,166 | 43,583,000 | 0.061 oz/t |
| MILL | 18,144 | 9,072,000 | 0.133 oz/t |
| LEACH | 44,634 | 22,317,000 | 0.034 oz/t |
| UNDECIDED | 24,388 | 12,194,000 | 0.057 oz/t |

TABLE 5.4
Risk profile of the deposit

| RISK CATEGORY | PROPORTION |
|---|---|
| INFERRED | 19.8% |
| INDICATED | 36% |
| MEASURED | 44.2% |

5.1.1 The Ultimate Pit

Once the block model characteristics are outlined, the next step is to determine the ultimate pit for the McLaughlin Deposit. The mathematical model for the ultimate pit problem which is essentially a single period version of the subproblem shown in Section 4 may have a single value for a mining decision variable; which means that the destination of a block may be pre-determined. Hence, given a set of possible destinations for a single block, the destination where the highest recoverable value can be achieved will be selected. Moreover, the cone pattern generation technique is implemented to create arcs between the blocks to accomplish a uniform 45° slope angle. Then the solution to the ultimate pit problem is determined by implementing the pseudoflow algorithm. Table 5.5 illustrates the number of blocks and tonnage mined in the ultimate pit. It is clear that while the block model includes 1.9 million blocks, the ultimate pit has 245.6 thousand blocks. There are about 2 thousand leach blocks that existed in the block model but not mined in the ultimate pit since they are not economical. We can also say that leaving those leach blocks on the ground lead to a decrease of the proportion of the inferred blocks about 1.4% as shown in Table 5.6. Also, there is no observable change on the average grades mined in the ultimate pit. The value of the pit which is calculated with the undiscounted block values determined by picking the most valuable destination was found to be $2.2 billion.

TABLE 5.5
Summary of blocks in the ultimate pit

| MATERIAL TYPE | BLOCKS | TONNAGE | AVG GRADE |
|---|---|---|---|
| TOTAL | 245,617 | 122,808,500 | — |
| WASTE | 160,445 | 80,222,500 | — |
| ORE | 85,172 | 42,586,000 | 0.062 oz/t |
| MILL | 18,140 | 9,070,000 | 0.133 oz/t |
| LEACH | 42,737 | 21,368,500 | 0.034 oz/t |
| UNDECIDED | 24,295 | 12,147,500 | 0.057 oz/t |

TABLE 5.6
Ultimate pit risk profile

| RISK CATEGORY | PROPORTION |
|---|---|
| INFERRED | 18.4% |
| INDICATED | 36.7% |
| MEASURED | 44.9% |

The results are integrated to MineSight 3D in order to visualize the blocks in the ultimate pit. The FIG. 5.2 demonstrates the plan view together with the potential destinations. FIG. 5.3 shows a cross section from East-11075 location and FIG. 5.4 shows a cross section from North-9800 location. Traditionally, the ultimate pit limit is known as the most economical pit and treated as the final shape of the pit. A question remains, are the ultimate pit limits truly achievable given a particular mining system and related constraints. The comparison of the actual pit limits established after scheduling and the ultimate pit limit will be also given later in the section.

5.1.2 Mine Production Schedule

The mine production schedule will be generated to mine the blocks in the ultimate pit under the guidance of production requirements. The life of the mine is 10 years. The mine plan must comply with the yearly production requirements outlined in Table 5.7. The requirements include restrictions on the maximum tonnage that can be processed at mill and leach pads, minimum average grade from mill and leach pads, restrictions on the maximum proportion of the ore blocks that belongs to an inferred category which possess high risk and minimum requirements on the proportion of the ore blocks that belongs to indicated and measured risk categories. Risk proportions basically quantify the risk exposure of the ore blocks in the process flow.

TABLE 5.7
Production requirements for the mine plan

| | PROCESS CAPACITY (TONNAGE) | | AVG GRADE (oz/t) | | RISK PROPORTIONS | | |
|---|---|---|---|---|---|---|---|
| PERIODS | MILL | LEACH | >=MILL | >=LEACH | <=INF | >=IND | >=MEA |
| 1 | 1,500,000 | 1,500,000 | 0.062 | 0.035 | 20% | 10% | 35% |
| 2 | 1,750,000 | 1,750,000 | 0.062 | 0.035 | 20% | 10% | 35% |
| 3 | 2,000,000 | 2,000,000 | 0.062 | 0.035 | 20% | 10% | 35% |
| 4 | 2,750,000 | 2,750,000 | 0.062 | 0.035 | 40% | 10% | 25% |
| 5 | 3,000,000 | 3,000,000 | 0.062 | 0.035 | 40% | 10% | 25% |
| 6 | 3,000,000 | 3,000,000 | 0.062 | 0.035 | 40% | 10% | 25% |
| 7 | 2,750,000 | 2,750,000 | 0.062 | 0.035 | 50% | 10% | 25% |
| 8 | 2,000,000 | 2,000,000 | 0.062 | 0.035 | 50% | 10% | 25% |
| 9 | 1,750,000 | 1,750,000 | 0.062 | 0.035 | 50% | 10% | 25% |
| 10 | 1,500,000 | 1,500,000 | 0.062 | 0.035 | 50% | 10% | 25% |

The optimal mine plan is generated by implementing the presently disclosed integer solution algorithm. The results are shown in Table 5.8. It is clear that all of the yearly requirements are honored. In FIG. 5.5 it can be seen that the mill is working at full capacity for the first 7 years and after that there is a shortage of mill blocks to fill the mill capacity. On the other hand, the FIG. 5.6 shows that the resulting mine plan is able to fill leach pad capacity every year. Also, the red dotted line that appears in both figures shows the average grade of the ore blocks processed every year. The optimizer prioritizes the high-grade zones in the earlier years of the production in order to prevent the loss in value occurring naturally by the discount factor. Hence, both mill and leach average grades may be higher in the earlier periods and gradually decrease until they become equal to the minimum yearly average grade used by the process destination. The FIG. 5.7 shows the risk behavior of the mine plan over the years. It is apparent that the earlier years of the production, the optimizer mines from the less riskier areas. This is indeed true in practice where the approved business plan must deliver the amount of ounces promised to the shareholders, therefore the confidence level on the processed ore tonnage plays a role. The riskier areas are postponed to the later years of the production since the confidence level on the riskier areas can be always increased by adding more drill holes later on.

As it was mentioned before the presently disclosed integer solution algorithm also provides the theoretical upper bound on a given solution. The theoretical upper bound is calculated by solving the mining problem as a LP problem and then the quality of the integer solution can be measured from the optimality gap. In this case the LP optimal solution is found as $1,581,250,000 and the integer solution is found as $1,581,085,000; as shown in Table 5.9. The optimality gap is 0.01% and it took 5 hours 30 minutes to achieve an integer solution. Such a small optimality gap has never been reported in the literature on a problem of this size (˜7.3 million variables) with capacity and blending constraints along with multi destinations.

TABLE 5.8
Summary of the results for the generated mine plan

| | PROCESS (TONNAGE) | | AVG GRADE (oz/t) | | RISK PROPORTIONS | | |
|---|---|---|---|---|---|---|---|
| PERIODS | MILL | LEACH | MILL | LEACH | INF | IND | MEA |
| 1 | 1,500,000 | 1,500,000 | 0.196 | 0.054 | 7% | 27% | 66% |
| 2 | 1,750,000 | 1,750,000 | 0.149 | 0.051 | 6% | 39% | 55% |
| 3 | 2,000,000 | 2,000,000 | 0.124 | 0.044 | 9% | 40% | 52% |
| 4 | 2,750,000 | 2,750,000 | 0.089 | 0.035 | 13% | 38% | 49% |
| 5 | 2,999,999 | 2,999,999 | 0.075 | 0.035 | 11% | 40% | 49% |
| 6 | 3,000,000 | 3,000,000 | 0.063 | 0.035 | 19% | 37% | 45% |
| 7 | 2,750,000 | 2,750,000 | 0.062 | 0.035 | 25% | 35% | 40% |
| 8 | 522,000 | 2,000,000 | 0.062 | 0.035 | 30% | 38% | 32% |
| 9 | 26,000 | 1,750,000 | 0.062 | 0.035 | 27% | 43% | 31% |
| 10 | 63,000 | 1,500,000 | 0.074 | 0.035 | 41% | 34% | 25% |

TABLE 5.9
Summary of the results

| | |
|---|---|
| LP NPV @ 12.5% | $1,581,250,000 |
| IP NPV @ 12.5% | $1,581,085,000 |
| OPTIMALITY GAP % | 0.01% |
| SOLUTION TIME | 5 h 30 min |

The yearly schedules are presented on a plan view in FIG. 5.8, north-south and east west cross sections are shown in FIG. 5.9 and FIG. 5.10 respectively. Once the pit outline is established based on the yearly production schedules; it is worth making a comparison with the pit outline generated by the ultimate pit as shown in FIG. 5.11. First of all, it can be clearly seen that the undecided blocks colored with blue on the ultimate pit plan view received yellow or pink colors on the schedules which shows that the ore blocks are not blindly designated to the mill just because there is more recoverable value; instead the state of the system determined the best destination for each block. Secondly, the ultimate pit is essentially an unconstrained max closure where the mine plan is a constrained max closure. Hence, the real pit limit can be determined once the production schedule is generated.

5.2 Case Study 2 (Gold Deposit)

The second case study will demonstrate the implementation of the presently disclosed integer solution algorithm to schedule the blocks mined from multiple pits and blend them with the blocks pulled out from stockpiles. FIG. 5.12 shows the schematic description of the mining complex. As there are 4 stockpiles, they will be assumed to have initial capacities and there will not be any blocks going into the stockpiles. Any ore block sent to a process destination must first pass through the crusher. Henceforth, the crusher capacity is the bottleneck of the system. There will be further capacity restrictions enforced by the mill and also total mining capacity based on the equipment availability.

5.2.1 The Ultimate Pits

In this example, the destinations of the blocks are pre-determined. By using 1200$/oz gold price, the block values are calculated for the designated destination which can be either mill, leach, waste dump 1 or waste dump 2. Moreover, the pits include 17 geotechnical zones where the slope angles may vary from 34° to 58° from one zone to another. In order to honor the slope requirements, the proposed cone generation technique discussed in Appendix A is used to form the arcs between the blocks. Once the arc file is generated, the ultimate pits are determined by implementing the pseudoflow algorithm. The ultimate pits can be determined with one pseudoflow run where the strong set of trees are formed within the independent pits which will eventually translate into two disconnected set of strong trees where both sets will be extracted. Table 5.10 illustrates the number of blocks and tonnage of material within the ultimate pits. As seen the significant proportion of the ore blocks are leach blocks. Also, the number waste blocks are relatively low which leads to a stripping ratio less than 1. Moreover, the total undiscounted value of the pits is found as $701,879,000. The plan view of the ultimate pits is shown in FIG. 5.13. The colors represent the designated destinations of the blocks. Also, FIG. 5.14 shows a cross section from East-28000 location and FIG. 5.15 shows a cross section from North-43000 location. Once the ultimate pits are determined, the next step is to generate the mine plan.

TABLE 5.10
Summary of the blocks in the ultimate pit

| MATERIAL TYPE | BLOCKS | TONNAGE |
|---|---|---|
| TOTAL | 46,585 | 288,598,000 |
| ORE | 34,643 | 220,627,000 |
| MILL | 1,386 | 8,891,500 |
| LEACH | 33,257 | 211,735,500 |
| WASTE 1 | 8,448 | 51,582,400 |
| WASTE 2 | 3,494 | 16,388,600 |

5.2.2 Mine Production Schedules

The optimal mine plan will be generated for a time horizon of 8 years with the implementation of the presently disclosed integer solution algorithm. The discount factor will be assumed as 7%. The production requirements encompass crusher capacity, mill capacity and total mining capacity as shown in Table 5.11. The leach pads have enough capacity to handle all the leach materials, henceforth a leach capacity constraint is not included in the model. There are 4 stockpiles at the site with initial capacities and the average grades shown in Table 5.12. Moreover, the stockpile materials are processed at the mill. However, the stockpile materials will be treated at the old mill for the first 6 months and after that a new mill will be available to treat the stockpile materials with enhanced recoveries. Table 5.12 also shows that the processing costs of the stockpile materials at the old mill are lower than the costs at the new mill.

TABLE 5.11
Mine plan production scheduling requirements

| | CRUSHED | MILL | MINING |
|---|---|---|---|
| PERIOD | CAPACITY | CAPACITY | CAPACITY |
| 1st 6 months | 11,000,000 | 906,660 | 21,500,000 |
| 2nd 6 months | 11,000,000 | 906,660 | 21,500,000 |
| 3 | 22,000,000 | 1,813,320 | 43,000,000 |
| 4 | 22,000,000 | 1,813,320 | 43,000,000 |
| 5 | 22,000,000 | 1,813,320 | 43,000,000 |
| 6 | 22,000,000 | 1,813,320 | 43,000,000 |
| 7 | 22,000,000 | 1,813,320 | 43,000,000 |
| 8 | 22,000,000 | 1,813,320 | 43,000,000 |
| 9 | 22,000,000 | 1,813,320 | 43,000,000 |

TABLE 5.12
Initial stockpile parameters

| | | | RECOVERIES | | COST ($/t) | | |
|---|---|---|---|---|---|---|---|
| | | AVG. | OLD | NEW | HAUL- | OLD | NEW |
| STOCKPILES | TONNAGE | GRADE | MILL | MILL | AGE | MILL | MILL |
| STK 1 | 436000 | 0.150 (oz/t) | 60.0% | 93.0% | 0.5 | 16.1 | 19.2 |
| STK 2 | 385000 | 0.070 (oz/t) | 10.0% | 90.0% | 0.5 | 16.1 | 19.2 |
| STK 3 | 614000 | 0.055 (oz/t) | 52.4% | 87.0% | 0.5 | 16.1 | 19.2 |
| STK 4 | 1338000 | 0.085 (oz/t) | 65.0% | 90.0% | 0.5 | 16.1 | 19.2 |

Since the stockpile materials will be treated differently for the first 6 months, the production requirements of the first year are split into 6 months intervals. After the first year, the mine plan will be generated based on yearly intervals. The results of the mine production schedule are illustrated in Table 5.13 where all the production requirements are honored. First of all, the scheduler prioritized the stockpile 4 to feed the mill in the first 6 months since the stockpile 4 has the highest recovery value. The second half of the first year, stockpile 1 is fully consumed since the stockpile has the highest average grade which translates into a higher profit that needs to be realized before reduced by a discount factor. Also, no mill material is mined from the pits during the second half of the year which shows that the average grade of the ore available from stockpile 1 and stockpile 4 is higher than the available ore in the pit. Furthermore, the behavior of the tonnage and the average grade of the material processed in the mill is shown in FIG. 5.16 and the tonnage and the average grade of the material treated in the leach pads is shown in FIG. 5.17. It can be observed in FIG. 5.16 that the mill capacity is not filled in years 4, 7, 8 and 9. However, FIG. 5.17 shows us that the crusher capacity is fully utilized for those years. This indicates that mill material is not available for extraction without taking leach material, which cannot be accomplished since the crusher is working at capacity. Also, there is a shortage in the crushed material tonnage in the second half of the first year and year 6. It is clearly seen in FIG. 5.16 that the mill is fully utilized for those periods. In this case, it appears that the mill material is overlaying the leach material, where the extraction of leach material is not possible without mining more mill material.

TABLE 5.13
Summary of the mine production scheduling results

| | MINED | | | | | | | | |
|---|---|---|---|---|---|---|---|---|---|
| | TONNAGE | | STOCKPILE RECLAIM TONNAGE | | | | PROCESSED TONNAGE | | |
| PERIOD | MILL | LEACH | 1 | 2 | 3 | 4 | CRUSHER | MILL | LEACH |
| 1st | 896,243 | 10,095,839 | | | | 7,918 | 11,000,000 | 904,161 | 10,095,839 |
| 6 months | | | | | | | | | |
| 2nd | 0 | 1,092,146 | 436,000 | | | 470,660 | 1,998,806 | 906,660 | 1,092,146 |
| 6 months | | | | | | | | | |
| 3 | 297,269 | 20,182,863 | | 385,000 | 271,629 | 859,422 | 21,996,183 | 1,813,320 | 20,182,863 |
| 4 | 1,498,990 | 20,256,603 | | | 244,407 | | 22,000,000 | 1,743,397 | 20,256,603 |
| 5 | 1,809,530 | 20,187,070 | | | 3,400 | | 22,000,000 | 1,812,930 | 20,187,070 |
| 6 | 1,808,634 | 18,754,065 | | | 4,686 | | 20,597,385 | 1,813,320 | 18,784,065 |
| 7 | 1,558,302 | 20,430,398 | | | 11,300 | | 22,000,000 | 1,569,602 | 20,430,398 |
| 8 | 365,941 | 21,612,117 | | | 21,942 | | 22,000,000 | 387,883 | 21,612,117 |
| 9 | 249,672 | 21,727,295 | | | 23,033 | | 22,000,000 | 272,705 | 21,727,295 |

As shown in Table 5.14, the theoretical upper bound of this problem is found to be $778,426,000 whereas the integer solution is $774,108,000. The optimality gap is 0.55% which is achieved in 33 minutes. Since the optimality gap is so small, the quality of the integer solution is successfully verified.

TABLE 5.14
Summary of the results

| | |
|---|---|
| LP NPV @ 7% | $778,426,000 |
| IP NPV @ 7% | $774,108,000 |
| OPTIMALITY GAP % | 0.55% |
| SOLUTION TIME | 33 min |

The yearly schedules are also illustrated on a plan view in FIG. 5.18, also on a cross section from East-27700 location in FIG. 5.19 and North-55200 location in FIG. 5.20. The colors represent the time period when each block is mined.

The case studies demonstrate the behavior of the components of the mining system, their interactions with each other, and how the targets of system production, grades and risks can be realized with a true optimization technique. The strength of the presently disclosed integer solution algorithm will be further supported by the results obtained from the implementation on various types of mine production scheduling problems. Table 5.15 presents the results generated by scheduling the McLaughlin deposit with pre-determined destinations, on various ranges of time horizons and different uniform slope angle requirements by enforcing process capacity, grade blending and risk blending constraints. The optimality gaps range from 0.0003% to 1.3%. The next Table 5.16 illustrates the results obtained by scheduling the McLaughlin deposit for 3, 5 and 10 years using a dynamic cutoff grade strategy technique which allows the optimizer to pick the best destination for the blocks and with uniform 45° slope angle requirements. The mine plan is constrained with mill and leach capacity, mill and leach grade blending, and risk blending constraints. The total number of variables range from 2.2 million to 7.3 million and the resulting optimality gaps range from 0.01% to 0.05%. Table 5.17 demonstrates the solutions obtained for the multi pit Gold deposit that includes 17 geotechnical zones. Both mine plans are scheduled for 9 years and subject to the same total mining capacity, mill capacity and crusher constraints, however they are modeled under different slope angle requirements which changes the schedules drastically. The optimality gaps of 0.18% and 0.55% are again significantly small.

So far, 15 large scale open pit mining problems have been scheduled by implementing the presently disclosed integer solution algorithm. The problems were subject to various pit slope requirements, multi destinations and multiple capacity and blending constraints with upper and lower bounds. The results demonstrate that for 11 out of 15 problems, the optimality gaps are less than 0.2%, three problems have a gap between 0.2% and 0.7% and one problem ended up with an optimality gap of 1.3%. Although it cannot be proven that the integer solutions are true optimal integer solutions, we know that the optimality gap generated between the true optimal LP and the true optimal IP solution of the small 2D integer example in the previous section was 3.75%. Moreover, it was also mentioned a couple times by the developers of the BZ algorithm that the integrality gaps between the linear relaxation of the problems and the integer programs are often small. Hence, the fact that resulting gaps are so small may show that the integer solution to the problem may be the true optimal integer solution, if not the tightness of the gaps proves the quality of the integer solutions.

TABLE 5.15
Summary of the results for scheduling the McLaughlin Deposit with
predetermined destinations together with the set of constraints enforced

| | | | | | |
|---|---|---|---|---|---|
| | TOTAL | | | | |
| PERIODS | VARIABLES | LP NPV | IP NPV | GAP | TIME |

MCLAUGHLIN DEPOSIT-FIXED DESTINATION-9X9X9 SLOPE PATTERN

| | | | | | |
|---|---|---|---|---|---|
| 3 YRS v1 | 874,989 | $2,089,565,000 | $2,076,065,000 | 0.65% | 0.5 h |
| 3 YRS v2 | 874,989 | $2,138,260,000 | $2,138,140,000 | 0.01% | 0.5 h |
| 3 YRS v3 | 874,989 | $2,087,750,000 | $2,087,425,000 | 0.02% | 0.5 h |
| 3 YRS v4 | 874,989 | $1,901,165,000 | $1,896,085,000 | 0.27% | 0.5 h |
| 5 YS | 1,458,315 | $1,682,040,000 | $1,682,020,000 | 0.001% | 2 h |
| 7 YRS | 2,041,641 | $1,729,345,000 | $1,729,180,000 | 0.01% | 2.5 h |
| 9 YRS | 2,624,967 | $1,589,660,000 | $1,589,410,000 | 0.02% | 5.8 h |
| 10 YRS | 2,916,630 | $1,569,635,000 | $1,549,255,000 | 1.30% | 5.8 h |

MCLAUGHLIN DEPOSIT-FIXED DESTINATION-45 DEGREE SLOPE

| | | | | | |
|---|---|---|---|---|---|
| 3 YRS | 762,567 | $2,132,655,000 | $2,132,590,000 | 0.003% | 1 h |
| 5 YRS | 1,270,945 | $1,714,060,000 | $1,714,055,000 | 0.0003% | 4 h |

| CONSTRAINTS | BOUNDS |
|---|---|
| MILL CAPACITY | <= |
| MILL AVG GRADE | >= |
| PROP. INFERRED | <= |
| PROP. INDICATED | >= |
| PROP. MEASURED | >= |

TABLE 5.16
Summary of the results for scheduling the McLaughlin Deposit with
dynamic cutoff grade strategy and the regarding set of constraints
MCLAUGHLIN DEPOSIT-MULTI DESTINATIONS-45 DEGREE SLOPE

| | TOTAL | | | | |
|---|---|---|---|---|---|
| PERIODS | VARIABLES | LP NPV | IP NPV | GAP | TIME |
| 3 YRS | 2,210,553 | $2,070,265,000 | $2,069,205,000 | 0.05% | 0.7 h |
| 5 YRS | 3,684,255 | $1,925,585,000 | $1,925,045,000 | 0.03% | 2 h |
| 10 YRS | 7,368,510 | $1,581,250,000 | $1,581,085,000 | 0.01% | 5.5 h |

| CONSTRAINTS | BOUNDS |
|---|---|
| MILL CAPACITY | <= |
| LEACH CAPACITY | <= |
| MILL AVG GRADE | >= |
| LEACH AVG GRADE | >= |
| PROP. INFERRED | <= |
| PROP. INDICATED | >= |
| PROP. MEASURED | >= |

TABLE 5.17
Summary of the results for scheduling the multi pit Gold Deposit
subject to 17 slope zones and the corresponding set of constraints
GOLD DEPOSIT-MULTI PIT-FIXED DESTINATION-17 SLOPE ZONES

| | TOTAL | | | | |
|---|---|---|---|---|---|
| PERIODS | VARIABLES | LP | IP | GAP | TIME |
| 9 | 412,704 | $793,187,000 | $791,776,000 | 0.18% | 1 h |
| 9 | 419,265 | $778,426,000 | $774,108,000 | 0.55% | 0.5 h |

| CONSTRAINTS | BOUNDS |
|---|---|
| MINING CAPACITY | <= |
| CRUSHER CAPACITY | <= |
| MILL CAPACITY | <= |

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A method for optimizing a mining sequence for a pit mine comprising:
determining an initial plurality of mining plans, wherein each mining plan of the plurality of mining plans includes a plurality of blocks of ore to be mined and each ore block of the plurality of ore blocks has a first economic value;
determining an objective function subject to one or more time periods and one or more capacity constraints;
modifying the first economic value of an ore block of the plurality of ore blocks based on one or more of the capacity constraints to determine a modified first economic value;
determining one or more feasible mining plans based on the one or more capacity constraints;
orthogonalizing the one or more feasible mining plans with respect to the initial plurality of mining plans; and
determining a second plurality of mining plans based on the one or more capacity constraints; and thereby
optimizing a mining sequence for a pit mine.

2. The method of claim 1, wherein one of the capacity constraints is mill capacity.

3. The method of claim 1, wherein one of the capacity constraints is leach field capacity.

4. The method of claim 1, wherein one of the capacity constraints is total mining capacity.

5. The method of claim 2, further comprising determining the first economic value of each or block of the plurality of ore blocks for a plurality of time periods.

6. The method of claim 5, wherein the method further comprises determining 500,000 variables or more.

7. The method of claim 6, wherein the determining steps involve an integer problem.

8. The method of claim 7, wherein the method results in an optimality gap of less than about 0.1%.

9. The method of claim 7, wherein the method results in an optimality gap of less than about 0.01%.

10. The method of claim 3, further comprising determining the first economic value of each or block of the plurality of ore blocks for a plurality of time periods.

11. The method of claim 10, wherein the method further comprises determining 500,000 variables or more.

12. The method of claim 11, wherein the determining steps involve an integer problem.

13. The method of claim 12, wherein the method results in an optimality gap of less than about 0.1%.

14. The method of claim 4, further comprising determining the first economic value of each or block of the plurality of ore blocks for a plurality of time periods

15. The method of claim 14, wherein the method further comprises determining 500,000 variables or more.

16. The method of claim 15, wherein the determining steps involve an integer problem.

17. The method of claim 16, wherein the method results in an optimality gap of less than about 0.1%.

18. The method of claim 1, further comprising determining the first economic value of each ore block of the plurality of ore blocks for a plurality of time periods.

19. The method of claim 18, wherein the capacity constraints are selected from mill capacity, leach field capacity, and total mining capacity.

20. A method for optimizing a mining sequence for a pit mine comprising:
determining an initial plurality of mining plans, wherein each mining plan of the plurality of mining plans includes a plurality of blocks of ore to be mined and each ore block of the plurality of ore blocks has a first economic value;
determining the first economic value of each ore block of the plurality of ore blocks for a plurality of time periods;
determining an objective function subject to one or more time periods and one or more capacity constraints, wherein the one or more capacity constraint include one or more of mill capacity, leach field capacity, and total mining capacity;
modifying the first economic value of an ore block of the plurality of ore blocks based on one or more of the capacity constraints to determine a modified first economic value;
determining one or more feasible mining plans based on the one or more capacity constraints;
orthogonalizing the one or more feasible mining plans with respect to the initial plurality of mining plans; and
determining a second plurality of mining plans based on the one or more capacity constraints; and thereby
optimizing a mining sequence for a pit mine, wherein the method comprises more than 500,000 variables, at least one determining step involves an integer problem, and results in an optimality gap of less than about 0.01%.
